(19) United States
(12) Patent Application Publication
(10) Pub. No.: US 2025/0242290 A1
(43) Pub. Date: Jul. 31, 2025

(54) PROCESS ASSEMBLY WITH ROTOR ASSEMBLY AND PROCESS DEVICE

(71) Applicant: GE-Hitachi Nuclear Energy Americas LLC, Wilmington, NC (US)

(72) Inventors: Brian HUNT, Spring Grove, PA (US); Clarice NELSON, Wilmington, NC (US); Tanmoy CHATTERJEE, Madison, WI (US); Nikolai PASTOUCHENKO, Latham, NY (US)

(73) Assignee: GE-Hitachi Nuclear Energy Americas LLC, Wilmington, NC (US)

(21) Appl. No.: 18/422,422

(22) Filed: Jan. 25, 2024

(51) Int. Cl. B01D 53/04; B01D 53/14; F04D 25/08; F04D 29/32; G21C 15/24

(52) U.S. Cl. CPC B01D 53/0446; B01D 53/0438; B01D 53/1475; F04D 25/08; F04D 29/329; G21C 15/24; B01D 2257/504; B01D 2258/02

(57) ABSTRACT

A process assembly includes an air mover assembly having a rotor assembly with rotor blades extending from a rotor hub and configured to cause an air flow to move over at least a portion of a process device to facilitate a process. The process device includes at least one of a heat exchanger or a direct air carbon capture device. The air mover assembly may be a wind turbine air mover assembly including a wind turbine rotor assembly. Each rotor blade may include a body structure defining root and airfoil sections extending along respective first and second span portions of the rotor blade. A ratio between the airfoil profile chord and the profile thickness and a twist angle between the airfoil profile chord and a root profile chord of the root section may vary along one or more portions of the second span portion.

### BACKGROUND

### Field

The present inventive concepts relate in general to process devices operating to perform an industrial process based on an air flow over at least a portion of the process devices (e.g., over one or more surfaces of the one or more process devices), and in particular to process assemblies that include an air mover assembly that includes a rotor assembly and is configured to generate the air flow over at least a portion of one or more process devices based on causing at least a portion of the air flow to move vertically through the air mover assembly.

### Description of Related Art

Some process assemblies include one or more process devices (also referred to herein as process units) that are configured to perform a process based on a flow of air over one or more elements of the one or more process devices, for example an air flow over one or more surfaces of the one or more process devices. Such processes may include an industrial process, for example a physical or mechanical process (e.g., heat transfer between a process device and an air flow over a portion of the process device), a chemical process (e.g., a chemical reaction of a material in the process device with molecules in the air flow over the material or substance), or any combination thereof.

In such process assemblies, the air flow over at least a portion of one or more process devices may be generated based on operation of air mover assemblies, which may include mechanically driven fans.

### SUMMARY

According to some example embodiments, a process assembly may include a process device and a wind turbine air mover assembly. The process device may be configured to perform a process based on an air flow over at least a portion of the process device. The process device may include at least one of a heat exchanger configured to transfer heat from a working fluid into the air flow, or a direct air capture (DAC) device configured to capture carbon dioxide from the air flow. The wind turbine air mover assembly may be configured to cause the air flow to flow over the portion of the process device based on causing the air flow to move in a particular direction through the wind turbine air mover assembly. The wind turbine air mover assembly may include a wind turbine rotor assembly. The wind turbine rotor assembly may be mechanically coupled to a drive motor and configured to rotate around a central axis based on operation of the drive motor. The wind turbine rotor assembly may include a plurality of wind turbine rotor blades extending radially from a rotor hub. Each wind turbine rotor blade of the plurality of wind turbine rotor blades may include a body structure. The body structure may define a root section that extends along a first span portion of the wind turbine rotor blade and has a cylindrical shape, and an airfoil section that extends along a second span portion of the wind turbine rotor blade to a tip of the wind turbine rotor blade. Each cross-sectional profile of the airfoil section may have an airfoil profile chord and a profile thickness perpendicular to the airfoil profile chord. A ratio between the airfoil profile chord and the profile thickness may vary along at least a first portion of the second span portion. The body structure may define a twist angle between the airfoil profile chord and a root profile chord of the root section, the twist angle varying along at least a second portion of the second span portion.

The root section may have a circular cylindrical shape.

The body structure may include a composite material structure.

The wind turbine rotor assembly may have a rotor diameter that is equal to or greater than 50 meters.

The particular direction may be a vertical direction extending parallel to a direction of gravity. The central axis of the wind turbine rotor assembly may extend parallel to the direction of gravity.

The body structure of each wind turbine rotor blade may define an enclosure within an interior of the wind turbine rotor blade.

The wind turbine rotor assembly may be between the process device and an air outlet of the process assembly, such that the wind turbine rotor assembly is configured to induce the air flow through the process device based on drawing the air flow through the process device and further forcing the drawn air flow through the air outlet.

The wind turbine rotor assembly may be at least partially above the process device in the vertical direction, such that the wind turbine rotor assembly is configured to draw the air flow upwards through the wind turbine rotor assembly and at least partially opposite the direction of gravity.

The wind turbine rotor assembly may be at least partially beneath the process device in the vertical direction, such that the wind turbine rotor assembly is configured to draw the air flow downwards through the wind turbine rotor assembly and at least partially in the direction of gravity.

The wind turbine rotor assembly may be between the process device and an air inlet of the process assembly, such that the wind turbine rotor assembly is configured to force the air flow toward the process device based on drawing the air flow through the air inlet and further forcing the drawn air flow toward the process device.

The wind turbine rotor assembly may be at least partially above the process device in the vertical direction, such that the wind turbine rotor assembly is configured to force the air flow downwards through the wind turbine rotor assembly and at least partially in the direction of gravity.

The wind turbine rotor assembly may be at least partially beneath the process device in the vertical direction, such that the wind turbine rotor assembly is configured to force the air flow upwards through the wind turbine rotor assembly and at least partially opposite the direction of gravity.

The process assembly may be a DAC system, comprising a circumferential plurality of DAC devices including the process device, where the process device is the DAC device. Each DAC device of the circumferential plurality of DAC devices may include a contactor having a carbon capture material within an enclosure and further including one or more openings configured to be selectively opened or closed to selectively seal or open the enclosure. The circumferential plurality of DAC devices may at least partially define a circumference of a central enclosure space in a plane, at least one opening of each DAC device facing into the central enclosure space. The wind turbine rotor assembly of the wind turbine air mover assembly may at least partially overlap the central enclosure space in a direction extending perpendicular to the plane.

The DAC system may include at least one additional circumferential plurality of DAC devices extending circumferentially around at least a portion of the circumference of the central enclosure. At least one DAC device of the additional circumferential plurality of DAC devices may be stacked on at least one DAC device of the circumferential plurality of DAC devices in the direction extending perpendicular to the plane.

According to some example embodiments, a direct air capture (DAC) facility may include the DAC system, a vacuum generator configured to at least partially evacuate one or more enclosures of the circumferential plurality of DAC devices, and a heat source configured to heat the carbon capture material in one or more DAC devices of the circumferential plurality of DAC devices.

The process device may include at least one heat exchanger and at least one DAC device.

The process assembly may further include a shroud structure. The shroud structure may include at least one helical strake extending around an inner surface of the shroud structure. The shroud structure may define an at least partially hyperbolic conduit between the wind turbine rotor assembly and the process device in the vertical direction.

The process device may include at least one heat exchanger, such that the process assembly is a cooling tower.

The process device may be a closed-loop heat exchanger, such that the process assembly is a dry cooling tower.

According to some example embodiments, a nuclear power plant may include a nuclear reactor, at least one coolant circuit configured to circulate a working fluid to absorb heat from a heat source and to transfer the absorbed heat into a heat sink, where the heat source includes the nuclear reactor or a separate working fluid of a separate coolant circuit; and the process assembly, wherein the process device includes at least one heat exchanger and is configured to circulate the working fluid to transfer at least a portion of the heat from the working fluid to atmosphere via the air flow.

According to some example embodiments, a method of operating the process assembly may include operating the drive motor to cause the wind turbine rotor assembly of the wind turbine air mover assembly to rotate around the central axis, to cause the air flow to move in the particular direction through the wind turbine rotor assembly, parallel to the central axis and to further flow over at least the portion of the process device, and operating the process device to perform a process based on the air flow flowing over at least the portion of the process device. The process may include at least one of circulating a working fluid through a heat exchanger such that the heat exchanger transfers heat from the working fluid to the air flow, and the wind turbine air mover assembly causes the air flow to remove the transferred heat from the process assembly via an air outlet of the process assembly, or directing the air flow to flow over one or more surfaces of a carbon capture material such that the carbon capture material captures carbon dioxide from the air flow and subsequently isolating the carbon capture material from the air flow and further subsequently releasing the captured carbon dioxide from the carbon capture material.

According to some example embodiments, a method of constructing a process assembly may include installing a process device at a process site, the process device including at least one of a heat exchanger configured to transfer heat from a working fluid into an air flow, or a direct air carbon capture (DAC) device configured to capture carbon dioxide from an air flow. The method may include installing a wind turbine air mover assembly at the process site to configure the wind turbine air mover assembly to generate an air flow that flows over one or more surfaces of the process device based on causing at least a portion of the air flow to move in a particular direction through the wind turbine air mover assembly, the wind turbine air mover assembly including a wind turbine rotor assembly, the wind turbine rotor assembly mechanically coupled to a drive motor and configured to rotate around a central axis based on operation of the drive motor, the wind turbine rotor assembly including a plurality of wind turbine rotor blades extending radially from a central rotor hub, the wind turbine rotor assembly configured to cause the air flow to move through the wind turbine rotor assembly, parallel to the central axis, based on operation of the drive motor. Each wind turbine rotor blade of the plurality of wind turbine rotor blades may include a body structure defining a root section that extends along a first span portion of the wind turbine rotor blade, the root section having a cylindrical shape, an airfoil section that extends along a second span portion of the wind turbine rotor blade to a tip of the wind turbine rotor blade, each cross-sectional profile of the airfoil section having an airfoil profile chord and a profile thickness perpendicular to the airfoil profile chord, a ratio between the airfoil profile chord and the profile thickness varying along at least a first portion of the second span portion, and a twist angle between the airfoil profile chord and a root profile chord of the root section, the twist angle varying along at least a second portion of the second span portion.

According to some example embodiments, a direct air capture (DAC) system may include a circumferential plurality of DAC devices and an air mover assembly. Each DAC device of the circumferential plurality of DAC devices may include a contactor having a carbon capture material within an enclosure and further including one or more openings configured to be selectively opened or closed to selectively seal or open the enclosure. The circumferential plurality of DAC devices may at least partially define a circumference of a central enclosure space in a plane, at least one opening of each DAC device facing into the central enclosure space. The air mover assembly may be configured to cause an air flow to flow over at least a portion of a contactor of one or more of the DAC devices based on causing the air flow to move in a particular direction through the air mover assembly. The air mover assembly may include a rotor assembly at least partially overlapping the central enclosure space in an axial direction extending perpendicular to the plane.

The air mover assembly may be a wind turbine air mover assembly. The rotor assembly may be a wind turbine rotor assembly.

The DAC system may further include a cylindrical shroud structure at least partially circumferentially surrounding the central enclosure space, the cylindrical shroud structure coupled to the air mover assembly such that the cylindrical shroud structure is configured to at least partially structurally support a weight of the rotor assembly at least partially overlapping the central enclosure space in the axial direction.

### BRIEF DESCRIPTION OF THE DRAWINGS

The various features and advantages of the non-limiting embodiments herein may become more apparent upon review of the detailed description in conjunction with the accompanying drawings. The accompanying drawings are merely provided for illustrative purposes and should not be interpreted to limit the scope of the claims. The accompanying drawings are not to be considered as drawn to scale unless explicitly noted. For purposes of clarity, various dimensions of the drawings may have been exaggerated.

FIG. 1 is a perspective view of a process assembly including a process device and a wind turbine air mover assembly, according to some example embodiments.

FIG. 2A is a cross-sectional view along cross-sectional view line IIA-IIA′ in FIG. 1 of a process assembly including a process device and a wind turbine air mover assembly above the process device, according to some example embodiments.

FIG. 2B is a cross-sectional view along cross-sectional view line IIA-IIA′ in FIG. 1 of a process assembly including a process device and an air mover assembly, according to some example embodiments.

FIG. 2C is a cross-sectional view of a process assembly including an air mover assembly beneath the process device, according to some example embodiments.

FIG. 2D is a cross-sectional view of a process assembly, according to some example embodiments.

FIG. 3 is a cross-sectional view along cross-sectional view line III-III′ in FIG. 2A of a process assembly including a process device and an air mover assembly, according to some example embodiments.

FIG. 4A is an expanded view of region 4A in FIG. 2A, according to some example embodiments.

FIG. 4B is a cutaway perspective view of a bearing of the wind turbine rotor assembly according to some example embodiments.

FIG. 5A is a perspective view of an individual rotor blade of a wind turbine rotor assembly according to some example embodiments.

FIG. 5B is a cross-sectional view of a particular cross-section of the individual rotor blade of FIG. 5A according to some example embodiments.

FIG. 5C is a cross-sectional view of a particular cross-section of the individual rotor blade of FIG. 5A according to some example embodiments.

FIG. 6 is a graph plotting power consumption per unit of volumetric flow rate by fan air mover assemblies and wind turbine air mover assemblies corresponding to rotor diameter of the respective rotor assemblies thereof, according to some example embodiments.

FIG. 7 is an expanded perspective view of a portion of a cylindrical shroud structure in region 7 in FIG. 2D, according to some example embodiments.

FIG. 8A is a schematic view of a nuclear power plant including a process assembly configured to implement a cooling tower to remove heat from a working fluid of the nuclear power plant to an air flow of ambient air, according to some example embodiments.

FIGS. 8B and 8C are cross-sectional views of a process assembly configured to implement a cooling tower, according to some example embodiments.

FIGS. 8D and 8E illustrate comparative footprint areas of a cooling tower including the process assembly and a comparative example, according to some example embodiments.

FIG. 9A is a schematic view of a direct air carbon capture (DAC) facility including a process assembly configured to implement a DAC system to remove carbon dioxide from an air flow of ambient air, according to some example embodiments.

FIGS. 9B and 9C are cross-sectional views of a process assembly configured to implement a DAC system, according to some example embodiments.

FIGS. 9D and 9E illustrate comparative footprint areas of a DAC system including the process assembly and a comparative example, according to some example embodiments.

FIG. 10 is a flowchart illustrating a method for operating a process assembly, according to some example embodiments.

FIG. 11 is a flowchart illustrating a method for constructing a facility that includes a process assembly, according to some example embodiments.

### DETAILED DESCRIPTION

Reference will now be made in detail to example embodiments, some of which are illustrated in the accompanying drawings, wherein like reference labels refer to like elements throughout.

It should be understood that when an element or layer is referred to as being “on,” “connected to,” “coupled to,” or “covering” another element or layer, it may be directly on, connected to, coupled to, or covering the other element or layer or intervening elements or layers may be present. In contrast, when an element is referred to as being “directly on,” “directly connected to,” or “directly coupled to” another element or layer, there are no intervening elements or layers present. Like numbers refer to like elements throughout the specification. As used herein, the term “and/or” includes any and all combinations of one or more of the associated listed items.

It should be understood that, although the terms first, second, third, etc. may be used herein to describe various elements, components, regions, layers and/or sections, these elements, components, regions, layers, and/or sections should not be limited by these terms. These terms are only used to distinguish one element, component, region, layer, or section from another region, layer, or section. Thus, a first element, component, region, layer, or section discussed below could be termed a second element, component, region, layer, or section without departing from the teachings of example embodiments.

Spatially relative terms (e.g., “beneath,” “below,” “lower,” “above,” “upper,” and the like) may be used herein for ease of description to describe one element or feature's relationship to another element(s) or feature(s) as illustrated in the figures. It should be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” may encompass both an orientation of above and below. The device may be otherwise oriented (rotated 90 degrees or at other orientations) and the spatially relative descriptors used herein interpreted accordingly.

The terminology used herein is for the purpose of describing various embodiments only and is not intended to be limiting of example embodiments. As used herein, the singular forms “a,” “an,” and “the” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of example embodiments.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particular manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

It will be understood that elements and/or properties thereof (e.g., structures, surfaces, directions, or the like), which may be referred to as being “perpendicular,” “parallel,” “coplanar,” or the like with regard to other elements and/or properties thereof (e.g., structures, surfaces, directions, or the like) may be “perpendicular,” “parallel,” “coplanar,” or the like or may be “substantially perpendicular,” “substantially parallel,” “substantially coplanar,” respectively, with regard to the other elements and/or properties thereof.

Elements and/or properties thereof (e.g., structures, surfaces, directions, or the like) that are “substantially perpendicular”, “substantially parallel”, or “substantially coplanar” with regard to other elements and/or properties thereof will be understood to be “perpendicular”, “parallel”, or “coplanar”, respectively, with regard to the other elements and/or properties thereof within manufacturing tolerances and/or material tolerances and/or have a deviation in magnitude and/or angle from “perpendicular”, “parallel”, or “coplanar”, respectively, with regard to the other elements and/or properties thereof that is equal to or less than 10% (e.g., a. tolerance of ±10%).

It will be understood that elements and/or properties thereof may be recited herein as being “the same” or “equal” as other elements, and it will be further understood that elements and/or properties thereof recited herein as being “identical” to, “the same” as, or “equal” to other elements may be “identical” to, “the same” as, or “equal” to or “substantially identical” to, “substantially the same” as or “substantially equal” to the other elements and/or properties thereof. Elements and/or properties thereof that are “substantially identical” to, “substantially the same” as or “substantially equal” to other elements and/or properties thereof will be understood to include elements and/or properties thereof that are identical to, the same as, or equal to the other elements and/or properties thereof within manufacturing tolerances and/or material tolerances. Elements and/or properties thereof that are identical or substantially identical to and/or the same or substantially the same as other elements and/or properties thereof may be structurally the same or substantially the same, functionally the same or substantially the same, and/or compositionally the same or substantially the same. While the term “same,” “equal” or “identical” may be used in description of some example embodiments, it should be understood that some imprecisions may exist. Thus, when one element is referred to as being the same as another element, it should be understood that an element or a value is the same as another element within a desired manufacturing or operational tolerance range (e.g., +10%).

It will be understood that elements and/or properties thereof described herein as being “substantially” the same and/or identical encompasses elements and/or properties thereof that have a relative difference in magnitude that is equal to or less than 10%. Further, regardless of whether elements and/or properties thereof are modified as “substantially,” it will be understood that these elements and/or properties thereof should be construed as including a manufacturing or operational tolerance (e.g., +10%) around the stated elements and/or properties thereof.

When the terms “about” or “substantially” are used in this specification in connection with a numerical value, it is intended that the associated numerical value includes a manufacturing or operational tolerance (e.g., +10%) around the stated numerical value. Moreover, when the words “about” and “substantially” are used in connection with geometric shapes, it is intended that precision of the geometric shape is not required but that latitude for the shape is within the scope of the disclosure. Further, regardless of whether numerical values or shapes are modified as “about” or “substantially,” it will be understood that these values and shapes should be construed as including a manufacturing or operational tolerance (e.g., +10%) around the stated numerical values or shapes. When ranges are specified, the range includes all values therebetween such as increments of 0.1%.

As described herein, when an operation is described to be performed, or an effect such as a structure is described to be established “by” or “through” performing additional operations, it will be understood that the operation may be performed and/or the effect/structure may be established “based on” the additional operations, which may include performing said additional operations alone or in combination with other further additional operations.

As described herein, an element that is described to be “spaced apart” from another element, in general and/or in a particular direction (e.g., vertically spaced apart, laterally spaced apart, etc.) and/or described to be “separated from” the other element, may be understood to be isolated from direct contact with the other element, in general and/or in the particular direction (e.g., isolated from direct contact with the other element in a vertical direction, isolated from direct contact with the other element in a lateral or horizontal direction, etc.). Similarly, elements that are described to be “spaced apart” from each other, in general and/or in a particular direction (e.g., vertically spaced apart, laterally spaced apart, etc.) and/or are described to be “separated” from each other, may be understood to be isolated from direct contact with each other, in general and/or in the particular direction (e.g., isolated from direct contact with each other in a vertical direction, isolated from direct contact with each other in a lateral or horizontal direction, etc.). Similarly, a structure described herein to be between two other structures to separate the two other structures from each other may be understood to be configured to isolate the two other structures from direct contact with each other.

Unless otherwise defined, all terms (including technical and scientific terms) used herein have the same meaning as commonly understood by one of ordinary skill in the art to which example embodiments belong. It will be further understood that terms, including those defined in commonly used dictionaries, should be interpreted as having a meaning that is consistent with their meaning in the context of the relevant art and will not be interpreted in an idealized or overly formal sense unless expressly so defined herein.

Units, systems, and/or devices according to one or more example embodiments may be implemented using one or more instances of hardware, software, and/or a combination thereof. For example, hardware devices may be implemented using processing circuitry such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor, Central Processing Unit (CPU), a controller, an arithmetic logic unit (ALU), a digital signal processor, a microcomputer, a microprocessor, etc.), the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable recording mediums, including the tangible or non-transitory computer-readable storage media discussed herein.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive), solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blu-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as one computer processing device; however, one skilled in the art will appreciate that a hardware device may include multiple processing elements and multiple types of processing elements. For example, a hardware device may include multiple processors or a processor and a controller. In addition, other processing configurations are possible, such as parallel processors.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

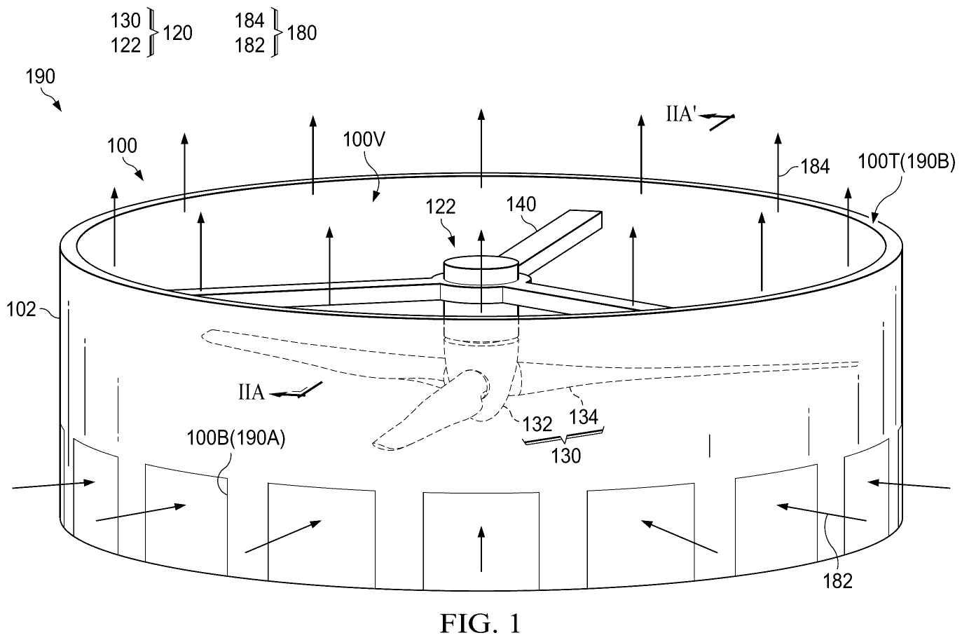

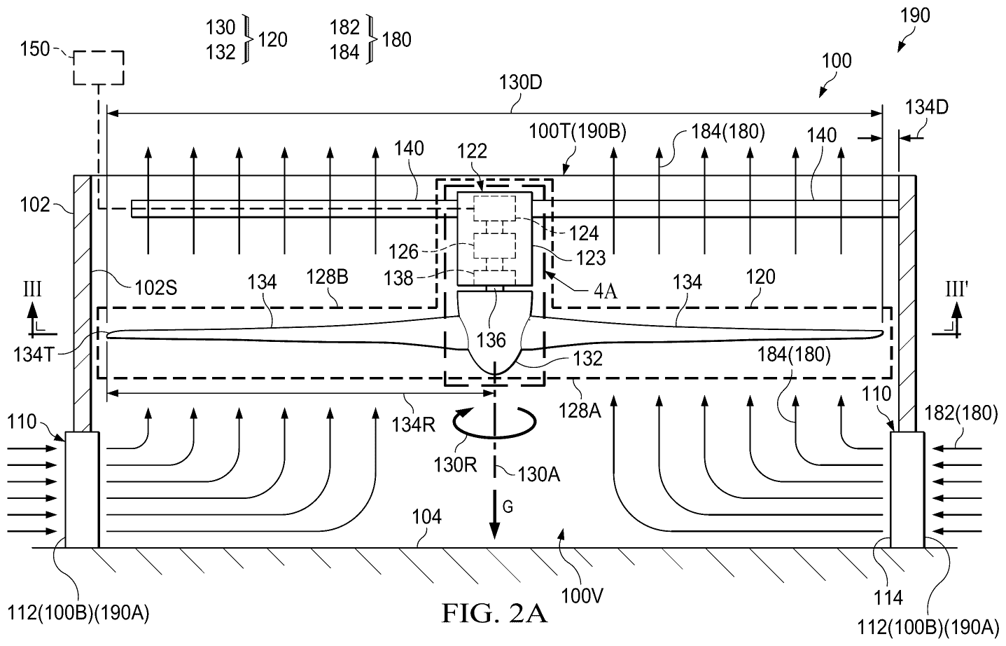

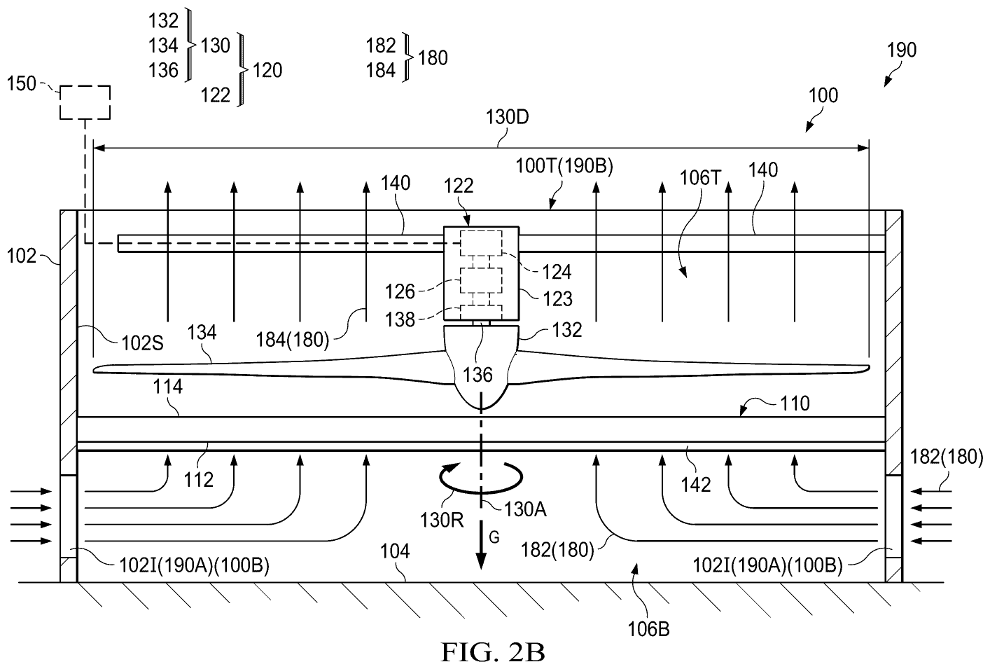

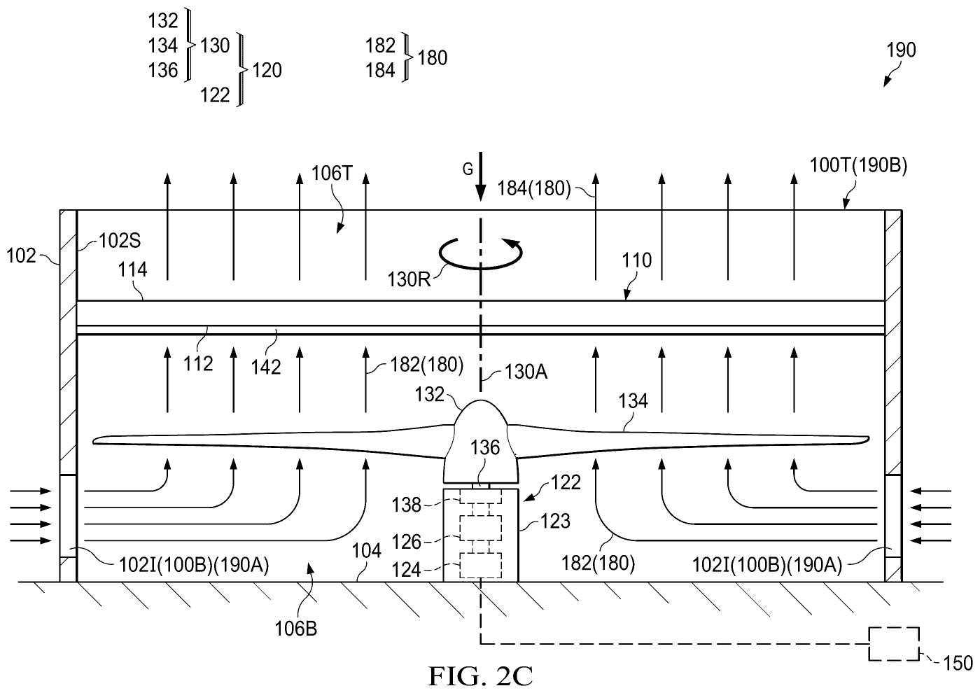

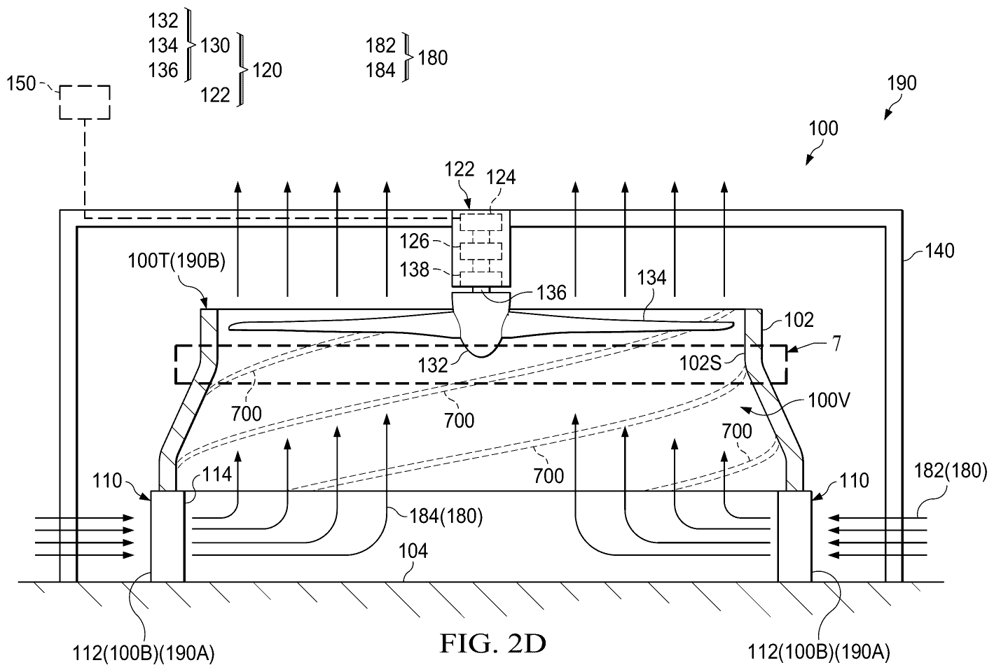

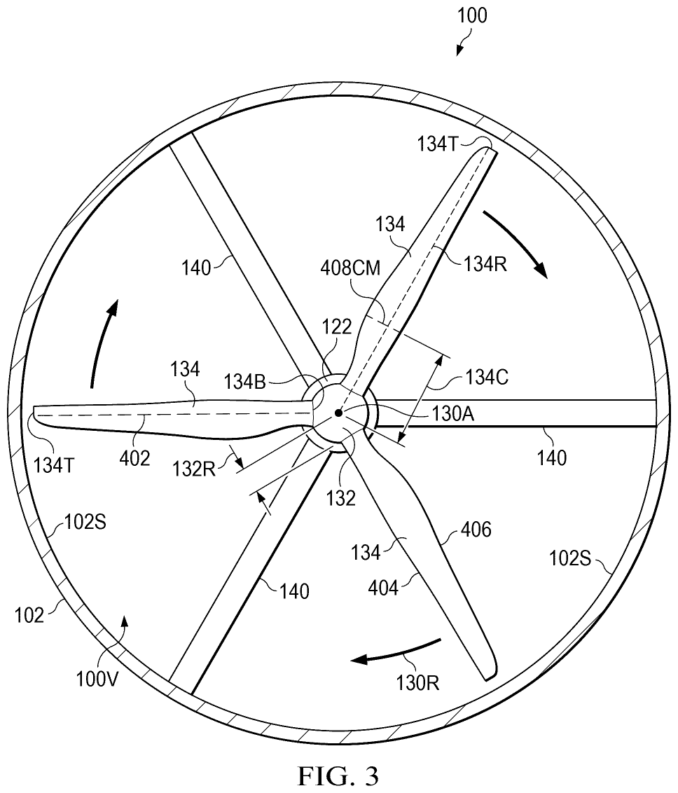

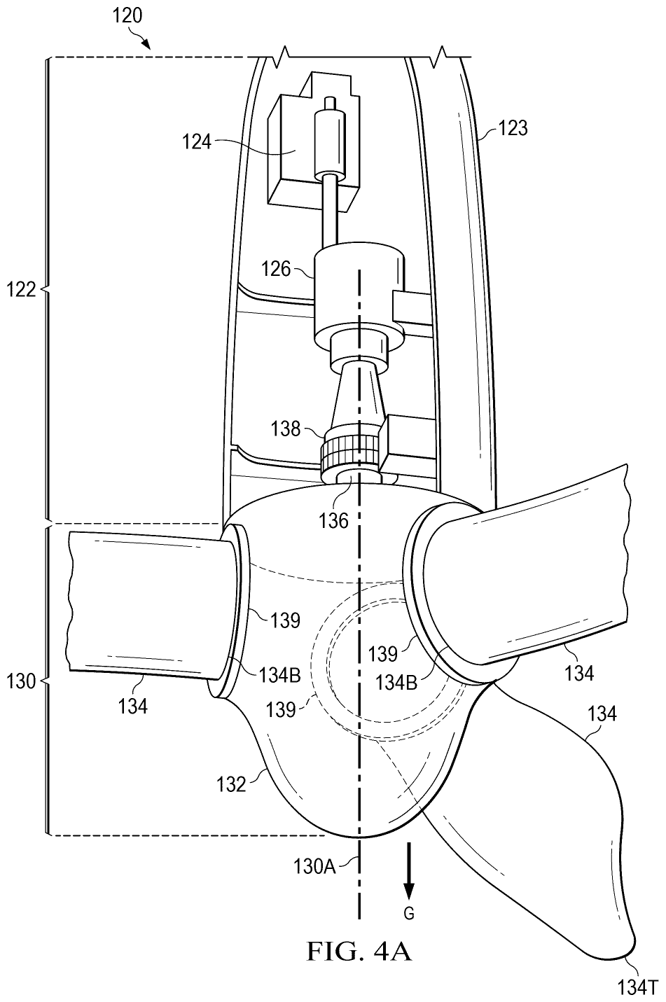

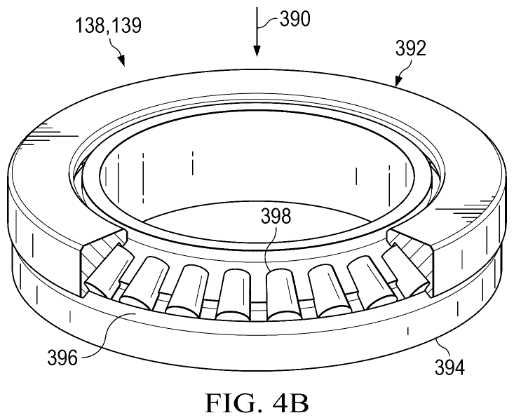

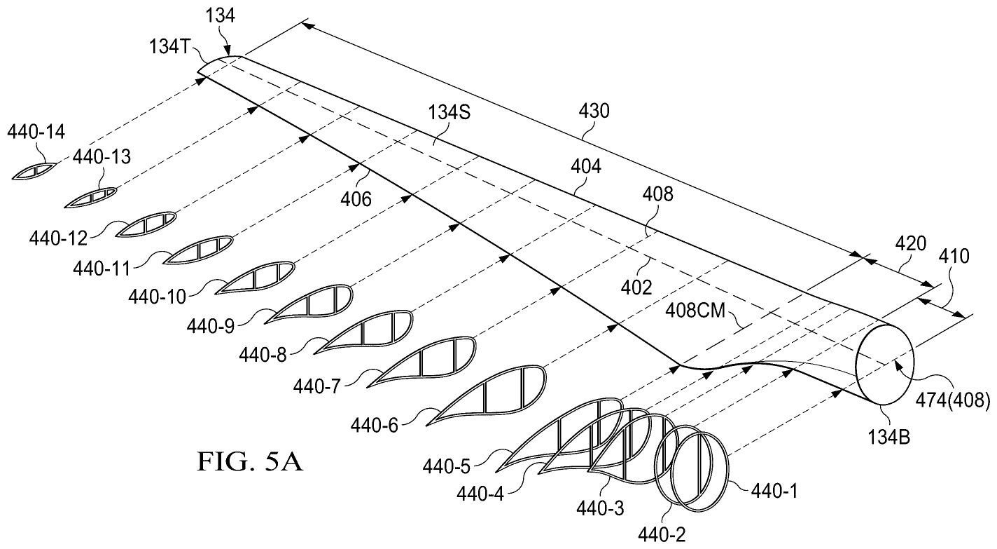

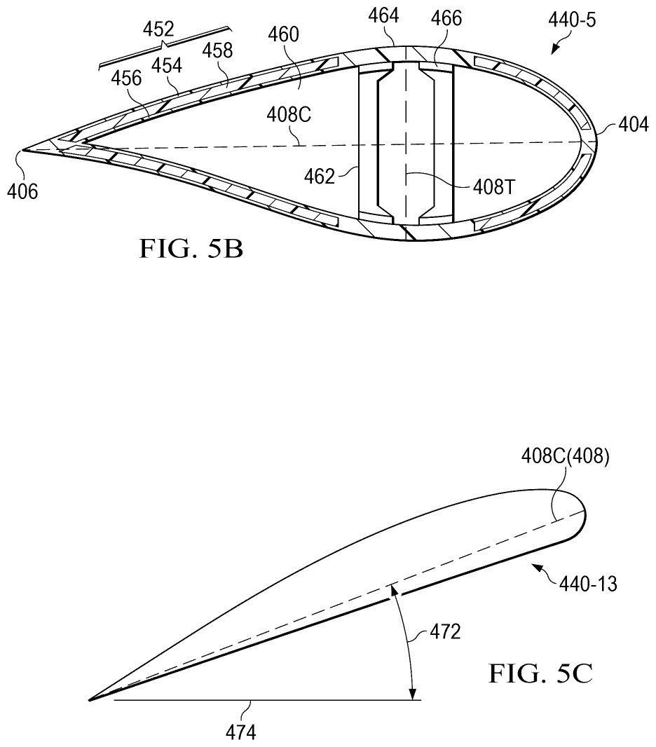

FIG. 1 is a perspective view of a process assembly including a process device and a wind turbine air mover assembly, according to some example embodiments. FIG. 2A is a cross-sectional view along cross-sectional view line IIA-IIA′ in FIG. 1 of a process assembly including a process device and a wind turbine air mover assembly above the process device, according to some example embodiments. FIG. 2B is a cross-sectional view along cross-sectional view line IIA-IIA′ in FIG. 1 of a process assembly including a process device and an air mover assembly, according to some example embodiments. FIG. 2C is a cross-sectional view of a process assembly including an air mover assembly beneath the process device, according to some example embodiments. FIG. 2D is a cross-sectional view of a process assembly, according to some example embodiments. FIG. 3 is a cross-sectional view along cross-sectional view line III-III′ in FIG. 2A of a process assembly including a process device and an air mover assembly, according to some example embodiments. FIG. 4A is an expanded view of region 4A in FIG. 2A, according to some example embodiments. FIG. 4B is a cutaway perspective view of a bearing of the wind turbine rotor assembly according to some example embodiments. FIG. 5A is a perspective view of an individual rotor blade of a wind turbine rotor assembly according to some example embodiments. FIG. 5B is a cross-sectional view of a particular cross-section of the individual rotor blade of FIG. 5A according to some example embodiments. FIG. 5C is a cross-sectional view of a particular cross-section of the individual rotor blade of FIG. 5A according to some example embodiments.

Referring to FIGS. 1, 2A-2D, and 3, a process assembly 100 may include one or more process devices 110 that are each configured to perform one or more processes (e.g., one or more industrial processes) based on an air flow 180 being directed to flow over at least a portion of the one or more process devices 110 (e.g., over one or more surfaces of the one or more process devices 110), and a wind turbine air mover assembly 120 configured to generate the air flow 180 flow over at least the portion of the one or more process devices 110 based on driving a wind turbine rotor assembly 130 to rotate 130R around its central axis 130A to cause at least a portion of the air flow 180 to move vertically through the wind turbine air mover assembly 120.

As shown in FIGS. 1, 2A-2D, and 3, the process assembly 100 may include a cylindrical shroud structure 102, also referred to herein as a shroud structure, a shroud, or the like, which may be configured to direct air flow 180 through at least a portion of the process assembly 100. The shroud structure 102 may be configured to act as a diffuser for the air flow 180 through the process assembly 100. As shown, the shroud structure 102 may include one or more cylindrical inner surfaces 102S that at least partially define a cylindrical enclosure 100V (also referred to herein as a central enclosure space) having an open top opening 100T that facilitates flow communication between the enclosure 100V and the external ambient environment 190 and which may be defined by the top edge of the shroud structure 102. As further shown, the process assembly 100 may include one or more bottom openings 100B that facilitate flow communication between the enclosure 100V and the external ambient environment 190. The one or more bottom openings 100B may be defined by openings in the shroud structure 102 (e.g., openings through the thickness of the shroud structure extending between the enclosure 100V and the ambient environment 190). In some example embodiments, including the example embodiments shown in FIG. 2A, the one or more bottom openings 100B may be defined by openings in one or more process devices 110 which may be beneath the shroud structure 102 and/or may protrude through a sidewall thickness of the shroud structure 102 from the enclosure 100V to the external ambient environment 190. In some example embodiments, including the example embodiments shown in FIG. 2B, the one or more bottom openings 100B may be defined by openings in the shroud structure 102 proximate to the bottom of the shroud structure 102.

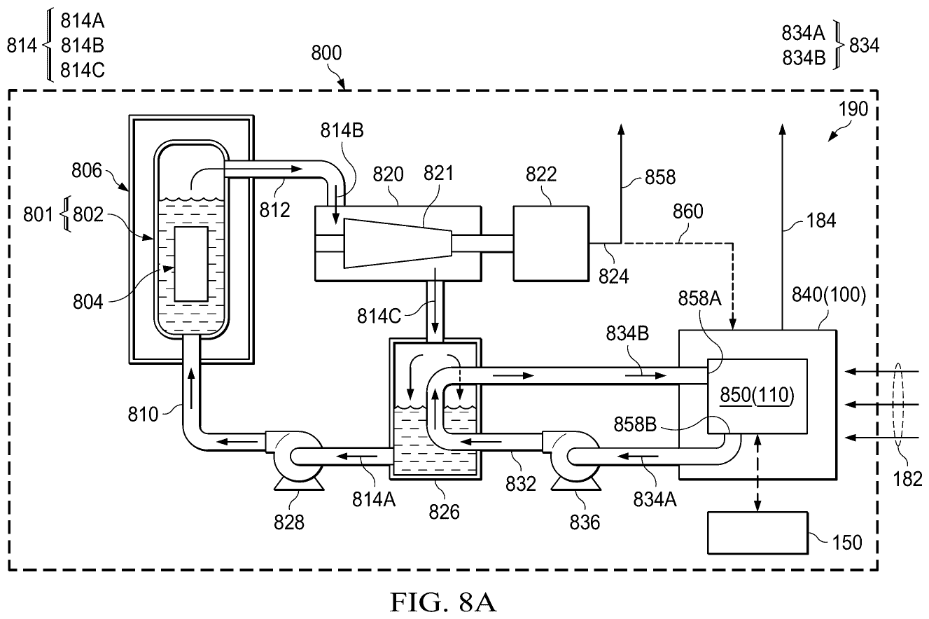

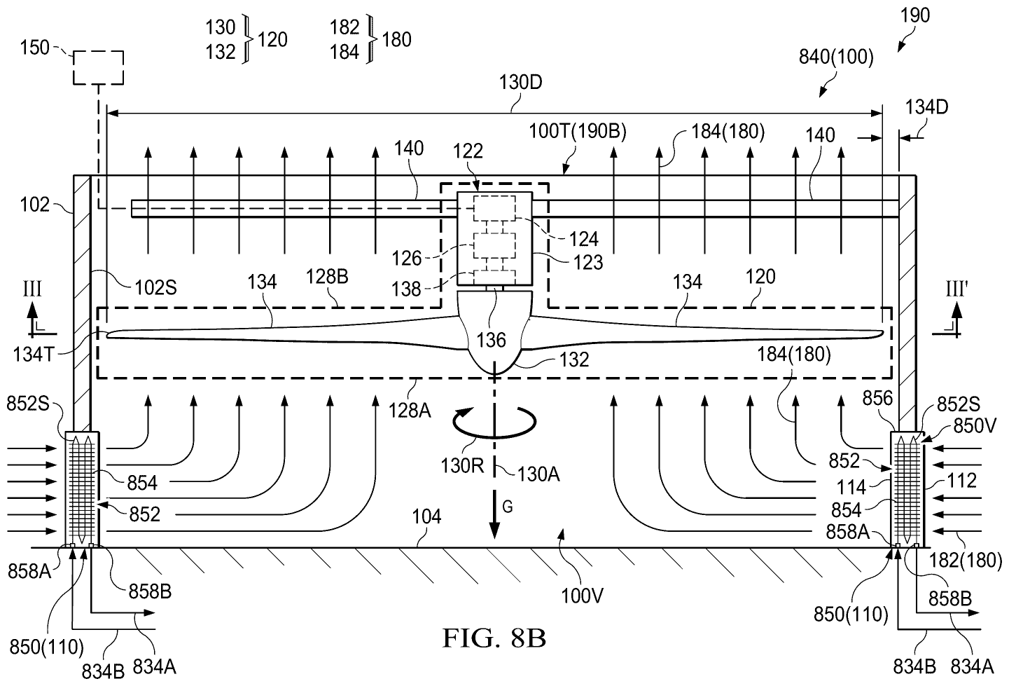

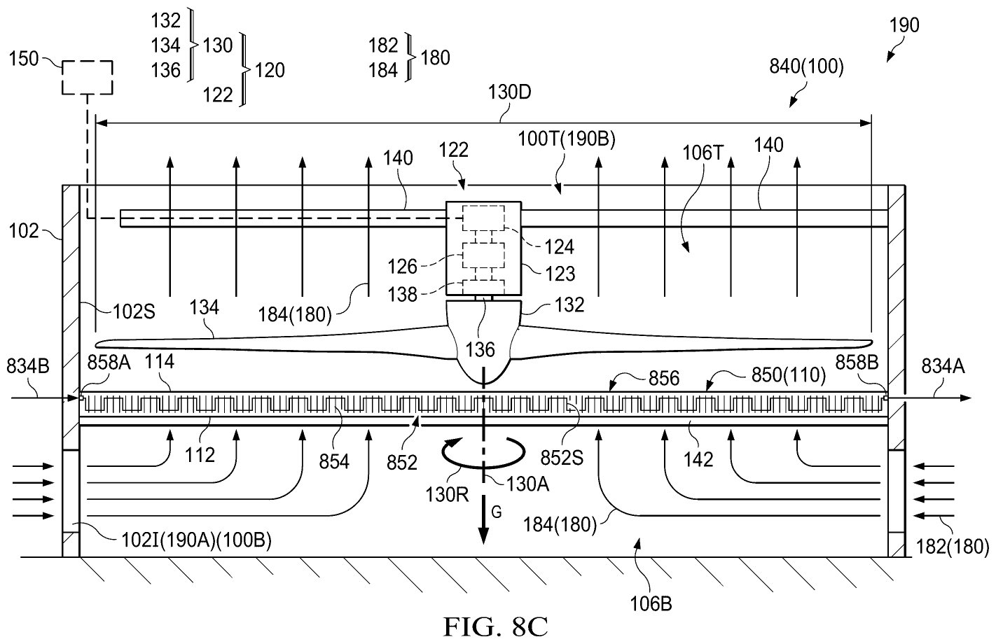

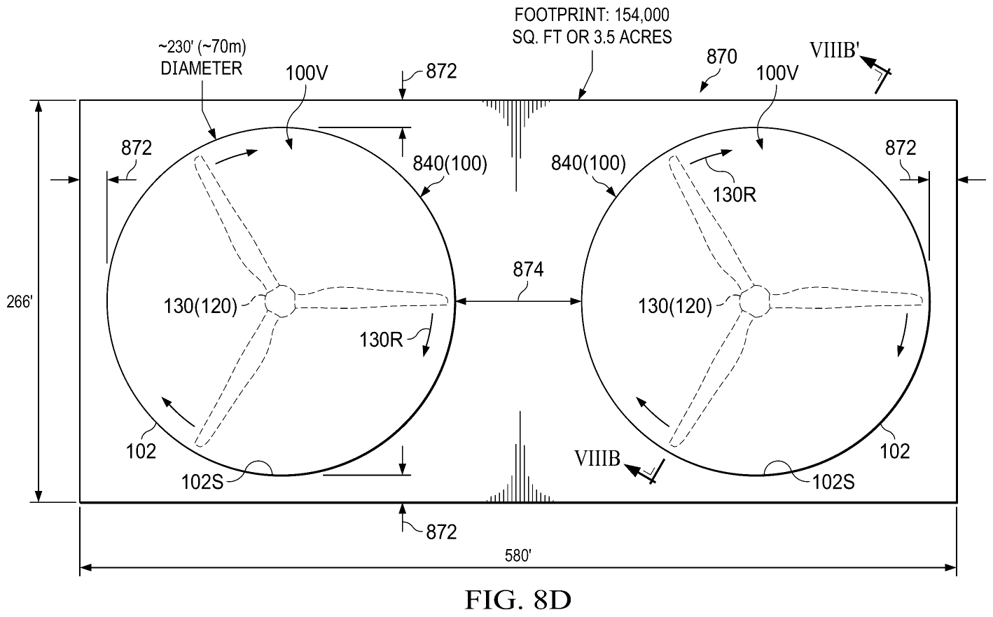

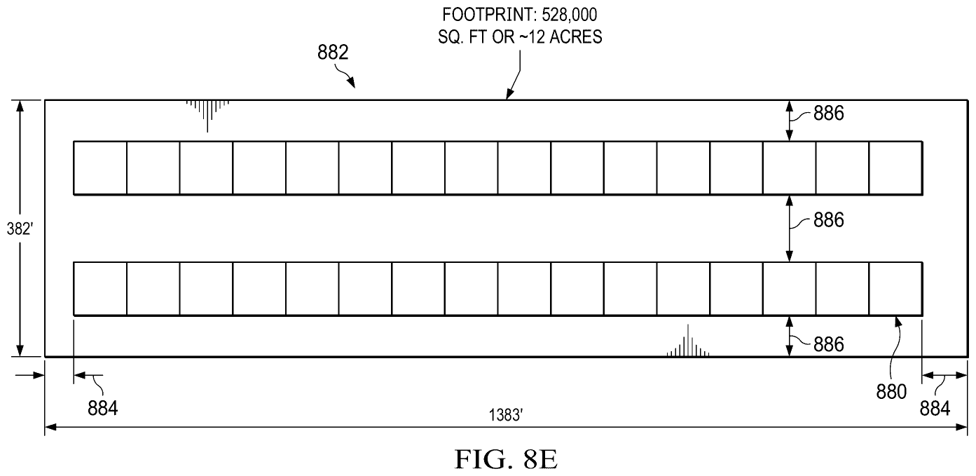

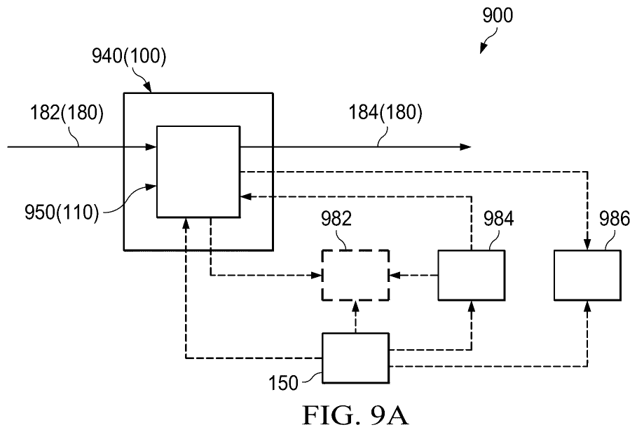

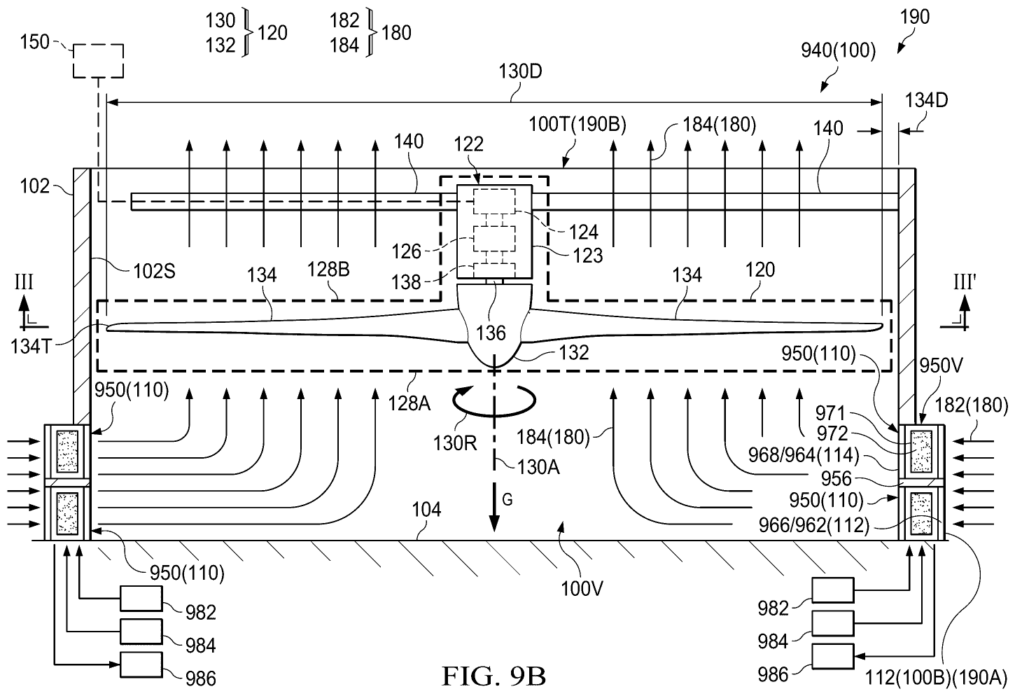

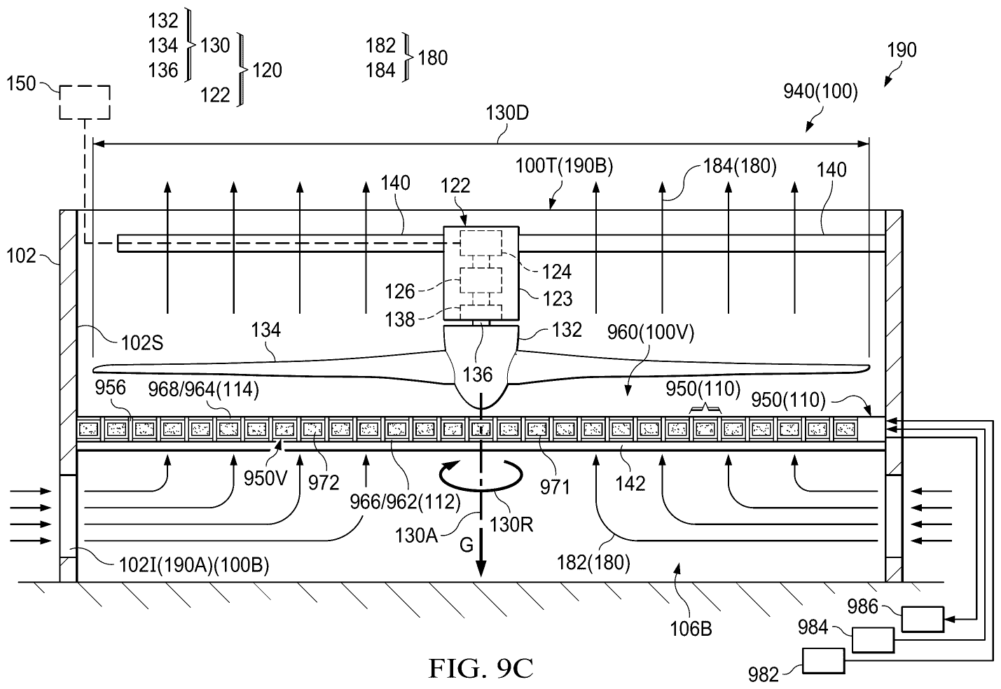

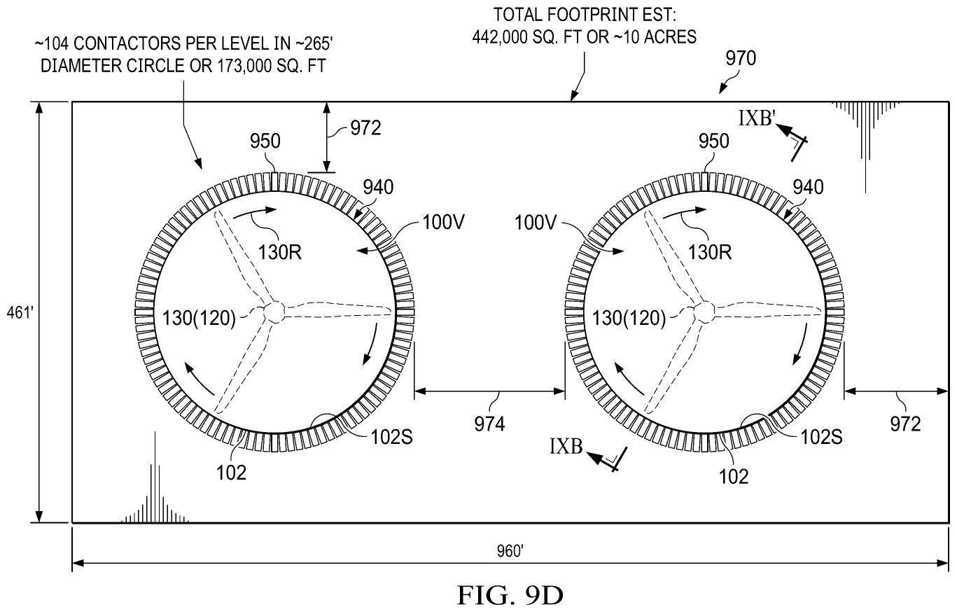

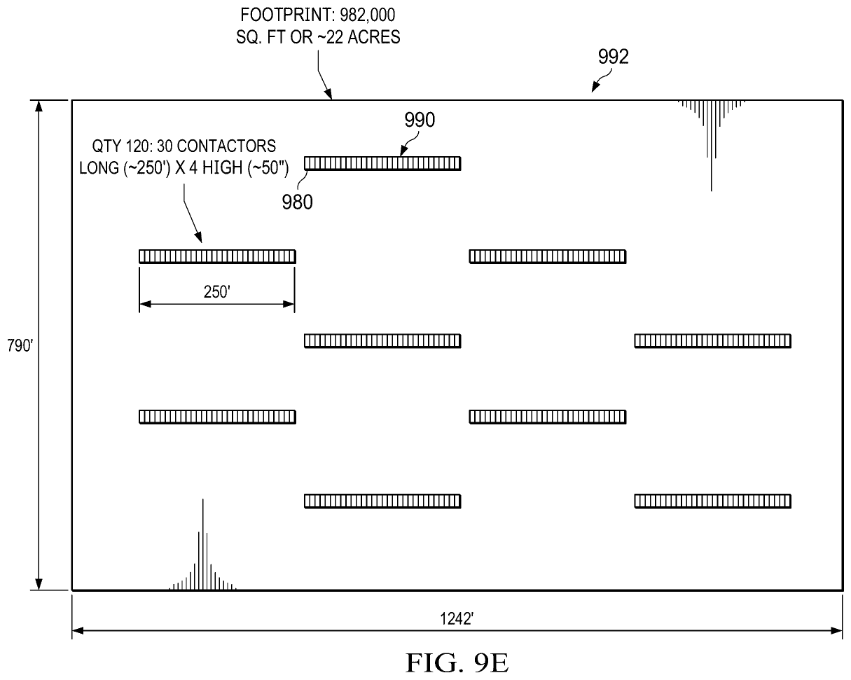

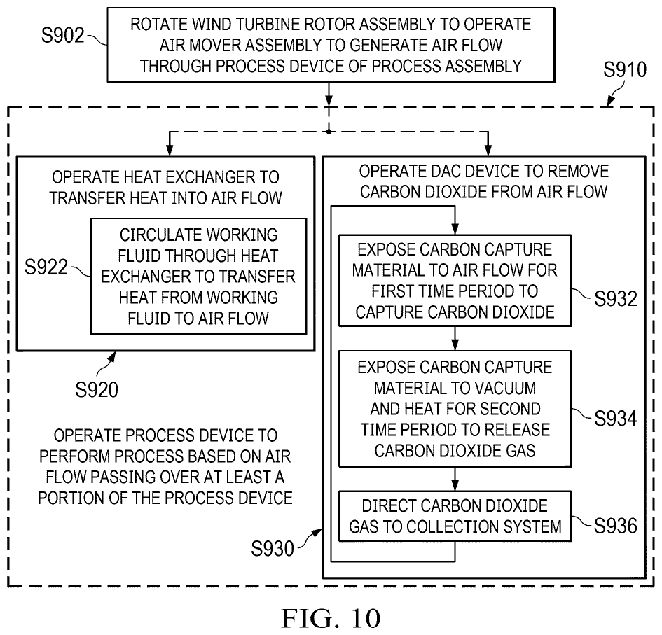

Still referring to FIGS. 1, 2A-2D, and 3, the process assembly 100 may include one or more process devices 110 that are each configured to perform one or more processes based on at least a portion of an air flow 180 flowing over at least a portion of the one or more process devices 110 (e.g., over one or more surfaces of the one or more process devices 110). Such one or more processes that may be performed by a process device 110 based on such directed air flow 180 may include one or more industrial processes, including for example a physical process, a mechanical process, a chemical process, or any combination thereof. For example, as described further herein with regard to FIGS. 8A-8E and 9A-9E, a process device 110 may include at least one of a heat exchanger configured to reject heat (e.g., also referred to herein interchangeably as transfer heat) from a working fluid into at least a portion of the air flow directed to flow over at least a portion of the heat exchanger (e.g., one or more surfaces of the heat exchanger and/or the working fluid itself), a direct air capture (DAC) device configured to capture carbon dioxide from at least a portion of the air flow 180 flowing over a carbon capture material (e.g., flowing over a surface of and/or though a carbon capture material), or any combination thereof. A heat exchanger that may be included in a process device 110, as described herein, may include any known closed-loop or open-loop heat exchanger, including for example a finned tube heat exchanger, a plate fin heat exchanger, a shell and tube heat exchanger, a phase change heat exchanger, a direct contact heat exchanger, any combination thereof, or the like. A DAC device that may be included in a process device 110, as described herein, may include any known DAC module, DAC device, DAC system, or the like, including DAC devices that utilize a solvent to absorb carbon dioxide from an air flow or utilize a sorbent to adsorb (e.g., bind) carbon dioxide from an air flow 180.

Still referring to FIGS. 1, 2A-2D, and 3, the wind turbine air mover assembly 120 may be located within the cylindrical enclosure 100V and may be configured to generate the air flow 180 as a flow of intake air 182 drawn from the ambient environment 190, caused to flow through the process assembly 100 (e.g., through the cylindrical enclosure 100V) such that at least a portion of the air flow 180 flow over at least a portion of the one or more process devices 110 (e.g., through and/or over one or more surfaces of the one or more process devices 110), and to be discharged as exit air 184 back to the ambient environment 190.

Referring to FIGS. 1, 2A-2D, and 3, and further referring to FIG. 4A, the wind turbine air mover assembly 120 may include a wind turbine rotor assembly 130 and a driver assembly 122 (also referred to herein as a nacelle). The driver assembly 122 may include a drive motor 124 within a driver assembly housing 123. The drive motor 124 may include any known motor, including any known electric motor, any known combustion-driven motor, or the like. The driver assembly 122 may include a gearbox 126 mechanically coupled to the drive motor 124 within the driver assembly housing 123, but example embodiments are not limited thereto.

The wind turbine rotor assembly 130 includes a central rotor hub 132 and a plurality of rotor blades 134 extending radially from the central rotor hub 132. The rotor blades 134 may each be interchangeably referred to herein as a wind turbine rotor blade. The wind turbine rotor assembly 130 is illustrated in FIGS. 1-4A as including three rotor blades 134, but it will be understood that example embodiments are not limited thereto, and greater or fewer quantities of rotor blades 134 may be included in a given wind turbine rotor assembly 130. The wind turbine rotor assembly 130 may have a central axis 130A, and the wind turbine rotor assembly 130 may be configured to rotate 130R around the central axis 130A. The rotor blades 134 may extend radially away from the central axis 130A along respective spans 402 (e.g., longitudinal axes) in a horizontal plane extending perpendicular to the central axis 130A. The wind turbine rotor assembly 130 may be mechanically coupled to the drive motor 124 via a main shaft 136, such that the wind turbine rotor assembly 130 may be configured to rotate 130R around the central axis 130A based on operation of the drive motor 124. In some example embodiments, the main shaft 136 may be coupled to the drive motor 124 via a gearbox 126. In some example embodiments, the gearbox 126 is omitted from the wind turbine air mover assembly 120, such that the wind turbine rotor assembly 130 (e.g., the main shaft 136) is directly connected to the drive motor 124 (e.g., directly connected to the driveshaft of the drive motor 124) in a direct-drive configuration (e.g., without any intermediate couplings).

The wind turbine rotor assembly 130 may include one or more bearings configured to provide for movement of elements thereof (e.g., rotation of the main shaft 136 in relation to the driver assembly housing 123, rotation of the rotor blades 134 in relation to the rotor hub 132, etc.), including for example a main shaft bearing 138, rotor blade pitch bearings 139, or the like. The main shaft bearing 138 and the rotor blade pitch bearings 139 may include any known bearing or combination of bearings which may be used in a wind turbine rotor assembly. Any bearing or combination of bearings that may be included in the wind turbine air mover assembly 120, including for example the main shaft bearing 138, the rotor blade pitch bearings 139, or the like, may each independently be one or more of a shaft-tapered ball bearing, a spherical roller bearing, a tapered roller bearing (TRB) a cylindrical roller bearing (CRB), a thrust roller bearing, a thrust ball bearing, any combination thereof, or the like. For example, referring to FIG. 4B, any bearing that may be included in the wind turbine air mover assembly 120, including for example the main shaft bearing 138, the rotor blade pitch bearings 139, or the like, may each independently be any one or more of a thrust ball bearing, a thrust roller bearing as shown in FIG. 4B, or the like. In FIG. 4B, a thrust roller bearing, which may comprise the main shaft bearing 138 and/or a rotor blade pitch bearing 139, may include a housing race 392, a shaft race 394, a cage 396, and rolling elements 398 (e.g., rollers). The main shaft bearing 138 may be understood to be included as a part of the wind turbine rotor assembly 130 or as a part of the wind turbine air mover assembly 120 external to the wind turbine rotor assembly 130.

As shown in at least FIGS. 2A-2D, the drive motor 124 may be electrically coupled to a control system 150, which may include a power supply. The control system 150 may be configured to control operation of the wind turbine air mover assembly 120 based on controlling a supply of electrical power to the drive motor 124. The control system 150 may be included as a part of the process assembly 100 or may be external to the process assembly 100. The control system 150 may include any known computing device, electronic device, or the like. For example, the control system 150 may include a memory (e.g., a non-transitory computer readable storage medium, including for example a solid state drive memory device) storing a program of instructions and a processor (e.g., a central processing unit) configured to load and execute the program of instructions to cause the control system 150 to control operation of at least a portion of the process assembly 100, for example based on controlling a supply of electrical power from a power source (e.g., mains power) to the drive motor 124 to control air flow 180 generation by the wind turbine air mover assembly 120.

Still referring to FIGS. 1, 2A-2D, 3, and 4A, the wind turbine air mover assembly 120, and thus the wind turbine rotor assembly 130, may be oriented vertically in relation to the direction of gravity G, referred to herein interchangeably as a vertical axis configuration, a vertical axis orientation, or the like, such that the central axis 130A of the wind turbine rotor assembly 130 extends in parallel to the direction of gravity G and the plurality of rotor blades 134 extend spanwise (e.g., along span 402) through a horizontal plane extending perpendicular to the direction of gravity G and further such that the wind turbine rotor assembly 130 is configured to cause the air flow 180 to move vertically (e.g., parallel to the direction of gravity) through the wind turbine rotor assembly 130, parallel to the central axis 130A, based on operation of the drive motor 124. Such an orientation of the wind turbine air mover assembly 120, and thus the wind turbine rotor assembly 130, may be referred to herein as the wind turbine air mover assembly 120 and/or the wind turbine rotor assembly 130 being in a “vertical axis” configuration.

Still referring to FIGS. 1, 2A-2D, and 3, and further referring to FIGS. 4A-4C, and 5A-5C, in some example embodiments the wind turbine air mover assembly 120 is an air mover assembly having a rotor assembly (the wind turbine rotor assembly 130, also referred to herein as simply a rotor) having a “wind turbine” configuration, wherein the wind turbine rotor assembly 130 includes a rotor assembly and/or rotor blades (e.g., “wind turbine rotor blades”) corresponding to (e.g., is similar to, is identical to, is repurposed from, etc.) a rotor assembly and/or rotor blades used in a wind turbine configured to generate electrical power based on rotating 130R the wind turbine rotor assembly 130 due to wind (e.g., a wind turbine rated to generate about 750 kW of electrical power). For example, FIG. 4A illustrates the wind turbine air mover assembly 120, including the driver assembly 122 and wind turbine rotor assembly 130 thereof, as being a nacelle and rotor assembly derived (e.g., repurposed) from a wind turbine (e.g., wind turbine generator) that is configured to generate electrical power based on rotation 130R of the wind turbine rotor assembly 130 due to impinging wind, where the driver assembly 122 and the wind turbine rotor assembly 130 are rotated to align the central axis 130A to be parallel with the direction of gravity G and where an electrical power generator of the wind turbine (which could be configured to generate electrical power based on rotation 130R of the wind turbine rotor assembly 130) is replaced with the drive motor 124 to configure the air mover assembly 120 to induce the rotation 130R of the wind turbine rotor assembly 130 around the central axis 130A based on operation of the drive motor 124. It will be understood that the rotation 130R of the wind turbine rotor assembly 130 may refer to rotation of the wind turbine rotor assembly 130 in relation to the driver assembly 122.

Referring to FIGS. 5A-5C, a wind turbine rotor blade 134 that is included in a wind turbine rotor assembly 130 may define (e.g., may have) an airfoil shape which may have a root section 410 (also referred to herein interchangeably as a “root”) and a varying ratio of profile thickness 408T (also referred to herein interchangeably as maximum profile thickness) to profile chord 408C along a chord line 408 (the profile thickness 408T being perpendicular to the profile chord 408C) along at least a portion of the length, or span 402 (e.g., longitudinal axis) from the base 134B to the tip 134T of the rotor blade 134. As a result, as shown in FIG. 5A, the cross-section (also referred to herein interchangeably as the profile, cross-sectional profile, etc.) of the rotor blade 134 perpendicular to the span 402 (e.g., perpendicular to the longitudinal axis) may vary in size and/or shape from the base 134B to the tip 134T of the rotor blade 134, as shown by the cross-sectional profiles 440-1 to 440-14 that are perpendicular to the span 402 (e.g., longitudinal axis) in FIG. 5A. As shown, the profile chord 408C (e.g., the line, or distance, extending perpendicular to the longitudinal axis of the span 402 from the leading edge 404 to the trailing edge 406 of the rotor blade 134) and/or the profile thickness 408T (extending perpendicular to the profile chord 408C) in a given cross-sectional profile 440-1 to 440-14 of the rotor blade 134 may vary along the span 402 (e.g., longitudinal axis) of the rotor blade 134 so that the ratio of the profile thickness 408T to the profile chord 408C varies along at least a portion of the span 402 (longitudinal axis) of the rotor blade 134 from at least the root section 410 to the tip 134T (e.g., along the span of the airfoil section 430).

As shown in FIG. 5A, the rotor blade 134 may have a root section 410, also referred to as a root, wherein the cross-sectional profiles 440-1, 440-2 (e.g., profiles) taken from the root section 410 are circular or substantially circular, corresponding to equal or substantially equal profile thickness 408T and profile chord 408C at the profiles 440-1 and 440-2 of the root section 410 (e.g., corresponding to a circular rotor blade pitch bearing 139 at the base 134B to connect the base 134B to the rotor hub 132), such that the root section 410 of the rotor blade 134 be a circular cylindrical or substantially circular cylindrical shape. However, example embodiments are not limited thereto, and the root section 410 may have any shape, including any cylindrical shape. The profile chord 408C of cross-sectional profiles (e.g., 440-1 and 440-2) the root section 410 may be referred to a root profile chord of the root section. The root profile chord 408C may extend in a reference direction (e.g., a horizontal direction) in relation to the base 134B.

The rotor blade 134 may have an airfoil section 430 defining the main airfoil portion of the rotor blade 134 having a profile chord 408C that varies from the tip 134T at one end of the airfoil section 430 to a maximum profile chord 408CM of the rotor blade 134 at an opposite end of the airfoil section 430, as shown by cross-sectional profiles 440-5 to 440-14 taken from the airfoil section 430 along the length therefrom from the maximum profile chord 408CM to the tip 134T. The rotor blade 134 may have a transition section 420 between the root section 410 and the airfoil section 430, wherein the transition section 420 varies the cross sectional profile of the rotor blade 134 from the circular or substantially circular cross-sectional profile of the root section 410 to the airfoil cross sectional profile of the airfoil section 430 at the maximum profile chord 408CM, for example such that the profile chord 408C increases along at least a portion of the span 402 away from the base 134B (e.g., away from at least the root section 410) to a maximum profile chord 408CM, which may represent the boundary of the airfoil section 430, and where the profile chord 408C may decrease from the maximum profile chord 408CM towards the tip 134T. The airfoil section 430 may be understood to be a portion of the rotor blade 134 extending from the location of the maximum chord 408C along the span 402 to the tip 134T.

Still referring to FIGS. 5A-5C, the rotor blade 134 may include a body structure 452 that defines the structure and shape of the rotor blade 134, including the outer surface 134S thereof, the root section 410, the airfoil section 430, the transition section 420, a variation of the ratio of profile thickness 408T to profile chord 408C along any portion of the span 402 of the rotor blade 134, a variation of twist angle 472 along any portion of the span 402 of the rotor blade 134, an enclosure 460 within the interior of any portion of the rotor blade 134, or any combination thereof. The body structure 452 may include one or more composite materials. In some example embodiments, the body structure 452, and thus some or all of the root section 410, transition section 420, and/or airfoil section 430, may partially or entirely comprise (e.g., may be formed of) one or more composite materials. The one or more composite materials may include one or more of carbon fiber, epoxy, fiberglass, polyester, balsa-wood, polyvinyl chloride (PVC) foam, or the like. The one or more composite materials may include a fiber-reinforced plastic material, including for example a fiberglass-reinforced polyester defining at least the outer surface 134S of the rotor blade 134. The one or more composite materials may include an inner material laminated with one or more shell materials. For example, FIG. 5B shows a cross-sectional profile 440-5 of a rotor blade 134, where the rotor blade 134 may have a body structure 452 which may include a composite (e.g., fiberglass, carbon fiber, etc.) outer shell 454 (e.g., laminate) which may define the outer surface 134S of the rotor blade 134, and the body structure 452 may include an inner material 458 (e.g., polyester, PVC foam, balsa-wood, etc.), also referred to as a “core,” which may be covered (e.g., laminated, reinforced, etc.) by the composite outer shell 454 (e.g., as a laminated outer shell), which may also be referred to as a “skin.”

In some example embodiments, and for example as shown in FIGS. 5A and 5B, the body structure 452 may define an enclosure 460 (also referred to as an enclosure space) within the interior of the rotor blade 134, such that the body structure 452 may be understood to be at least partially hollow. Thus one or more cross sectional profiles along the span 402 (e.g., cross-sectional profile 440-5 as shown in at least FIG. 5B) may have an enclosure 460 within an interior of the cross-sectional profile which may be surrounded by at least a portion of the body structure 452 (e.g., the outer shell 454 and inner material 458), thereby enabling a low weight of the rotor blade 134 despite potentially having a relatively long span 402 (e.g., a span 402 of 20-25 meters corresponding to a rotor diameter 130D of 50 meters, a span 402 of 30-35 meters corresponding to a rotor diameter 130D of 70 meters, a span 402 of 40-50 meters corresponding to a rotor diameter 130D of 100 meters, etc.). The body structure 452 may include an inner composite structure, or shell 456 (e.g., fiberglass, carbon fiber, etc.) such that the body structure 452 may include a sandwich structure of the inner material 458 (e.g., PVC foam, polyester, balsa-wood, etc.), also referred to as a “core,” reinforced by inner and outer shells 454 and 456 (e.g., carbon fiber, fiberglass, etc.), also referred to as “skins.” Such a material composition may further enable a low weight of the rotor blade 134 despite potentially having a relatively long span 402 (e.g., corresponding to a rotor diameter of 50 meters, 70 meters, 100 meters, etc.). In some example embodiments, at least a portion of the body structure 452, for example a portion of the body structure 452 defining at least the outer surfaces 134S and an enclosure 460 within an interior of the rotor blade 134, may include a single, unitary piece of material instead of a sandwich structure of an inner material 458 reinforced by inner and outer shells 454 and 456. For example, at least a portion of the body structure 452 defining at least the outer surfaces 134S and an enclosure 460 within an interior of the rotor blade 134 (and in some example embodiments further comprising one or more webbing structures 462) may comprise a single, unitary piece of material. Such a single, unitary piece of material may include a single, unitary piece of a fiber-reinforced plastic material, including for example a fiberglass-reinforced polyester structure.

As shown, the interior structure of the rotor blade 134 may include one or more webbing structures 462 (e.g., shear webbing) which may extend through the enclosure 460, between opposing inner surfaces of the body structure 452, along the profile thickness 408T of the rotor blade 134 and may be coupled to the opposing inner surfaces of the body structure 452 via a bond 466, which may be any known adhesive, weld, or the like. In some example embodiments, the one or more webbing structures 462 may be integrated into the body structure 452 such that the webbing structures 462, the portions of the body structure 452 defining the spar-caps 464, the outer shell 454, or the like may be separate portions of a single, unitary piece of material, such that the bonds 466 may be omitted.

As further shown, the body structure 452 may include composite material caps (e.g., comprising fiberglass, carbon fiber, or the like) at the leading edge 404, the trailing edge 406, and spar-caps 464. In some example embodiments, a rotor blade 134 of the wind turbine rotor assembly 130 may have a fiberglass-reinforced polyester blade design (e.g., the body structure 452 may comprise a fiberglass-reinforced polyester structure). At larger scale of rotor blades 134 of a wind turbine rotor assembly 130 having a rotor diameter 130D of 50 meters, 70 meters, 100 meters, or the like, body structure 452 of the rotor blades 134 may define the enclosure 460 within at least a portion of the span 402 of the rotor blades 134, as shown in at least FIGS. 5A and 5B. As shown, the airfoil shapes made with spar-caps 464, shear-webs (e.g., webbing structures 462), and a sandwich structures of shells (e.g., laminates) 454 and 456 and inner material 458 (e.g., at least partially comprising composite material construction), as shown in at least FIG. 5B, and further with the root section 410 and varying thickness to chord ratio as shown in FIG. 5A, the rotor blade 134 may have exceptionally low weight and high strength despite having a relatively large span 402 length (e.g., about 20-25 meters, about 30-35 meters, about 40-45 meters, about 45-50 meters, etc.).

As shown in at least FIG. 5B, an enclosure 460 may be an enclosure space that may be completely enclosed by the body structure 452 within a cross-sectional profile extending perpendicular to the span 402. The enclosure 460 may be a hollow enclosure having an empty space which may be filled with a gas (e.g., air). However, example embodiments are not limited thereto. For example, in some example embodiments the enclosure 460 may be partially or entirely filled with one or more materials, such that the enclosure 460 defined by the body structure 452 may be a filled enclosure. Such one or more materials filling the enclosure 460 (e.g., separately from structures of the body structure 452 extending through the enclosure 460 such as webbing structures 462) may be referred to as one or more filler materials. A filler material that may be included in the enclosure 460 (e.g., to partially or entirely fill the enclosure 460) may be a material that is different from a material of the body structure 452 which defines at least the outer surface 134S, the profile chord 408C, the profile thickness 408T, or any combination thereof. The filler material at least partially filling the enclosure 460 may be less rigid than a material partially or entirely comprising the body structure 452. The filler material at least partially filling the enclosure 460 may have a lower density than a material partially or entirely comprising the body structure 452, such that a wind turbine rotor blade 134 may include a high-density body structure (e.g., comprising a composite structure such as fiberglass-reinforced polyester) surrounding a lower-density filler material (e.g., polyethylene foam, polystyrene foam, polyurethane foam, polyvinyl chloride foam) that at least partially or entirely fills an enclosure 460 defined by the body structure 452 within the interior of the rotor blade 134. The body structure 452 may be configured to be more load-bearing than the filler material at least partially comprising the enclosure 460. A filler material that may be included in the enclosure 460 (e.g., to partially or entirely fill the enclosure 460, aside from body structure 452 elements such as one or more webbing structures 462) may include one or more foam materials. A foam material may include, for example, polyethylene foam, polystyrene foam, polyurethane foam, polyvinyl chloride foam, or the like. In some example embodiments, the presence of the enclosure 460 within the rotor blade 134 may configure the rotor blade 134 to have improved flexibility (e.g., flapwise bending flexibility, torsion or twisting flexibility, edgewise bending flexibility, etc.), durability, ductility, or the like. The presence of filler material within the enclosure 460 may configure the rotor blade 134 to have improved flexibility (e.g., flapwise bending flexibility, torsion or twisting flexibility, edgewise bending flexibility, etc.), durability, ductility, or the like with improved resistance to damage due to flexing, bending, etc. of the rotor blade 134. In some example embodiments, the body structure 452 is the load-bearing structure of the rotor blade 134 that transfers the weight of the rotor blade 134 to the rotor hub 132. In some example embodiments, a wind turbine rotor blade 134 may have a body structure 452 that is a solid structure (e.g., not having any hollow interior) and omits the internal enclosure 460 and which may omit the webbing structures 462.

Still referring to FIG. 5A, the body structure 452 of the rotor blade 134 may define a root section 410 having a cylindrical shape or substantially cylindrical shape, for example where the cross-section of the root section 410 (e.g., shown by sections 400-1 and 400-2) may be circular or substantially circular in shape such that the root section 410 has a circular cylindrical shape. As a result, the root section 410 may contain the majority of the weight of the rotor blade 134 for structural integrity of the rotor blade 134, thereby enabling the rotor blade 134 to have a very long span 402 while being structurally supported by the rotor hub 132 at the base 134B (e.g., with or without any other external supports of the rotor blade 134 along the span 402) without compromising structural integrity of the rotor blade 134. A higher ratio of profile thickness 408T to profile chord 408C (e.g., 1:1 or about 1:1) in the root section 410, adjacent to the base 134B, may ensure the improved or maximum structural integrity of the rotor blade 134 despite a relatively large span 402 length of the rotor blade 134.

As shown in at least FIGS. 5A-5C, the root section 410 may be understood to extend along a first span portion of the span 402 of the rotor blade 134 (e.g., extending from the base 134B at least partially along the span 402 towards the maximum profile chord 408CM. As shown in FIGS. 5A-5C, the airfoil section 430 may extend along a separate, second span portion of the span 402 of the rotor blade 134 to a tip 134T of the rotor blade. As shown, each cross-sectional profile of the airfoil section 430 (e.g., profiles 440-5 to 440-14 as shown in FIG. 5A) may have an airfoil profile chord 408C and a profile thickness 408T perpendicular to the airfoil profile chord 408C. A ratio between the airfoil profile chord 408C and the profile thickness 408T may vary (e.g., the ratio of chord to thickness may increase, the ratio of the thickness to chord may decrease, etc.) along at least a portion of the second span portion.

As shown in at least FIG. 5C, the airfoil (e.g., airfoil section 430) of the rotor blade 134 may exhibit a “twist” of the rotor blade 134 body shape, as defined by the body structure 452, due to variation (e.g., twisting) of the shape of the cross-sectional profile of the rotor blade 134 along at least a portion of the span 402, including for example a portion of the span 402 extending from the maximum profile chord 408CM to the tip 134T, such that the profile chord 408C along a chord line 408 of a given cross-sectional profile (e.g., 440-5 to 440-14) in the airfoil section 430 defines a twist angle 472 with the root profile chord of the root section 410. The shape of the rotor blade cross-sectional profile may “twist” along at least a portion of the span 402 (e.g., from the maximum profile chord 408CM to the tip 134T) such that the twist angle 472 varies along the span 402 (e.g., longitudinal axis) of the rotor blade towards the tip 134T. For example, the body structure 452 of the rotor blade 134 may define the twist angle 472 between the airfoil profile chord 408C of the airfoil section 430 and a reference profile chord 474, which as described herein may be (but is not limited to) the root profile chord 408C of the root section 410 such that the twist angle 472 varies along at least a portion of the second span portion of the rotor blade 134 in which the airfoil section 430 extends. Such blade twist, as shown in at least FIG. 5C, may configure the rotor blade 134 to maintain a generally consistent (e.g., almost constant) angle of attack (e.g., represented by twist angle 472) along the span 402 (e.g., longitudinal axis) of at least the airfoil section 430 of the rotor blade 134. As shown in FIGS. 5A and 5C, a wind turbine rotor blade 134 may be twisted across the spanwise axis (e.g., along the longitudinal axis of the span 402) ensuring constant or substantially constant angles of attack between the profile chord 408C and the relative direction of air flow across the rotor blade 134 that ensures homogeneous distribution of lift across the entire rotor blade 134 span 402 of at least the airfoil section 430, thereby configurating a wind turbine rotor assembly 130 that includes the rotor blade 134 to have improved air moving efficiency (e.g., configuration to maintain a certain induced flow rate of air flow 180 with reduced power consumption by the air mover assembly 120) for a given rotor diameter 130D. Accordingly, it will be understood that a body structure 452 of a wind turbine rotor blade may have a twist angle 472 between profile chord 408C of at least the airfoil section 430 and a reference profile chord 474 (e.g., the root profile chord 408C) that varies along at least a portion of the span 402 of the rotor blade 134 toward the blade tip 134 so as to configure the rotor blade 134 to maintain a constant or substantially constant angle of attach between the profile chord 408C and the relative direction of air flow across the rotor blade 134 during rotation 130R of the rotor assembly 130 that comprises the rotor blade 134.

It will be understood that the ratio between the airfoil profile chord 408C and the profile thickness 408T may vary along at least a first portion of the second span portion of the span 402 in which the airfoil section 430 is located, and the twist angle 472 may vary along at least a second portion of the second span portion of the span 402 in which the airfoil section 430 is located. The first and second portions of the second span portion in which the airfoil section 430 is located may be the same portion of the span 402 or different portions of the span 402 (e.g., partially overlapping portions).

The composite material composition of the rotor blade 134, coupled with the enclosure 460 in the interior of the rotor blade 134 (which may be empty to define a hollow enclosure or may be at least partially filled with a filler material) and the shape of the rotor blade 134 including the root section 410 and an airfoil section 430 having variable profile thickness to profile chord ratio along at least a portion of the span 402 towards the tip 134T, may provide a rotor blade 134 having exceptionally low weight and high structural strength for its size. Such a rotor blade 134 may have an exceptionally long span 402, for example such that the rotor diameter 130D of a wind turbine rotor assembly 130 that includes the rotor blade(s) 134 may be about 50 meters to about 100 meters, about 50 meters to about 70 meters, or the like. Such a rotor blade 134 may have a relatively light weight and a high structural integrity despite having such a long span 402. Additionally, the presence of a “twist” of the rotor blade 134 along the span 402, exhibited by the variation (e.g., increase) of the twist angle 472 between the airfoil profile chord 408C of a given cross-sectional profile in the airfoil section 430 from the root profile chord 408C of at least one cross-sectional profile of the root section 410 along the span 402 towards the tip 134T may configure the rotor blade 134, together with the relatively low weight of the rotor blade 134 for its size due to the aforementioned composition and structure thereof, to provide high air moving efficiency.

Referring to FIGS. 5A-5B and further referring back to FIG. 2A and FIG. 3, the wind turbine rotor assembly 130, comprising the rotor hub 132 and a plurality of rotor blades 134, may have a blade radius 134R defined as the radial distance from the central axis 130A of the rotor assembly 130 to the blade tips 134T of the rotor blades 134 and thus is one-half of the rotor diameter 130D of the rotor assembly 130. For example, when the rotor diameter 130D of a rotor assembly 130 is 50 meters, the blade radius 134R is 25 meters. In another example, when the rotor diameter 130D is 70 meters, the blade radius 134R is 35 meters. The rotor assembly 130 may also have a hub radius 132R that extends along a portion of the blade radius 134R. As further shown, the base 134B of the rotor blade 134 (and any rotor blade pitch bearing coupling the base 134B to the hub 132) may be located at a radial distance from the central axis 130A corresponding to the hub radius 132R. As shown, the maximum profile chord 408CM of a rotor blade 134 may be located at a chord radial distance 134C from the central axis 130A that is a portion of the blade radius 134R.

In some example embodiments, the hub radius 132R of a rotor assembly 130 may be about 5% of the blade radius 134R of the rotor assembly 130 from the central axis 130A thereof, although example embodiments are not limited thereto. In some example embodiments, the maximum profile chord 408CM of a rotor blade 134 of a rotor assembly 130 may be at a chord radius 134C that is about 25% of the blade radius 134R of the rotor assembly 130 from the central axis 130A thereof, although example embodiments are not limited thereto.

In some example embodiments, the magnitude of the maximum profile chord 408CM may be a particular proportion of the blade radius 134R. For example, the maximum profile chord 408CM of a rotor blade 134 of a rotor assembly 130 may have a magnitude that is about 8% of the blade radius 134R of the rotor assembly 130 from the central axis 130A thereof, although example embodiments are not limited thereto. In another example,

In some example embodiments, a wind turbine rotor assembly 130 may have a rotor diameter 130D of 70 meters and thus may have a blade radius of 35 meters. The wind turbine rotor assembly 130 may have a hub radius 132R of 1.75 meters and may include a plurality (e.g., three) rotor blades 134 each having a blade length (e.g., span 402) of about 33.25 meters, a total mass of 4,336 kg, a first mass moment of inertia of 46,497 kg-m, a second mass moment of inertia of 798,506 kg-m², a center of mass located 10.72 meters along the span 402 from the base 134B (also referred to herein interchangeably as the root) towards the tip 134T. The rotor blades 134 may each have a profile chord 408C that varies along the span 402. The profile chord 408C may be about 1.9 meters at (e.g., within 2.2 meters along the span 402 of) the base 134B of the rotor blade 134 (e.g., reference profile chord 474, which may be the root profile chord 408C). The profile chord 408C may be a maximum profile chord 408CM of 2.7 meters at a maximum profile chord location along the span 402 that may be about 8.9 meters from the base 134B and thus may be at a chord radius 134C that is about 25% of the blade radius 134R of 35 meters. The profile chord 408C may be about 0.9 meters at the tip 134T (e.g., within 2.2 meters of the tip 134T along the span 402). Accordingly, the profile chord may vary along the span 402 of each rotor blade 134 from about 1.9 meters at the base 134B to a maximum of about 2.7 meters and further to about 0.9 meters at the tip 134T. The rotor blades 134 may each have a twist angle 472 that varies (e.g., decreases) along at least a portion of the span 402 away from the base 134B and towards the tip 134T. The twist angle may be about 11 degrees at the base 134B of the rotor blade 134 (e.g., within 2.2 meters of the base 134B along the span 402). The twist angle 472 may be about 0.08 degrees at the tip 134T (e.g., within 2.2 meters of the tip 134T along the span 402). Accordingly, the twist angle 472 may vary along the span 402 of each rotor blade 134 from about 11 degrees at the base 134B to about 0.08 degrees at the tip 134T.

In some example embodiments, a wind turbine rotor assembly 130 may have a rotor diameter 130D of 50 meters and thus may have a blade radius of 25 meters. The wind turbine rotor assembly 130 may have a hub radius 132R of 1.25 meters and may include a plurality (e.g., three) rotor blades 134 each having a blade length (e.g., span 402) of about 23.75 meters, a total mass of 1,941 kg, a first mass moment of inertia of 14,605 kg-m, a second mass moment of inertia of 180,640 kg-m², a center of mass located 7.52 meters along the span 402 from the base 134B (also referred to herein interchangeably as the root) towards the tip 134T. The rotor blades 134 may each have a profile chord 408C that varies along the span 402. The profile chord 408C may be about 1.4 meters at (e.g., within 1.6 meters along the span 402 of) the base 134B of the rotor blade 134 (e.g., reference profile chord 474, which may be the root profile chord 408C). The profile chord 408C may be a maximum profile chord 408CM of 1.96 meters at a maximum profile chord location along the span 402 that may be about 6.32 meters from the base 134B and thus may be at a chord radius 134C that is about 25% of the blade radius 134R of 25 meters. The profile chord 408C may be about 0.7 meters at the tip 134T (e.g., within 1.6 meters of the tip 134T along the span 402). Accordingly, the profile chord may vary along the span 402 of each rotor blade 134 from about 1.3 meters at the base 134B to a maximum of about 1.96 meters and further to about 0.7 meters at the tip 134T. The rotor blades 134 may each have a twist angle 472 that varies (e.g., decreases) along at least a portion of the span 402 away from the base 134B and towards the tip 134T. The twist angle may be about 11 degrees at the base 134B of the rotor blade 134 (e.g., within 1.6 meters of the base 134B along the span 402). The twist angle 472 may be about 0.08 degrees at the tip 134T (e.g., within 1.6 meters of the tip 134T along the span 402). Accordingly, the twist angle 472 may vary along the span 402 of each rotor blade 134 from about 11 degrees at the base 134B to about 0.08 degrees at the tip 134T.

The rotor blades 134 of the wind turbine rotor assembly 130 may include a body structure 452 including an outer shell 454 and inner shell 456 that each include a 1.78-mm-thick fiberglass skin that surrounds a core (e.g., inner material 458) of balsa wood, and a box spar of uniaxial glass fibers extending longitudinally along the blades from 25% span 402 from the base 134B to the end (e.g., tip 134T) of the rotor blade 134 and laterally from 15% to 50% chord and may feature a root section 410, variable thickness to chord ratios along at least a portion of the span 402 thereof, and a variable twist angle 472 of airfoil profile chord 408C to root profile chord along at least a portion of the airfoil section span.

As shown in FIGS. 5A-5C, the rotor blade 134 of a wind turbine rotor assembly 130 may have a design, structure, and/or shape that is radically different from industrial fan air mover assembly designs (e.g., industrial fan rotor assembly designs) or even wind-turbine blade look-alike rotor blades of industrial fan air mover assemblies, including for example high volume, low speed (HVLS) fans. Such radical difference may be based on the rotor blade 134 having a body structure 452 that includes one or more composite materials (e.g., including a fiber reinforced polyester structure). Such radical difference may be based on the rotor blade 134 having a body structure 452 that defines an enclosure 460 (which may be a hollow enclosure or may be at least partially filled with a filler material) within the interior of the rotor blade 134 along at least a portion of the span 402 thereof, defines a cylindrical or substantially cylindrical root section 410 and an airfoil section 430 having a varying profile thickness to profile chord ratio along at least a (first) portion of the span 402 towards the tip 134T (also referred to herein interchangeably as the blade tip), defining a twist angle between the airfoil profile chord 408C of a given profile of the airfoil section 430 and a root profile chord 408C of the root section 410 that varies along at least a (second) portion of the span 402 towards the tip 134T so as to define a twist of the rotor blade 134, has a large span 402 such that the rotor diameter 130D of the rotor assembly is relatively large (e.g., at least 50 meters), or any combination thereof. In some example embodiments, the wind turbine rotor assembly 130 may have improved structural integrity, acro-clastic integrity, durability, and/or reinforcement in relation to upscaled industrial fan rotor assemblies having fan blades of a similar (e.g., same or substantially same) span 402 length based on including rotor blades 134 having a body structure that defines a root section 410 having a cylindrical shape. In some example embodiments, the wind turbine rotor assembly 130 may be lighter than upscaled industrial fan rotor assemblies for a given span 402 length of the rotor blades 134 thereof, based on the wind turbine rotor assembly 130 including rotor blades 134 having a body structure 452 defining an enclosure 460 (hollow or at least partially filled with one or more filler materials) within the rotor blades 134, thereby reducing structural support requirements of the wind turbine air mover assembly 120, improving power consumption efficiency due to reduced power consumption required to rotate the wind turbine rotor assembly 130, etc.

Additionally, a wind turbine rotor assembly 130 having a large rotor diameter (e.g., at least 50 meters) may be unexpectedly capable of supporting the weight of a rotor blade 134 having a large span 402 (e.g., at least 20 meters to enable an at least 50-meter rotor diameter of the wind turbine rotor assembly 130) in a vertical axis configuration where the weight is supported exclusively through the connection between the base 134B and the rotor hub 132 (e.g., without requiring mid-span or tip supports of the rotor blade from an exterior of the rotor blade) with acceptable sag in the rotor blades 134, for example without damaging sag in the rotor blade 134 which may include sagging and/or bending of the rotor blade beyond a threshold magnitude (e.g., a yield point of the rotor blade 134 or any portion thereof, an clastic limit of the rotor blade 134 or any portion thereof, etc.) so as to subject the rotor blade to plastic deformation, nonelastic deformation, cracking, and/or structural failure. Such an unexpected capability may be based at least in part upon the structure of the wind turbine rotor blade (e.g., the body structure 452 defining an airfoil section 430 and further defining at least one of a cylindrical root section 410, a variable profile thickness to profile chord ratio along at least a portion of the span of the airfoil section, a variable twist angle between the profile chord and the root profile chord along at least a portion of the span of the airfoil section, an enclosure 460 within the interior of the rotor blade 134, composite material construction of at least the body structure 452 of the rotor blade 134, or any combination thereof) providing dramatically low weight, high flexibility, and structural integrity proximate to the base 134B that would not be expected for a large rotor blade 134 (e.g. having a span 402 of at least 20 meters). The wind turbine rotor assembly 130 may therefore provide improved air moving capability over upscaled industrial fan rotor assembly designs (e.g., in the vertical axis configuration), which would be expected to require external structural support of the upscaled industrial fan rotor blades along the span thereof to mitigate sag or structural failure due to flapwise bending of the rotor blade, due to the reduced rotor blade weight and improved flapwise flexibility of the wind turbine rotor assembly 130.

Referring back to FIGS. 1, 2A-2D, 3, 4A, and 5A-5C, in some example embodiments, the process assembly 100 includes, in the wind turbine air mover assembly 120, a wind turbine rotor assembly 130 that corresponds to (e.g., is similar to, is identical to, is repurposed from, etc.) a standard onshore wind turbine rotor assembly for an onshore wind turbine having an approximate 750 KW rated output (when used as a wind turbine) and an approximate rotor diameter 130D of at least 50 meters (e.g., 50 meters to 100 meters). The process assembly 100 may repurpose the wind turbine rotor assembly 130 to operate as a driven (e.g., mechanically driven, by at least the drive motor 124) air mover in a vertical axis configuration where the central axis of rotation (also referred to herein as the central axis 130A) of the wind turbine rotor assembly 130 is extending vertically, parallel to the direction of gravity G. The repurposed wind turbine rotor assembly 130 may simplify or omit some or all features that would be included with the wind turbine rotor assembly 130 when the wind turbine rotor assembly 130 is included in a wind turbine (e.g., in a horizontal axis configuration where the central axis 130A extends perpendicular to the direction of gravity G) but which are unnecessary when the wind turbine rotor assembly 130 is used as an air mover in a vertical axis orientation. Such simplified or omitted features may include a tower, a yaw and pitch system, wind sensors, a gearbox and at least some control systems. For example, as shown in at least FIGS. 2A-2D and 4A, the wind turbine air mover assembly 120 may include a wind turbine rotor assembly 130 corresponding to a rotor assembly of a horizontal axis wind turbine. A simpler gearbox 126 than the gearbox used in a horizontal axis wind turbine may be included in the wind turbine air mover assembly 120, for example a single speed gearbox, or the gearbox 126 may be omitted entirely from the wind turbine air mover assembly 120. A speed modulation control system and inverter used for a horizontal axis wind turbine rotor assembly may be simplified or replaced with simpler systems in the wind turbine air mover assembly 120 oriented in the vertical axis configuration.

A wind turbine air mover assembly 120 including a wind turbine rotor assembly 130 may be configured to generate an air flow having a large flow rate (e.g., large volumetric flow rate and/or large mass flow rate) with a low pressure head (e.g., low pressure impact). Application of a wind turbine rotor assembly 130 as at least a part of a mechanically driven air mover (e.g., a fan) to move large amounts of air (e.g., air flow 180 having a large mass flow rate and/or volumetric flow rate) with a low pressure impact and/or low flow velocity, to further cause the large amounts of air of the air flow 180 to flow over one or more surfaces of one or more process devices 110 (and/or through one or more elements of the one or more process devices 110) to enable the one or more process devices 110 to perform one or more (industrial) processes (e.g., heat transfer from a heat exchanger to the air flow, capture of carbon dioxide from the air flow, etc.) takes advantage of a wind turbine rotor assembly 130 being configured to move large volumes/masses of air at relatively low speed (e.g., low flow velocity) and low pressure (e.g., low pressure head) and with correspondingly low power consumption and noise generation.

For example, and referring to at least FIGS. 5A-5C, a wind turbine rotor assembly 130 may include structures (e.g., rotor blades 134) configured to generate an air flow with relatively high aerodynamic efficiency, including a higher acrodynamic efficiency than industrial fan rotor assemblies, based on to the structural characteristics of the wind turbine rotor assembly corresponding to a rotor assembly of a wind turbine used in a horizontal axis configuration (e.g., a wind turbine rotor assembly 130 having a rotor diameter 130D of about 50 meters to about 100 meters). Additionally, a wind turbine rotor assembly 130 (e.g., having a rotor diameters 130D of about 50 meters to about 100 meters) and configured to generate a particular magnitude of air flow 180 flow rate may be lighter than a corresponding set of one or more industrial fan rotor assemblies configured to generate the same magnitude of air flow 180. As a result, a wind turbine air mover assembly 120 having a wind turbine rotor assembly 130 in a vertical axis configuration may be configured to generate a volumetric flow rate of air flow 180 with unexpectedly reduced power consumption and noise generation relative to upscaled industrial air mover assembly designs (e.g., one or more axial fans) based at least in part upon the improved aerodynamic efficiency and/or reduced weight of the wind turbine air mover assembly 120 relative to a set of one or more industrial fan air mover assemblies configured to generate a same magnitude of air flow 180.

Accordingly, a wind turbine rotor assembly 130 corresponding to a rotor assembly of a standard onshore wind turbine (e.g., a rotor and hub design of a standard onshore wind turbine) in a wind turbine air mover assembly 120 to be driven (e.g., by drive motor 124 motor) to generate an air flow 180 may significantly reduce the initial cost, power consumption, number of units (e.g., quantity of rotor assemblies) requirements of the wind turbine air mover assembly 120 as well as the broadband noise generated by the wind turbine air mover assembly 120 of the process assembly 100 while achieving improved or maximized acrodynamic efficiency of the wind turbine air mover assembly 120. The wind turbine air mover assembly 120 may be enclosed (e.g., enclosed in the horizontal plane extending perpendicular to the direction of gravity) within the shroud structure 102 which may aid in improving aerodynamic efficiency of the wind turbine air mover assembly 120 further (which may further reduce power consumption by the air mover assembly 120 for a given magnitude of generated air flow 180 (e.g., in terms of volumetric flow rate) and to provide additional reduction of noise external to the process assembly 100 during operation of the wind turbine air mover assembly 120.

In some example embodiments, where the process assembly 100 is configured to direct the air flow 180 generated by the wind turbine air mover assembly 120 to move in a cross wind configuration (e.g., such that the intake air is drawn into the process assembly moving in the horizontal direction, perpendicular to the vertical direction in which the wind turbine rotor assembly causes the air flow to move through the air mover assembly), the average wind & turbulence at the intake side 128A of the wind turbine air mover assembly 120 may be reduced or negligible, thereby causing significant reduction in the turbulent fatigue damage loads on the wind turbine rotor assembly 130 and thus increasing service life of the wind turbine rotor assembly 130, reducing maintenance schedule requirements for the wind turbine rotor assembly 130, etc. Any induced air turbulence produced in the air flow discharge from the wind turbine rotor assembly 130 of the wind turbine air mover assembly 120 could add potential benefits to performance of a process device 110 that is “downstream” of the wind turbine air mover assembly 120 and uses the discharged air flow 180 to perform a process (e.g., industrial process), thereby improving the functionality of the process device 110 based on the air mover of the process assembly 100 being a wind turbine air mover assembly 120 as described herein.

The vertical-axis configuration of the wind turbine rotor assembly 130 may evenly distribute gravity loads and acro-loads on the wind turbine rotor assembly 130, particularly upon a main shaft bearing 138 of the wind turbine rotor assembly (e.g., a shaft-tapered ball bearing which may be at the rotor hub 132) compared to normal operation of the wind turbine rotor assembly 130 when used in a horizontal axis configuration in a standard wind turbine. As a result, the vertical-axis configuration of the wind turbine rotor assembly 130 may unexpectedly cause significant load reduction and bearing life improvement on elements of the wind turbine rotor assembly 130 compared to compared to normal operation of the wind turbine rotor assembly 130 when used in a horizontal axis configuration in a standard wind turbine. The wind turbine rotor assembly 130 may advantageously include (e.g., repurpose, re-use, etc.) the existing bearing shaft design of a main shaft bearing 138 for onshore wind turbines, because the primary force on the main shaft bearing 138 of the wind turbine rotor assembly 130 in the vertical axis configuration is in the direction of gravity G, parallel to the central axis 130A of the wind turbine rotor assembly 130 (and thus potentially parallel to the central axis of the main shaft bearing 138) and therefore is evenly compressing the main shaft bearing 138, with reduced or minimized rotation or lateral load on the main shaft bearing 138 which is seen in normal onshore wind turbine operation when the wind turbine rotor assembly 130 is in a horizontal axis configuration.

The forces acting on the elements of a wind turbine rotor assembly 130 (e.g., main shaft bearing 138, rotor hub 132, rotor blades 134, connections between the rotor blades 134 and the rotor hub 132, etc.) in a vertical axis configuration and driven as part of a wind turbine air mover assembly 120, particularly a wind turbine rotor assembly 130 that may have been originally designed for use in a horizontal axis configuration where the central axis 130A of the wind turbine rotor assembly 130 would extend perpendicular to the direction of gravity G when the wind turbine rotor assembly 130 is applied in a wind turbine, may unexpectedly be within the tolerances of such elements (e.g., within the force tolerances of a bearing that is a wind turbine bearing shaft design for onshore wind turbines), even where the rotor blades 134 are exclusively structurally supported from the connection between the base 134B of the rotor blades and the rotor hub 132. This is because, when the wind turbine rotor assembly 130 is in the vertical axis configuration, the primary force acting on the elements thereof (e.g., on the main shaft bearing 138, the rotor blades 134, the connections between the rotor blades 134 and the rotor hub 132, etc.) is due to gravity G, perpendicular to the plane in which the rotor blades 134 extend, and may evenly compress the main shaft bearing 138 in the direction of the central axis 130A, with reduced or minimized rotation or lateral load on the main shaft bearing 138, rotor blades 134, connections between the rotor blades 134 and the rotor hub 132, etc. which is seen in standard onshore wind turbine operation which are in the horizontal axis configuration.

Notably, the gravity loads on a wind turbine rotor assembly 130 of a wind turbine air mover assembly 120 that is in the vertical axis configuration may be directed in the direction of gravity G and thus may be loads in parallel to the central axis 130A of the wind turbine rotor assembly 130, such that the gravity loads on the wind turbine rotor assembly 130 may be in the same direction as aerodynamic loads on a corresponding (e.g., identical or similar) wind turbine rotor assembly 130 applied in a wind turbine in the horizontal axis configuration where the central axis 130A of the wind turbine rotor assembly 130 is perpendicular to the direction of gravity G. Such aerodynamic loads that the elements of the wind turbine rotor assembly 130 are configured to withstand in a direction parallel to the central axis 130A when the wind turbine rotor assembly 130 is the horizontal axis configuration as part of a wind turbine may be greater than the gravity loads exerted in the same direction-parallel to the central axis 130A-when the wind turbine rotor assembly 130 is in the vertical axis configuration in the wind turbine air mover assembly 120 of the process assembly 100.

As a result, the wind turbine rotor assembly 130, despite its size (e.g., a wind turbine rotor assembly 130 having a rotor diameter of at least about 50 meters), may be unexpectedly capable of operating in a vertical axis configuration where the rotor blades 134 are exclusively structurally supported through the rotor hub 132 (e.g., without separate externally-applied structural support along the span 402 of the rotor blades 134). For example, the resultant loads and bending forces on elements of the wind turbine rotor assembly 130 in a vertical axis configuration, including for example the resultant loads and bending forces on horizontally-extending rotor blades 134, the connections between the rotor blades 134 and the rotor hub 132, a main shaft bearing 138 of the wind turbine rotor assembly 130, or the like, may be unexpectedly smaller than the design loads on such elements due to expected acrodynamic loads when the wind turbine rotor assembly 130 is used in a wind turbine in a horizontal axis configuration. As a result, the gravity-induced loads on the elements of the wind turbine rotor assembly 130 in a vertical axis configuration may be unexpectedly smaller than the design loads that such elements are designed to withstand due to acrodynamic loads when the wind turbine rotor assembly 130 is used as a wind turbine in the horizontal direction, thereby enabling the wind turbine rotor assembly 130 to maintain structural integrity and to unexpectedly have an improved service life of the wind turbine rotor assembly 130 and the elements thereof when applied in a vertical axis configuration in the wind turbine air mover assembly 120.

Based on acro-clastic simulations and analytical estimations of the blade loads of a wind turbine rotor assembly, the gravity loads on the rotor blades 134 due to the weight of the rotor blades 134 (e.g., gravity loads in the flapwise direction) are determined to be about 4% of the static-acrodynamic loads of the rotor blades 134 in operation, for example static-aerodynamic loads on the rotor blades 134 from air in the flapwise direction when the wind turbine rotor assembly is rotating around the central axis 130A in a horizontal axis configuration as part of a wind turbine generator. When the wind turbine rotor assembly 130 is operating in a horizontal axis configuration as part of a wind turbine generator, the gravity loads on the rotor blades 134 of the wind turbine rotor assembly 130 are periodic in nature and occur in a more flexible flapwise direction. When the wind turbine rotor assembly 130 is operating in a vertical axis configuration as part of a wind turbine air mover assembly according to some example embodiments, the gravity loads on the rotor blades 134 are fixed (always present) and act on the stiffer edgewise direction. However, since the wind turbine rotor assembly 130 is designed for stronger aerodynamic loads, and the gravity effects are miniscule compared to the acrodynamic loads, such gravity loads would have insignificant effect on the wind turbine rotor assembly 130 that is operating in a vertical axis configuration as part of a wind turbine air mover assembly 120 according to some example embodiments, which may operate in a quiescent environment.

The success of operating the wind turbine rotor assembly 130 in a vertical axis configuration is unexpected due to the total size and weight of the rotor blades 134 providing a large rotor diameter (e.g., at least 50 meters) due to gravity. The result of the gravity loads on such a wind turbine rotor assembly 130 being a small fraction of the force from air movement that the wind turbine rotor assembly 130 is configured to withstand when operating in the horizontal axis configuration, such that the wind turbine rotor assembly 130 is well-suited to withstanding the gravity loads when operating in the vertical axis configuration, for example where the rotor blades 134 are structurally supported exclusively by the rotor hub 132 at the base 134B thereof, is unexpected for a rotor assembly of such size (e.g., having a rotor diameter 130D of at least 50 meters).

In addition, the ability to re-use (e.g., repurpose) the existing bearing design (e.g., for the main shaft bearing 138) of a horizontal axis configuration wind turbine design in a vertical axis configuration wind turbine air mover assembly 120 without redesign is an unexpected result due to the significantly different (perceived to be completely rotated) forces wind turbine rotor assembly 130 in a vertical axis configuration would experience relative to a rotor assembly in a horizontal axis configuration (for which a wind turbine main shaft bearing 138 is designed). For example, in the case of a main shaft bearing 138 that is a thrust roller bearing as shown for example in FIG. 4B, significant axial load 390, applied in the axial direction of arrow 390 on the bearing, and some radial load on the bearing can be tolerated. Therefore, for wind turbine rotor assemblies 130 with such bearings, no change would likely need to be made to this design in order to operate the main shaft bearing 138 in the vertical axis configuration, since the predominant loads (e.g., gravity loads) will be in the axial direction (e.g., parallel to the direction of gravity G as shown in at least FIGS. 2A and 5A). As a result, a wind turbine main shaft bearing 138, designed to be used in a horizontal axis configuration where the direction of gravity is in the radial direction, is unexpectedly configured to be used in a vertical axis configuration where the direction of gravity is in the axial direction, where the main shaft bearing 138 design may be unchanged from the design used in the horizontal axis configuration, without compromising integrity or service life of the wind turbine rotor assembly 130 due to the main shaft bearing 138 design. Additionally, the vertical axis configuration of the main shaft bearing 138 in the wind turbine air mover assembly has an additional advantage with respect to the horizontal axis design configuration of the main shaft bearing 138 being uniformly loaded due to the gravity load in the axial direction, thereby enabling a higher lifetime of the main shaft bearing 138 when included in a wind turbine rotor assembly 130 in the vertical axis configuration, as opposed to asymmetric and heterogeneous loading of a main shaft bearing in the horizontal axis configuration. Furthermore, as noted above, the gravity loads on the wind turbine rotor assembly 130, and thus on the main shaft bearing 138, when the wind turbine rotor assembly 130 is operating in the vertical axis configuration may be unexpectedly significantly smaller than the axial thrust created by wind forces on the wind turbine rotor assembly 130, and thus on the main shaft bearing 138, when the wind turbine rotor assembly 130 is operating in the horizontal axis (normal) configuration, for example as part of a wind turbine generator.

In addition, the use of wind turbine rotor assembly in a vertical axis configuration provides an unexpected result with regard to the blade support structures (e.g., load-bearing body structures 452) for the rotor blades of the wind turbine rotor assembly. Despite having a relatively large size (e.g., enabling a 50-meter to 100-meter rotor diameter), the rotor blades 134 of the wind turbine rotor assembly 130 are unexpectedly able to support themselves in the flapwise direction with the only structural support at the hub connection to the rotor hub 132 at the base 134B of the rotor blades 134. Importantly, mid-span or tip supports of the rotor blade 134 (e.g., from an external structure that is external to the rotor blade 134) are unexpectedly not required to reduce ‘sag’ in the rotor blades 134 extending horizontally from the rotor hub 132 of the wind turbine rotor assembly 130 in the vertical axis configuration, as would be expected for upscaled industrial fan rotor blade designs. This unexpected result is due to the gravity loads acting on the blade, perpendicular to the flat or flapwise direction of the rotor blade 134 being a small fraction (approximately 4%) of the total force load on the rotor blade 134. The remainder force load would be expected to be a significant axial thrust load from the force of wind (or in this case the load on the rotor blade 134 from the air flow 180 induced based on the rotation 130R of the wind turbine rotor assembly 130 due to operation of the drive motor 124. Due to this unexpected result, the rotor blades 134 will be adequately supported via the connection between the body structure 452 at the base 134B to the rotor hub 132, and existing wind turbine rotor blade designs can be re-used (e.g., repurposed) with no redesign nor external blade supports despite being very large (e.g., causing the wind turbine rotor assembly 130 to have an at least 50-meter rotor diameter 130D).

In addition, when the wind turbine rotor assembly 130 is included in a wind turbine air mover assembly 120 in the vertical axis configuration and is configured to generate an upwards-directed air flow 180 (e.g., opposite to the direction of gravity G) as shown in FIGS. 2A-2D, the acrodynamic loads on elements of the wind turbine rotor assembly 130 (e.g., the rotor blades 134) during operation thereof may at least partially counteract the gravity loads on such elements of the wind turbine rotor assembly 130 during operation of the wind turbine air mover assembly 120, further reducing loads on the wind turbine rotor assembly 130 in the direction of gravity G and further improving operational life of the wind turbine rotor assembly 130 elements (e.g., the rotor blades 134, the main shaft bearing 138, the connections between the rotor blades 134 and the rotor hub 132, etc.).

In some example embodiments, application of a wind turbine rotor assembly corresponding to a rotor assembly used in a wind turbine in a horizontal axis configuration (e.g., a wind turbine rated for 750 kW power output) in a driven air mover assembly in a vertical axis configuration, may provide both a cost and noise floor benefit due to leveraging wind turbine technology for driven air movers, as opposed to many “normal-sized” industrial fan air mover assemblies or fans used to generate a similar magnitude air flow as may be generated by a wind turbine rotor assembly 130 (e.g., having a rotor diameter 130D of about 50 meters to about 100 meters), which may have greater operating cost, operating noise, additional structural requirements for individual units, etc. than a wind turbine air mover assembly 120 as described herein.

As described herein, a wind turbine rotor assembly may provide improvements in power consumption and noise generation, for a given amount of air flow generated thereby, that are unexpected for an air mover having a rotor assembly of such size and scale.

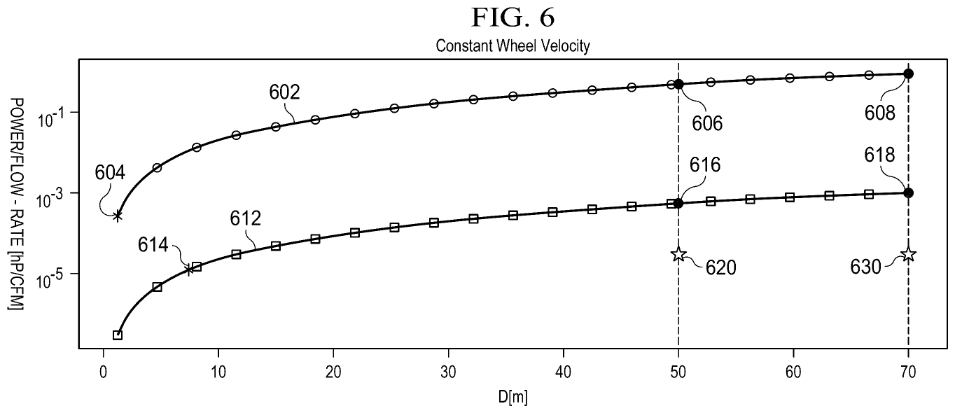

FIG. 6 is a graph plotting power consumption (e.g., horsepower, hp) per unit of volumetric flow rate (e.g., cubic feet per minute, CFM), also referred to herein as generated air flow, by fan air mover assemblies and wind turbine air mover assemblies corresponding to rotor diameter (e.g., meters) of the respective rotor assemblies thereof, according to some example embodiments.

Referring to FIG. 6, the power consumption of fan air mover assemblies scales as (e.g., is proportional to)∝D^{P} where D is the rotor diameter of the fan rotor assembly of the air mover assembly. For example, power consumption (also referred to as simply “power”, e.g., in units of horsepower “hp”) of an air mover assembly having a rotor assembly with a rotor diameter (e.g., in units of meters), the scaling curve of power consumption against rotor diameter can be written as P=P₀(D/D₀)^{p}, where P₀, D₀ are the reference power DO and rotor diameter (e.g., of an existing design). From fan affinity laws it is straightforward to show that p=2 for industrial fan rotor assemblies of industrial fan air mover assemblies (e.g., fan assemblies comprising aluminum casting and/or solid interior, non-twist blade body shape, non-root rotor blades lacking a cylindrical or substantially cylindrical root section, etc.) where the rotor blade tip velocity is kept constant, while in contrast p=5 for industrial fan rotor assemblies of industrial fan air mover assemblies rate of rotation of the rotor assembly is kept constant. The affinity laws are based on non-dimensional arguments and do not take into consideration the change of aerodynamics & acroacoustics around rotor blades at order of magnitude scale-up.

Additionally, according to fan scaling laws and fan affinity laws for industrial fan air mover assembly designs, the power consumption of a fan air mover assembly scales as P∝N³ D⁵ where N, D are the rpm/wheel velocity of the fan rotor assembly of the fan air mover assembly, and the rotor diameter of the fan rotor assembly. In a similar spirit, the flow rate scales as Q∝ND³.

FIG. 6 illustrates the effect of upscaling the rotor diameter of industrial three-bladed fan air mover assembly designs including industrial high volume, low speed (HVLS) fan air mover assembly designs having industrial HVLS fan rotor assembly designs and industrial vane-axial fan air mover assembly designs having industrial vane-axial fan rotor assembly designs, where such industrial fan rotor assembly designs include absence of a root section, enclosure (e.g., hollow or filled with a separate filler material), varying twist angle along at least a portion of the rotor blade span, and/or varying profile thickness to profile chord ratio along at least a portion of the rotor blade span. In FIG. 6, the rotor diameters of the industrial fan air mover assembly designs are upscaled assuming constant RPM or wheel velocity of the industrial fan air mover assemblies. Consequently, P∝D⁵ and Q∝D³, thus the power consumed per cubic ft/minute of air moved (surrogate to inverse efficiency) scales as P/Q∝D⁵⁻³∝D². As shown in FIG. 6, the plot of horsepower (hp) per CFM for constant wheel velocity indicates that the 3-bladed HVLS fans with constant N [rpm] require roughly an order of magnitude greater power consumption (hp) per unit of generated air flow (CFM) than wind turbine air mover assemblies according to some example embodiments. In a similar spirit, the 6-bladed vane-axial fans are 3-4 orders of magnitude greater power consumption (hp) per unit of generated air flow (CFM) than wind turbine air mover assemblies according to some example embodiments.

As shown in FIG. 6, curve 602 extrapolates expected power consumption per CFM of generated air flow (P/Q) of a fan air mover assembly comprising “simple (up) scaling” of rotor diameter “D” of industrial vane-axial fan air mover assemblies having industrial vane-axial fan rotor assembly designs (e.g., fan rotor assemblies comprising aluminum casting and/or solid interior, non-twist blade body shape, non-root rotor blades lacking a cylindrical or substantially cylindrical root section, etc.) while keeping the wheel velocity (e.g., revolutions per minute, or rpm) of the industrial vane-axial fan rotor assembly constant, and the corresponding scaling of power consumption thereof based on applying

$$\frac{P}{Q} = \frac{{P}_{0}}{{Q}_{0}} {( \frac{D}{{D}_{0}} )}^{2} ,$$

where P₀, D₀, Q₀ are the reference power, rotor diameter, and generated air flow rate, shown by reference point 604 of a reference vane-axial fan air mover assembly having a reference rotor diameter D₀ of 1.22 meters, a reference power consumption P₀ of 9.63 hp, and a reference generated air flow rate Q₀ of 36,000 CFM. As shown by data points 606 and 608 in FIG. 6, at a rotor diameter “D” of 50 meters (606) and 70 meters (608), the power consumption (hp) per unit of generated air flow (CFM) of an upscaled industrial HVLS fan air mover assembly design is 0.449 and 0.88, respectively.

As shown in FIG. 6, curve 612 extrapolates expected power consumption per CFM of generated air flow (P/Q) of a fan air mover assembly comprising “simple (up) scaling” of rotor diameter “D” of industrial high volume, low speed (HVLS) fan air mover assemblies having industrial HVLS fan rotor assembly designs (e.g., fan rotor assemblies comprising aluminum casting and/or solid interior, non-twist blade body shape, non-root rotor blades lacking a cylindrical or substantially cylindrical root section, etc.) while keeping the wheel velocity (e.g., revolutions per minute, or rpm) of the industrial HVLS fan rotor assembly design constant, and the corresponding scaling of power consumption thereof based on applying

$$\frac{P}{Q} = \frac{{P}_{1}}{{Q}_{1}} {( \frac{D}{{D}_{1}} )}^{2} ,$$

where P₁, D₁, Q₁ are the reference power, rotor diameter, and generated air flow rate, shown by reference point 614 of a reference HVLS fan air mover assembly having a reference rotor diameter D₁ of 9.1 meters, a reference power consumption P₁ of 2 hp, and a reference generated air flow rate Q₁ of 186,500 CFM. As shown by data points 616 and 618 in FIG. 6, at a rotor diameter “D” of 50 meters (606) and 70 meters (608), the power consumption (hp) per unit of generated air flow (CFM) of an upscaled industrial HVLS fan air mover assembly is 5.03×10⁻⁴ and 9.86×10⁻⁴, respectively.

Still referring to FIG. 6, the data points 620 and 630 indicate respective power consumptions per CFM of generated air flow (P/Q) of wind turbine air mover assemblies comprising a wind turbine rotor assembly according to some example embodiments, for example a wind turbine rotor assembly 130 comprising rotor blades 134 having a body structure 452 at least partially comprising composite materials (e.g., fiberglass-reinforced polyester) and defining an enclosure 460 within an interior of the rotor blade, defining a cylindrical or substantially cylindrical root section 410, defining an airfoil section 430 having a variable profile thickness 408T to profile chord 408C ratio along at least a portion of the span 402 of the rotor blade, a twist in the fan blade body shape (e.g., a varying twist angle 472 between the airfoil profile chord and the root profile chord along at least a portion of the span 402), or any combination thereof.

The wind turbine rotor assemblies 130 of the wind turbine air mover assemblies corresponding to data points 620 and 630 may each comprise respective rotor blades 134 that include a body structure 452 including a 1.78-mm-thick fiberglass skin that surrounds a core (e.g., inner material 458) of balsa wood, and a box spar of uniaxial glass fibers extending longitudinally along the blades from 25% span to the end of the blade and laterally from 15% to 50% chord and may feature a root section, variable thickness to chord ratios along at least a portion of the span thereof, and a variable twist angle of airfoil profile chord to root profile chord along at least a portion of the airfoil section span.

The wind turbine rotor assembly 130 of the wind turbine air mover assembly corresponding to data point 620 may have a rotor diameter 130D of 70 meters and thus may have a blade radius of 35 meters. The wind turbine rotor assembly 130 may have a hub radius 132R of 1.75 meters and may include a plurality (e.g., three) rotor blades 134 each having a blade length (e.g., span 402) of about 33.25 meters, a total mass of 4,336 kg, a first mass moment of inertia of 46,497 kg-m, a second mass moment of inertia of 798,506 kg-m², a center of mass located 10.72 meters along the span 402 from the base 134B (also referred to herein interchangeably as the root) towards the tip 134T. The rotor blades 134 may each have a profile chord 408C that varies along the span 402. The profile chord 408C may be about 1.9 meters at (e.g., within 2.2 meters along the span 402 of) the base 134B of the rotor blade 134 (e.g., reference profile chord 474, which may be the root profile chord 408C). The profile chord 408C may be a maximum profile chord 408CM of 2.7 meters at a maximum profile chord location along the span 402 that may be about 8.9 meters from the base 134B and thus may be at a chord radius 134C that is about 25% of the blade radius 134R of 35 meters. The profile chord 408C may be about 0.9 meters at the tip 134T (e.g., within 2.2 meters of the tip 134T along the span 402). Accordingly, the profile chord may vary along the span 402 of each rotor blade 134 from about 1.9 meters at the base 134B to a maximum of about 2.7 meters and further to about 0.9 meters at the tip 134T. The rotor blades 134 may each have a twist angle 472 that varies (e.g., decreases) along at least a portion of the span 402 away from the base 134B and towards the tip 134T. The twist angle may be about 11 degrees at the base 134B of the rotor blade 134 (e.g., within 2.2 meters of the base 134B along the span 402). The twist angle 472 may be about 0.08 degrees at the tip 134T (e.g., within 2.2 meters of the tip 134T along the span 402). Accordingly, the twist angle 472 may vary along the span 402 of each rotor blade 134 from about 11 degrees at the base 134B to about 0.08 degrees at the tip 134T.

The wind turbine rotor assembly 130 of the wind turbine air mover assembly corresponding to data point 630 may have a rotor diameter 130D of 50 meters and thus may have a blade radius of 25 meters. The wind turbine rotor assembly 130 may have a hub radius 132R of 1.25 meters and may include a plurality (e.g., three) rotor blades 134 each having a blade length (e.g., span 402) of about 23.75 meters, a total mass of 1,941 kg, a first mass moment of inertia of 14,605 kg-m, a second mass moment of inertia of 180,640 kg-m², a center of mass located 7.52 meters along the span 402 from the base 134B (also referred to herein interchangeably as the root) towards the tip 134T. The rotor blades 134 may each have a profile chord 408C that varies along the span 402. The profile chord 408C may be about 1.4 meters at (e.g., within 1.6 meters along the span 402 of) the base 134B of the rotor blade 134 (e.g., reference profile chord 474, which may be the root profile chord 408C). The profile chord 408C may be a maximum profile chord 408CM of 1.96 meters at a maximum profile chord location along the span 402 that may be about 6.32 meters from the base 134B and thus may be at a chord radius 134C that is about 25% of the blade radius 134R of 25 meters. The profile chord 408C may be about 0.7 meters at the tip 134T (e.g., within 1.6 meters of the tip 134T along the span 402). Accordingly, the profile chord may vary along the span 402 of each rotor blade 134 from about 1.3 meters at the base 134B to a maximum of about 1.96 meters and further to about 0.7 meters at the tip 134T. The rotor blades 134 may each have a twist angle 472 that varies (e.g., decreases) along at least a portion of the span 402 away from the base 134B and towards the tip 134T. The twist angle may be about 11 degrees at the base 134B of the rotor blade 134 (e.g., within 1.6 meters of the base 134B along the span 402). The twist angle 472 may be about 0.08 degrees at the tip 134T (e.g., within 1.6 meters of the tip 134T along the span 402). Accordingly, the twist angle 472 may vary along the span 402 of each rotor blade 134 from about 11 degrees at the base 134B to about 0.08 degrees at the tip 134T.

As shown, data point 620 indicates hp of power consumption per CFM of generated air flow (P/Q) of 2.857×10⁻⁵ for a wind turbine air mover assembly comprising a wind turbine rotor assembly having a rotor diameter of 50 meters. Data point 630 indicates hp of power consumption per CFM of generated air flow (P/Q) of 2.91×10⁻⁵ for a wind turbine rotor assembly having a rotor diameter of 70 meters.

As shown in FIG. 6, at 50 meters rotor diameter, the fan power (e.g., power consumption) per unit of generated air flow of a wind turbine air mover assembly (620) is at least an order of magnitude smaller than that of upscaled fan air mover assembly designs, specifically upscaled designs of vane-axial fan air mover assemblies (606) and HVLS fan air mover assemblies (616): the 50-meter wind turbine air mover assembly has a power consumption per unit of generated air flow of about 17 times smaller than that of the upscaled 50-meter HVLS fan air mover assembly design and about 15,700 times smaller than that of the upscaled 50-meter vane-axial fan air mover assembly design.

As shown in FIG. 6, at 70 meters rotor diameter, the fan power (e.g., power consumption) per unit of generated air flow of a 70-meter wind turbine air mover assembly is at least an order of magnitude smaller than that of upscaled fan air mover assembly designs, specifically upscaled designs of vane-axial fan air mover assemblies (608) and HVLS fan air mover assemblies (618): the 70-meter wind turbine air mover assembly has a power consumption per unit of generated air flow of about 33.9 times smaller than that of the upscaled 70-meter HVLS fan air mover assembly design and about 30,200 times smaller than that of the upscaled 70-meter vane-axial fan air mover assembly design.

In view of at least the above, and as shown in FIG. 6, wind turbine air mover assemblies, having a wind turbine rotor assembly according to some example embodiments, may be orders of magnitude more efficient in terms of power consumption per unit of generated air flow than upscaled vane-axial and HVLS fan air mover assembly designs at large rotor diameters of at least 50 meters (e.g., at least at 50 meters and 70 meters as shown in FIG. 6). Accordingly, in example embodiments where a large amount of generated air flow is generated to facilitate one or more processes performed by one or more process devices, such that the rotor diameter of the air mover assembly generating the air flow is large (e.g., at least 50 meters), the wind turbine air mover assembly may provide at least an order of magnitude of reduction of power consumption for the amount of generated air flow (e.g., total CFM) over upscaled fan air mover assembly designs having similar rotor diameters.

Additionally, at constant wheel velocity as shown in FIG. 6, the rotor blade tip velocity scales as ND∝D and hence the broadband noise scales D⁵ in the axial-vane & HVLS fan air mover assemblies, making them acoustically inefficient at large rotor dimeters (e.g., at least 50 meters). Using the formula for broad-band noise

$$Δ SPL = 50 {log}_{10} ( \frac{{N}_{0}}{{N}_{W 1}} ) ,$$

for a 50-meter rotor diameter design, the Vane-Axial fan is +70 dBA and HVLS+13 dBA more noisy than the 50-meter wind turbine fan air mover assembly having a rotor diameter of 50 meters (620). Such improvements provided by a wind turbine air mover assembly, based at least in part upon the structure of the rotor blades thereof with regard to the body structure as described herein, are unexpected for air mover assemblies of such rotor diameter size as the power consumption per unit of air flow for the wind turbine air mover assembly at such large rotor diameter size (e.g., at least 50 meters) are at least an order of magnitude lower than would be predicted when applying fan affinity laws to scale fan air mover assembly designs would predict, thereby unexpectedly rendering such large-diameter wind turbine air mover assemblies more economically viable than would be predicted from upscaling industrial fan air mover assembly designs via application of fan affinity laws.

While the above-noted unexpected improvements in power consumption per unit of generated air flow and broad band noise are described herein with regard to rotor diameters of 50 meters and 70 meters, it is apparent from at least FIG. 6 that such improvements provided by the wind turbine air mover assemblies may be provided at other rotor diameters of the wind turbine rotor assemblies thereof, including for example any rotor diameter between 50 meters and 70 meters, any other diameter greater than 70 meters (e.g., 100 meters), and rotor diameters smaller than 50 meters (e.g., 45 meters, 40 meters, 35 meters, 30 meters, 25 meters, and any rotor diameter between 25 meters and 50 meters).

As a result, a wind turbine air mover assembly, having a wind turbine rotor assembly according to some example embodiments may have significantly (e.g., at least an order of magnitude) improved power consumption per unit of generated air flow compared to upscaled fan air mover assembly that are upscaled to similar rotor diameters of the wind turbine air mover assembly according to known fan affinity laws with constant wheel velocity in relation to respective power and rotor diameter values 604, 608 of reference HVLS and vane-axis fan air mover assemblies.

In some example embodiments, for example where industrial (e.g., vane-axial and HVLS) fan air mover assembly designs are scaled from the aforementioned reference rotor diameters while keeping rotor blade tip speed, or ND, constant, such that P∝D² and Q∝D² the upscaled design has similar broad-band noise level as the baseline (reference) design, the wind turbine air mover assembly may still provide unexpected improvements over such upscaled industrial fan air mover assembly designs.

For example, the aforementioned fan-scaling laws for power and generated air flow (e.g., volumetric flow rate) are ideal and driven by the assumption of geometric and Reynolds number similarity between the machines. However, at large rotor diameters (e.g., 50 meters, 70 meters, etc.) the vane-axial fan design, the HVLS fan design, and the wind turbine air mover assembly design do not maintain geometric and Reynolds number similarity at the same diameter D=50 meters, 70 meters, etc. For example, at rotor diameters of at least 50 meters, the HVLS fan air mover assemblies have around an order of magnitude of lower Reynolds number compared to the wind turbine air mover assembly designs according to some example embodiments. For example, the Reynolds number of the air flow generated by an air mover assembly having a rotor assembly may be expressed as a function of the rotor diameter, for example expressed as (Re=ρND²/μ) where ρ, μ are the density and dynamic viscosity of air and D is the rotor diameter. For a fixed D, Reynolds number scales as & N [rpm]. At 50 meters & 70 meters rotor diameter, the Reynolds number for an upscaled HVLS fan air mover assembly where tip speed is kept constant, Re_{HVLS}=0.27 Re_{WT}. As an example, since the Reynolds number is much lower in the HVLS fan air mover assemblies, the efficiency (a strong function of Reynolds number) of HVLS fan air mover assemblies is reduced compared to the wind turbine air mover assemblies having similar, large (e.g., at least 25, 30, 35, 40, 45, and/or 50 meters, etc.) rotor diameters.

Accordingly, a wind turbine air mover assembly having a wind turbine rotor assembly according to some example embodiments provides improved operational efficiency (e.g., power consumption efficiency for the amount of air flow generated) over industrial HVLS fan air mover assemblies that are upscaled to a have large rotor diameter (e.g., 50 meters, 70 meters, etc.) while keeping tip speed constant, based at least in part upon the disparity in Reynolds number and various additional improvements provided by the structure of the wind turbine rotor blades (e.g., the aerodynamic shape and corresponding improved aerodynamic efficiency of the wind turbine rotor blades based on the spanwise-variable thickness/profile chord ratio, blade twist, root, etc.). For at least similar reasons, a wind turbine air mover assembly provides improved operational efficiency over industrial vane-axial fan air mover assembly designs that are upscaled to a have large diameter (e.g., 50 meters, 70 meters, etc.) while keeping tip speed constant.

In addition, even if industrial HVLS fan air mover assemblies as described herein were upscaled in rotor diameter to at least 50 meters while keeping tip speed constant, and even if such upscaled HVLS fan air mover assemblies were operating at their theoretical maximum efficiency, the volume of air moved by such upscaled HVLS fan air mover assemblies (e.g.,

$$Q = {{Q}_{1} ( \frac{D}{{D}_{1}} )}^{3}$$

for HVLS air move assemblies, where Q₁ and D₁ are as described above for the reference HVLS fan air mover assembly design) would be a total generated air flow of 8.74×10⁶ CFM at a rotor diameter of 50 meters and 17.148×10⁶ CFM at a rotor diameter of 70 meters. In contrast, a wind turbine air mover assembly having a wind turbine rotor diameter of 50 meters would generate a total air flow of 45.76×10⁶ CFM and a wind turbine air mover assembly having a wind turbine rotor diameter of 70 meters would generate a total air flow of 89.69×10⁶ CFM. Accordingly, a wind turbine air mover assembly according to some example embodiments may generate a significantly greater (e.g., at least 20% greater) magnitude of air flow than HVLS fan air mover assemblies upscaled to a similar rotor diameter (while keeping tip speed constant) at 50 meters and 70 meters of rotor diameter.

Consequently, upscaled HVLS designs that keep tip speed constant would accelerate and push less air than wind turbine air mover assemblies having similar rotor diameter according to some example embodiments, and thus such upscaled HVLS designs would not represent a viable option for providing a single air mover assembly to generate a large amount of air flow to facilitate processes that operate according to large amounts of air flow, such as DAC/Cooling tower system designs, without constructing a greater quantity of HVLS fan air mover assemblies. Restated, a wind turbine air mover assembly having a wind turbine rotor assembly according to some example embodiments may provide a large amount of generated air flow to facilitate one or more processes (e.g., heat transfer by a heat exchanger, carbon capture by a DAC system, etc.) without requiring constructing additional air mover assemblies, or at least based on requiring fewer air mover assemblies than would be required for upscaled HVLS fan air mover assemblies to generate the same amount of air flow, thereby providing reduced capital expenditures (e.g., due to reduced quantity of air mover assemblies and reduced corresponding support structure, shroud structure, reduced land purchase/leasing requirements, etc.) without compromising generated air flow than would be required for a same quantity of industrial air mover assemblies having a same rotor diameter. While the total generated air flow of a wind turbine air mover assembly might be matched by providing multiple industrial fan air mover assemblies, constructing multiple fan air mover assemblies may represent increased capital expenditure in relation to the wind turbine air mover assembly for the same amount of generated air flow provided thereby.

Referring to FIG. 6, the savings in power consumption per unit of generated air flow provided by a wind turbine air mover assembly 120 that includes a wind turbine rotor assembly 130 over that of an upscaled industrial fan air mover assembly at a same, relatively large rotor diameter (e.g., at least 50 meters) would not be expected at least because for upscaled industrial fan air mover assemblies, as power consumption requirements and inlet/discharge air flow rate become greater (e.g., based on increased rotor diameter), reducing the rate of rotation of the rotor assembly (e.g., RPM) to reduce power consumption would not translate to efficiency improvement in the fan air mover assembly, for example due to loss of performance at low Reynolds no., due to lower stall margins of the blades etc.

However, the cost-effectiveness of the seemingly expensive and large (in both volume and weight) wind turbine rotor assembly, which may result in a wind turbine air mover assembly having a relatively large rotor diameter of at least 50 meters which may be at least an order of magnitude beyond that of conventional vertical-axis configuration air mover assemblies, would be unexpected. For example, as described herein, the ability of a wind turbine rotor assembly 130 to support the rotor blades 134 thereof exclusively via the connection between the base 134B, also referred to herein interchangeably as the rotor blade base, and rotor hub 132 (e.g., without requiring externally-applied mid-span or tip supports of the rotor blade to reduce ‘sag’ in the blades extending horizontally from the hub of the rotor assembly in the vertical axis configuration) would be unexpected for a rotor assembly of large rotor diameter (e.g., at least 50 meters). In addition, a wind turbine rotor assembly, which may include re-use (e.g., re-purposing) of a wind turbine blade originally designed for horizontal axis configuration application in a wind turbine generator, may unexpectedly utilize a wind turbine rotor assembly that was designed and manufactured to meet a completely different set of requirements and 100% opposite function from that of an air mover assembly (e.g., being moved by impinging air flow to drive a generator, as opposed to being driven by a drive motor to induce air flow), and the ability of such a rotor assembly to resist bending or failure due to gravity loads in the vertical axis configuration without externally-applied mid-span or tip supports of the rotor blades (e.g., due to such gravity loads on the rotor assembly in the vertical axis configuration being smaller than the acrodynamic loads that the rotor assembly is configured to withstand when used in a wind turbine generator in the horizontal axis configuration) would be unexpected due to the absolute size and weight of such a large (e.g., 50+ meter rotor dimeter) rotor assembly.

Current conventional process assemblies, including DAC systems and dry cooling towers, have incorporated conventional fans (e.g., conventional fan air mover assemblies) into a modular multi-fan system whereby the module size is limited by the fan size and airflow ability. A process assembly that includes a wind turbine air mover assembly, having a wind turbine rotor assembly that is characterized by comprising composite materials (e.g., including a fiber reinforced polyester structure), having a hollow interior (e.g., the body structure of the rotor blade defining an enclosure which may be empty or may be at least partially filled by a filler material), having a cylindrical or substantially cylindrical root section and an airfoil section having a varying profile thickness to profile chord ratio along the span towards the blade tip, having a twist angle between the profile chord of a given profile of the airfoil section 430 and a profile chord of the root section that varies along the span 402 towards the tip so as to define a twist of the rotor blade 134, or any combination thereof, may incorporate a very large single rotor assembly (e.g., a very large fan) serving multiple modules thereby unexpectedly achieving significantly higher efficiency in both electrical consumption and capital expenditure (CAPEX) due to the tighter, more compact design that is enabled by the single-fan (e.g., single rotor) configuration. A practical and/or manufacturable single rotor assembly (e.g., a single fan) was not previously feasible to DAC or dry cooling tower designers. For example, a cylindrical multi-module dry cooling tower with a plurality of fans on top of a chimney is not known to be widely adopted in favor or multiple separated modules with individual fans for likely reasons of maintainability of the fans, cost of the structure, etc. However, a process assembly having a single wind turbine rotor assembly unexpectedly solves these challenges and enables a cost efficient solution for both power consumption and CAPEX.

Furthermore, manufacturing a rotor assembly for an air mover assembly that has rotor blades with an acrodynamic design corresponding to wind turbine rotor blades would be incomprehensible in currently established industry processes for industrial fan rotor blades (metal materials, fabrication methods such as casting or extruding, footprint scale, fabrication methods) and thus would be unexpected to be possible and/or feasible in terms of cost, power consumption, CAPEX, O&M costs, etc.

While example embodiments of the wind turbine air mover assembly 120 are described herein to have a wind turbine rotor assembly 130 having a rotor diameter 130D of at least 50 meters, for example, 50 meters, 70 meters, 100 meters, or the like, it will be understood that example embodiments are not limited thereto. For example, the rotor diameter 130D of a wind turbine rotor assembly 130 of a wind turbine air mover assembly 120 may be equal to or greater than 20 meters, equal to or greater than 25 meters, equal to or greater than 30 meters, equal to or greater than 35 meters, equal to or greater than 40 meters, equal to or greater than 45 meters, equal to or greater than 50 meters, equal or to greater than 55 meters, equal to or greater than 60 meters, equal to or greater than 65 meters, equal to or greater than 70 meter, equal to or greater than 75 meters, equal to or greater than 80 meters, equal to or greater than 85 meters, equal to or greater than 90 meters, equal to or greater than 95 meters, equal to or greater than 100 meters, equal to or greater than 110 meters, equal to or greater than 120 meters, equal to or greater than 130 meters, equal to or greater than 140 meters, equal to or greater than 150 meters, equal to or greater than 160 meters, or any combination thereof. It will be understood that the unexpected improvements provided by wind turbine air mover assemblies having a rotor diameter of 50 meters or 70 meters as described herein (e.g., with reference to FIG. 6) will also apply to wind turbine air mover assemblies having a rotor diameter between 50 meters and 70 meters, a rotor diameter greater than 70 meters, a rotor diameter smaller than 50 meters (e.g., between 20 meters and 50 meters), or the like.

While example embodiments of the wind turbine air mover assembly 120 are described herein to have a wind turbine rotor assembly 130 including rotor blades 134 that may have a maximum profile chord 408C at the airfoil section 430, the transition section 420, or a boundary therebetween for example as shown in FIG. 5A, example embodiments are not limited thereto. For example, in some example embodiments the maximum profile chord 408CM of the rotor blade 134 may be the profile chord 408C at the base 134B of the rotor blade 134 (e.g., a root profile chord).

While example embodiments of the wind turbine air mover assembly 120 are described herein to have a wind turbine rotor assembly 130 including rotor blades 134 that may each have a root section 410, or “root” together with an airfoil section 430 having an airfoil shape (e.g., having a varying ratio of profile thickness 408T to profile chord 408C along at least a portion of the span of the airfoil section 430, having a varying twist angle along at least a portion of the span of the airfoil section 430, etc., it will be understood that example embodiments are not limited thereto. For example, in some example embodiments, the wind turbine rotor blade 134 of a wind turbine rotor assembly 130 may omit the root section 410 and may further omit the transition section 420, such that the base 134B of the rotor blade 134 may have an airfoil profile shape, and some or all of the rotor blade 134 span 402 may define the airfoil section 430. The base 134B may have a profile having the maximum profile chord 408CM of the rotor blade 134.

Some example embodiments of the wind turbine rotor blade 134 of the wind turbine rotor assembly 130, including the example embodiments shown in FIGS. 5A-5C, may have a body structure 452 that may include one or more composite materials, may define an internal enclosure (e.g., a hollow interior), define a cylindrical or substantially cylindrical root section, define an airfoil section having a variable thickness to chord ratio along the longitudinal axis of the rotor blade from the root to the tip thereof, define a twist in the fan blade body shape along the longitudinal axis, or any combination thereof. However, it will be understood that a wind turbine rotor blade 134 of the wind turbine rotor assembly 130 according to some example embodiments may have different combinations of such features and may omit at least some of the above-noted features. For example, a wind turbine rotor blade 134 may have a body structure 452 that omits the root section 410, for example, such that the base 134B of the rotor blade 134 has an airfoil profile shape, and the body structure 452 may define an internal enclosure 460, a spanwise variable thickness to profile chord ratio, and a twist in the fan blade body shape along the longitudinal axis, or any combination thereof. In another example, a wind turbine rotor blade 134 may have a body structure 452 that is a solid structure and omits the internal enclosure 460 while the body structure 452 may define a root section 410 in addition to at least the airfoil section 430, a spanwise variable thickness to profile chord ratio along at least a portion of the airfoil section 430, a twist in the fan blade body shape along at least a portion of the airfoil section 430, or any combination thereof. In another example, a wind turbine rotor blade 134 may have a body structure 452 that omits at least one of a spanwise variable thickness to profile chord ratio or a twist in the fan blade body shape along the longitudinal axis. In another example, a wind turbine rotor blade 134 may have a body structure 452 having a span of at least 20-25 meters so as to define rotor diameter 130D of the wind turbine rotor assembly 130 that is at least 50 meters, with or without any of the enclosure 460 with the rotor blade interior, the blade twist, the cylindrical root section, or the variable profile thickness to profile chord ratio along the blade span, and wherein the rotor blade 134 is configured to be exclusively structurally supported at the base 134B of the rotor blade (e.g., via connection to the rotor hub 132 at the base 134B of the rotor blade 134) such that the rotor blade 134 is configured to extend from the connection at the base 134B to the rotor hub 132 without additional structural support (e.g., mid-span or tip support) from any external structure along the span 402 from the base 134B to mitigate ‘sag’ along the span of the rotor blade 134 to be an acceptable sag, for example without damaging sag in the rotor blade 134 which may include sagging and/or bending of the rotor blade beyond a threshold magnitude (e.g., a yield point of the rotor blade 134 or any portion thereof, an elastic limit of the rotor blade 134 or any portion thereof, etc.) so as to subject the rotor blade to plastic deformation, nonelastic deformation, cracking, and/or structural failure. In some example embodiments, the profile chord 408C and/or the profile thickness 408T may vary along at least a portion of the span 402 of the rotor blades 134 of a rotor assembly 130 without varying the ratio of the profile thickness 408T to the profile chord 408C along said portion of the span 402. In some example embodiments, the body structure 452 may comprise one or more pieces of composite material defining the outer surface 134S, the enclosure 460, any combination thereof, or the like. In some example embodiments, the rotor blades 134 may each have a swept portion (e.g., a swept tip section proximate to the tip 134T). In some example embodiments, a “wind turbine” rotor assembly may be a rotor assembly having any of the above-noted root section, airfoil section, body structure construction, enclosure, variable profile chord, variable profile thickness, sweep, twist, any combination thereof, or the like.

Still referring to FIGS. 1, 2A-2D, and 3, the process assembly 100 may include one or more support structures 140 configured to support the weight of the wind turbine air mover assembly 120 (e.g., the entire weight of the wind turbine air mover assembly 120) so as to fix the wind turbine air mover assembly 120 in the vertical axis configuration and fixed position as shown in the process assembly 100. The support structure 140 may include any known support (e.g., load-bearing) structures, including for example one or more steel beams connecting at least a portion of the wind turbine air mover assembly 120 to (and thus configured to transfer the load of the wind turbine air mover assembly 120 to) one or more other load-bearing structures (e.g., the foundation structure 104, the shroud structure 102, etc.). In some example embodiments, the support structures 140 may be coupled to the shroud structure 102, such that the shroud structure 102 may transfer the weight (e.g., load) of the wind turbine air mover assembly 120 from the support structures 140 to a foundation structure 104 upon which the process assembly 100 is resting. Accordingly, in some example embodiments, the cylindrical shroud structure 102, at least partially circumferentially surrounding the enclosure 100V (also referred to herein as a central enclosure space) may be coupled to the air mover assembly 120 (e.g., via one or more support structures 140) such that the cylindrical shroud structure 102 is configured to at least partially structurally support a weight of the wind turbine rotor assembly 130 (and thus the wind turbine rotor blades 134 thereof) over the enclosure 100V (e.g., at least partially overlapping the enclosure 100V in the axial direction, which may be the direction of the central axis 130A, which may be a vertical direction that is parallel with the direction of gravity). Accordingly, in some example embodiments, the cylindrical shroud structure 102 may be understood to be a load-bearing structure with regard to at least the wind turbine rotor assembly 130.

However, example embodiments are not limited thereto, and in some example embodiments, including the example embodiments shown in at least FIG. 2D, the support structures 140 may transfer the entire load of the wind turbine air mover assembly 120 to the foundation structure 104 independently of the shroud structure 102, such that the shroud structure 102 does not support any of the load of the wind turbine air mover assembly 120. As shown in FIGS. 2A, 2B, and 2D, the wind turbine air mover assembly 120 may be positioned in relation to the support structures 140 so that the wind turbine rotor assembly 130 is at least partially suspended beneath the support structure 140, but example embodiments are not limited thereto. For example, in some example embodiments, the wind turbine air mover assembly 120 may be positioned in relation to the support structure 140 so that the wind turbine rotor assembly 130 is at least partially above the support structure 140.

As further shown in at least FIGS. 2A-2D and 3, the wind turbine air mover assembly 120 may be positioned in the process assembly 100 so that the distal tips 134T of the rotor blades 134 are horizontally spaced apart 134D from the inner surface 102S of the shroud structure 102, such that the entire load of the rotor blades 134 is transferred to the central rotor hub 132 and is further transferred to the one or more support structures 140. As shown in FIG. 2A, in some example embodiments the swept area 130E of the rotor blades 134 may not overlap the one or more process devices 110 in the vertical direction (e.g., the direction parallel to the direction of gravity G), but example embodiments are not limited thereto. In some example embodiments, the swept area 130E of the rotor blades 134 may partially or completely overlap one or more process devices 110 in the vertical direction.

Referring now to FIGS. 2A-2D, the process assembly 100 may include one or more process devices 110 in various locations and/or orientations in the process assembly 100 relative to the wind turbine air mover assembly 120, the top opening(s) 100T, the bottom opening(s) 100B, or the like.

Referring to FIGS. 2A, 2B, and 2D, in some example embodiments the wind turbine rotor assembly 130 is between the one or more process devices 110 and an air outlet 190B of the process assembly 100 (which may be implemented by the top opening 100T), such that the wind turbine rotor assembly 130 is configured to induce the air flow 180 through the one or more process devices 110 based on drawing the air flow 180 through the one or more process devices 110 (e.g., to exit the one or more process devices 110 as exit air 184) and further forcing the drawn air through the air outlet 190B. Referring to FIGS. 2A, 2B, and 2D, in some example embodiments the wind turbine rotor assembly 130 is at least partially above the one or more process devices 110 in the vertical direction, such that the wind turbine rotor assembly 130 is configured to draw the air flow 180 upwards through the wind turbine rotor assembly 130 and at least partially opposite the direction of gravity G.

For example, as shown in FIG. 2A, in some example embodiments at least the wind turbine rotor assembly 130 is vertically (e.g., in a direction extending parallel to the direction of gravity G) between the one or more process devices 110 and the top opening 100T of the process assembly 100. As shown in FIG. 2A, the wind turbine air mover assembly 120 may be configured to induce the air flow 180 such that the wind turbine air mover assembly 120 draws ambient intake air 182 from the ambient environment 190 to flow into the one or more process devices 110 via an inlet side 112 of the one or more process devices 110 to pass over at least a portion of the one or more process devices 110 (e.g., one or more surfaces and/or through one or more elements of the one or more process devices 110) and to further be drawn out of the one or more process devices 110 via an outlet side 114 of the one or more process devices 110 as exit air 184. As further shown in FIG. 2A, the wind turbine air mover assembly 120 may be configured to further draw the exit air 184 vertically upwards through an intake side 128A of the wind turbine air mover assembly 120 to be discharged from the process assembly 100 via the discharge side 128B of the wind turbine air mover assembly 120 and further through the top opening 100T into the ambient environment 190 (e.g., atmosphere). In the example embodiments shown in FIG. 2A, the inlet side 112 of the one or more process devices 110 implement both the bottom opening 100B of the process assembly 100 and the air inlet 190A through which the wind turbine air mover assembly 120 causes the air flow 180 to be drawn from the ambient environment 190 (as intake air 182) into the process assembly 100, and the top opening 100T of the process assembly may implement the air outlet 190B through which the wind turbine air mover assembly 120 causes the air flow 180 to be discharged (as exit air 184) from the process assembly 100 to the ambient environment 190 As shown in FIG. 2A, the wind turbine rotor assembly 130 may be configured to induce the air flow 180 over at least a portion of the one or more process devices 110 (e.g., through the one or more process devices 110, over one or more surfaces of the one or more process devices 110, etc.) based on drawing the air flow 180 through the one or more process devices 110 via an air inlet 190A and further forcing the drawn air (exit air 184) through the air outlet 190B.

As further shown in FIG. 2A, the one or more process devices 110 may be positioned in a circumferential pattern (e.g., in a ring pattern) extending around the circumference of the process assembly 100 so that the inlet side 112 and the outlet side 114 face radially outwards and/or inwards from the central axis 130A and at least partially perpendicular to the direction of gravity G. The one or more process devices 110 may facilitate flow communication between the enclosure 100V and the ambient environment 190 through the one or more process devices 110. As a result, the one or more process devices 110 may be configured to direct the air flow 180 over at least a portion of the one or more process devices 110 (e.g., through the one or more process devices 110 and/or one or more surfaces of the one or more process devices 110), from the inlet side 112 thereof to an outlet side 114 thereof, as a horizontal air flow. In addition, as shown in FIG. 2A, where the wind turbine air mover assembly 120 is configured to draw the air flow 180 into the enclosure 100V from the ambient environment 190 via the one or more process devices 110, such that the outlet sides 114 face radially inwards to the enclosure 100V and the inlet sides 112 face radially outwards to the ambient environment 190, the wind turbine air mover assembly 120 may cause the exit air 184 exiting the one or more process devices 110 into the enclosure 100V to change direction to flow vertically after being drawn out of the outlet side 114 of the one or more process devices 110.

Referring now to FIG. 2B, the one or more process devices 110 may be positioned within the enclosure 100V, separately from and vertically above the bottom openings 100B of the process assembly 100 (which may be implemented by openings 1021 in the shroud structure 102 and which may implement the air inlets 190A of the process assembly 100) so as to at least partially define a bottom air chamber 106B beneath the process device 110 and a top air chamber 106T above the process device 110. The one or more process devices 110 may extend transversely (e.g., in a planar configuration) across the enclosure 100V, between opposing inner surfaces 102S of the shroud structure 102, to partition the enclosure 100V into the separate top and bottom air chambers 106T and 106B. The one or more process devices 110 may facilitate flow communication between the top and bottom air chambers 106T and 106B through the one or more process devices 110. As shown, the process assembly 100 may include one or more support structures 142 (e.g., load-bearing steel beams) that may structurally support the one or more process devices 110 in the transverse, elevation position shown in FIG. 2B (e.g., via transferring the load of the one or more process devices 110 to the shroud structure 102, transferring the load directly to the foundation structure 104, any combination thereof, or the like).

As shown in FIG. 2B, the wind turbine air mover assembly 120 may draw the air flow 180, as intake air 182, into the bottom air chamber 106B from the ambient environment 190 via the one or more air inlets 190A (bottom openings 1021, 100B) and to further draw the intake air 182 from the bottom air chamber 106B and through the one or more process devices 110 to the top air chamber 106T so as flow over one or more surfaces of (or through) one or more elements of the process device 110 and to be discharged as exit air 184 from the top air chamber 106T into the ambient environment 190 via the wind turbine air mover assembly 120 and the air outlet 190B that is implemented by the top opening 100T.

Referring now to FIG. 2C, in some example embodiments, the wind turbine rotor assembly 130 may be between the one or more process device 110 and an air inlet 190A of the process assembly 100, such that the wind turbine rotor assembly 130 is configured to force the air flow 180 (e.g., as intake air 182) toward the one or more process devices 110 based on drawing the air flow 180 through the air inlet 190A and further forcing the drawn air toward the one or more process devices 110. For example, as shown in FIG. 2C, the wind turbine air mover assembly 120 in some example embodiments may be located vertically beneath the one or more process devices 110 of the process assembly 100 in the bottom air chamber 106B at least partially defined beneath a bottom side of the one or more process devices 110. The wind turbine air mover assembly 120 may be mounted on a foundation structure 104, which may be the foundation upon which the shroud structure 102 is supported or may be a separate foundation. The wind turbine air mover assembly 120 may be configured to draw the air flow 180, as intake air 182, from the ambient environment 190 into the bottom air chamber 106B via one or more air inlets 190A (bottom openings 1021, 100B) and force the air flow 180 vertically upwards from the bottom air chamber 106B and through the one or more process devices 110 to the top air chamber 106T so as flow over at least a portion of (e.g., one or more surfaces of or through) the one or more process devices 110 and to be discharged as exit air 184 from the top air chamber 106T into the ambient environment 190 via the air outlet 190B that is implemented by the top opening 100T.

Referring now to FIG. 2D, in some example embodiments a process assembly 100 may include a wind turbine air mover assembly 120 that may be structurally supported by one or more support structures 140 independently of the shroud structure 102, such that the structural load of the wind turbine air mover assembly 120 is transferred to the foundation structure 104 (e.g., at grade) independently of the shroud structure 102.

Still referring to FIG. 2D, in some example embodiments, the shroud structure 102 may have a shape other than a linear cylindrical shape as shown in FIGS. 2A-2C. For example, as shown in FIG. 2D, the shroud structure 102 may have a more complex shape, which may be an at least partially hyperbolic conduit (e.g., a truncated hyperboloid shape as shown) between the wind turbine rotor assembly 130 and the one or more process devices 110 in the vertical direction, so as to configure the shroud structure 102 to direct the air flow 180 flowing through the enclosure 100V at least partially defined by the shroud structure 102 to facilitate improved air flow 180 through the process assembly 100 (e.g., improved flow uniformity through the one or more process devices 110, reduced turbulence in the air flow 180, etc.).

As shown in FIGS. 2A-2D, the wind turbine air mover assembly 120 may be configured to generate the air flow 180 to move vertically “upwards” through the wind turbine air mover assembly 120 to be forced upwards back to the ambient environment 190. Such a configuration may increase both the upwards velocity and temperature of the air flow 180 moving through the wind turbine air mover assembly 120. Upon discharge from the wind turbine air mover assembly 120 and further discharge vertically out of the process assembly 100 via the top opening 100T, such upwards-moving air flow 180 may have an upward momentum and may rise upwardly (against air friction losses and dissipative forces/currents) due to an elevated temperature of the discharged air flow 180 in relation to the surrounding ambient air of the ambient environment 190, thereby limiting recirculation of the discharged air flow 180 through the process assembly 100.

While FIGS. 2A-2B and 2D illustrate the wind turbine air mover assembly 120 as inducing the air flow 180 so as to “draw” air through the process device 110 towards the wind turbine air mover assembly 120 and vertically “upwards” through the wind turbine air mover assembly 120 to be forced upwards back to the ambient environment 190, example embodiments are not limited thereto. For example, in some example embodiments, the top opening 100T may be the air inlet 190A of the process assembly 100, and the wind turbine air mover assembly 120 may be configured to draw the air flow 180 as intake air 182 downwards from the ambient environment 190 into the enclosure 100V via the top opening 100T and to further force the intake air 182 downwards from the wind turbine air mover assembly 120 to be forced into the one or more process devices 110 via an inlet side 112 thereof, through the one or more process devices 110, and back to the ambient environment 190 as exit air 184 via an outlet side 114 of the one or more process devices 110 and an air outlet 190B of the process assembly 100. In such example embodiments, the inlet sides 112 and the outlet sides 114 of the one or more process devices 110 shown in FIGS. 2A-2B and 2D may be swapped, the air inlet 190A and the air outlet 190B may be swapped, and the rotor blades 134 of the wind turbine rotor assembly 130 may be oriented to generate vertical downwards air flow 180 through the wind turbine air mover assembly 120 instead of vertical upwards air flow 180 through the wind turbine air mover assembly 120. In such example embodiments, where the wherein the wind turbine rotor assembly 130 is at least partially above the one or more process devices 110 in the vertical direction as shown in FIGS. 2A, 2B, and 2D, and where the wind turbine rotor assembly 130 is between the one or more process devices 110 and an air inlet 190A of the process assembly 100 (based on the air inlet 190A and air outlet 190B as shown in FIGS. 2A, 2B, and/or 2D being swapped), the wind turbine rotor assembly as shown in FIGS. 2A, 2B, and/or may be configured to force the air flow 180 downwards through the wind turbine air mover assembly 120 and at least partially in the direction of gravity G toward one or more process devices 110 (e.g., as intake air 182).

While FIG. 2C illustrates the wind turbine air mover assembly 120 as forcing the air flow 180 so as to “force” air vertically upwards from the wind turbine air mover assembly 120 and through the one or more process devices 110 towards the ambient environment 190 via the top opening 100T, example embodiments are not limited thereto. For example, in some example embodiments, the top opening 100T may be the air inlet 190A of the process assembly 100, and the wind turbine air mover assembly 120 may be configured to draw the air flow 180, as intake air 182, downwards from the ambient environment 190 via the top opening 100T and through the process device 110 down into the bottom air chamber 106B as exit air 184 and to further force the exit air 184 from the bottom air chamber 106B into the ambient environment 190 via one or more air outlets 190B through the shroud structure 102. In such example embodiments, the inlet sides 112 and the outlet sides 114 shown in FIG. 2C may be swapped, the air inlet 190A and the air outlet 190B may be swapped, and the rotor blades 134 may be oriented to generate vertical downwards air flow 180 through the wind turbine air mover assembly 120 instead of vertical upwards air flow 180 through the wind turbine air mover assembly 120. As a result, in example embodiments where the wind turbine rotor assembly 130 is at least partially beneath the one or more process devices 110 in the vertical direction as shown in FIG. 2C and is further between the one or more process devices 110 and the air outlet 190B of the process assembly (e.g., based on the air inlet 190A and air outlet 190B shown in FIG. 2C being swapped), the wind turbine rotor assembly 130 may be configured to draw the air flow 180 downwards through the wind turbine rotor assembly 130 and at least partially in the direction of gravity G.

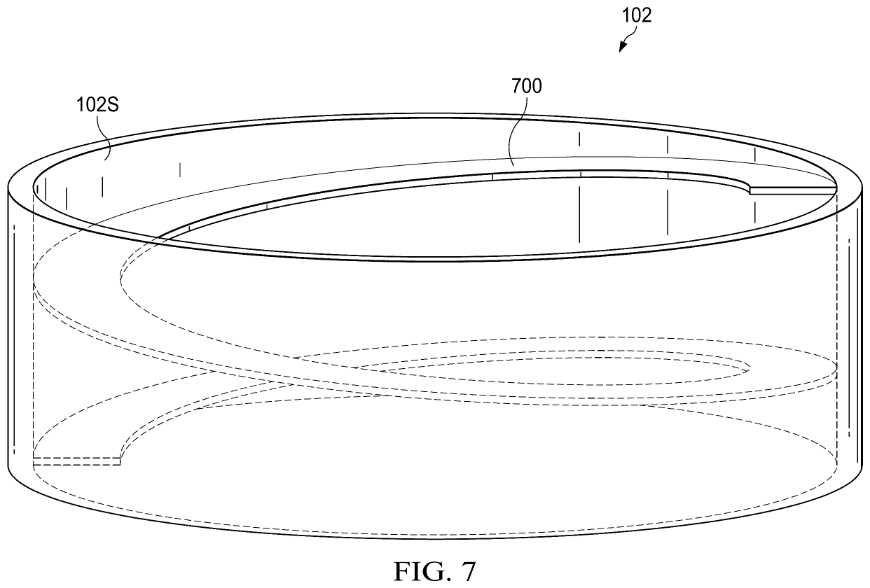

FIG. 7 is an expanded perspective view of a portion of a cylindrical shroud structure in region 7 in FIG. 2D, according to some example embodiments.

In some example embodiments, a shroud structure 102 of a process assembly 100 may act as a diffuser to direct and control air flow 180 drawn into and/or discharged out of the wind turbine air mover assembly 120. In some example embodiments, and as shown in at least FIGS. 2D and 7, the shroud structure 102 may include one or more helical strakes 700 extending in a helical pattern around the inner surface 102S of at least a portion of the shroud structure 102. As shown in FIG. 2D, the helical strakes may extend between the wind turbine air mover assembly 120 (e.g., an intake side 128A and/or discharge side 128B thereof) and the one or more process devices 110 (e.g., an inlet side 112 and/or outlet side 114). For example in FIG. 7, the helical strakes 700 may extend around the inner surface 102S of a portion of the shroud structure 102 extending between a discharge side 128B of a wind turbine air mover assembly 120 (either at the top or the bottom of the shroud structure 102) and an inlet side 112 of a process device 110 (either at the bottom or the top of the shroud structure 102).

The helical strakes 700 may mitigate, reduce, minimize, or eliminate potential induced turbulence or flow pulsation due to resonance in the air flow 180 (e.g., the portion of the air flow discharged from the wind turbine air mover assembly 120, such that the helical strakes 700 may protrude from the one or more inner surfaces 102S at a “downstream” portion of the enclosure 100V that is “downstream” of the wind turbine air mover assembly 120 within the enclosure). While some induced air turbulence in the air flow 180 (e.g., induced air turbulence produced in the air flow 180 discharged from the wind turbine air mover assembly 120) could add potential benefits to operation of a process device 110 that is downstream of the wind turbine air mover assembly 120 (e.g., where the process device 110 includes a heat exchanger as described herein that is downstream of the wind turbine air mover assembly 120, an induced air turbulence produced in the air flow 180 discharge from the wind turbine air mover assembly 120 could improve the heat transfer performance of the heat exchanger to transfer heat from a working fluid into the air flow 180), while the one or more helical strakes 700 may be present in a portion of the shroud structure 102 defining a downstream flow conduit within the enclosure 100V between the wind turbine air mover assembly 120 and one or more process devices 110 to mitigate, reduce, minimize, or eliminate potential induced turbulence or flow pulsation due to resonance in the air flow 180 flowing over one or more surfaces of the one or more process devices 110 (and/or through the one or more process devices 110) in order to mitigate, reduce, minimize, or prevent deterioration of the process device 110 performance due to such induced turbulence or flow pulsation due to resonance, thereby improving operation of the process device 110 to perform one or more process (e.g., heat transfer, carbon dioxide capture, etc.).

FIG. 8A is a schematic view of a nuclear power plant including a process assembly configured to act as a cooling tower to remove heat from a working fluid of the nuclear power plant, according to some example embodiments. FIGS. 8B and 8C are cross-sectional views of a process assembly configured to act as a cooling tower, according to some example embodiments. FIGS. 8D and 8E illustrate comparative footprint areas of a cooling tower including the process assembly and a comparative example, according to some example embodiments. The cross-sectional view of FIG. 8B is a cross-sectional view along line VIIIB-VIIIB′ in FIG. 8D.

Referring to FIGS. 8A-8C, a process assembly 100 may include one or more heat exchangers 850 configured to reject (transfer) heat from a working fluid 834 into at least a portion of the air flow 180 directed to flow over one or more surfaces of the one or more heat exchangers 850, and thus in thermal communication with the working fluid 834 through one or more portions of the one or more heat exchangers 850, such that the wind turbine air mover assembly 120, including the wind turbine rotor assembly 130 in the vertical axis configuration, is configured to cause at least a portion of the air flow 180 to flow over one or more surfaces of the one or more heat exchangers 850 to remove heat from the working fluid 834 circulating therein based on causing at least a portion of the air flow 180 to move vertically through the wind turbine air mover assembly 120.

Some example embodiments provide the process assembly 100 including a wind turbine air mover assembly 120 further including a wind turbine rotor assembly 130, initially designed for horizontal axis operation (where the central axis 130A of the wind turbine rotor assembly 130 is perpendicular to the direction of gravity G during operation of the wind turbine rotor assembly 130 as part of a wind turbine to generate electricity), where the wind turbine rotor assembly 130 of the wind turbine air mover assembly 120 is in a vertical axis configuration as shown (central axis 130A being parallel to the direction of gravity G) as part of a cooling tower (e.g., a dry cooling tower, a wet cooling tower, or the like) to remove heat from a cooling system (e.g., a closed loop cooling system of a dry cooling tower, an open loop cooling system of a wet cooling tower, etc.) for a power plant power cycle. A process assembly 100 including the one or more heat exchangers 850 circulating a working fluid 834 of a cooling system for a power plant power cycle may utilize the wind turbine air mover assembly 120 having a wind turbine rotor assembly 130 with highly aerodynamically efficient rotor blades 134 to move very large volumes of air (e.g., a high flow rate of air flow 180) based on rotating 130R the wind turbine rotor assembly 130 using an electric motor (e.g., drive motor 124) where a generator would normally be in a wind turbine to convert rotational shaft energy into electricity. The mechanically driven rotation 130R of the wind turbine rotor assembly 130 by the drive motor 124 may configure the wind turbine rotor assembly 130 to operate as a highly efficient high volume low pressure (HVLP) fan for a cooling tower and on a massive scale.

A process assembly 100 that implements a cooling tower based on including one or more process devices 110 that include one or more heat exchangers 850 configured to discharge heat to an air flow 180 and a wind turbine air mover assembly 120 including a wind turbine rotor assembly 130 and configured to generate the air flow 180 may take advantage of a wind turbine rotor assembly's potential to move these large volumes/masses of air at relatively low speed and low pressure which may match air flow 180 requirements for such heat exchangers 850 to implement a particular rate of heat transfer. Using a wind turbine rotor assembly 130 that corresponds to a standard onshore wind turbine rotor and hub design in the wind turbine air mover assembly 120 in such a cooling tower 840 may significantly reduce the initial cost of the cooling tower 840, power consumption of the cooling tower 840, number of units requirements of the cooling tower as well as the broadband noise generated by the cooling tower 840 while achieving improved or maximized acrodynamic efficiency of the wind turbine air mover assembly 120 of the cooling tower 840, based on the aerodynamic efficiency, reduced weight, reduced noise, and the like associated with the cooling tower 840 including a wind turbine air mover assembly 120 that includes a wind turbine rotor assembly 130 as described herein, having the distinctive structural and/or operational characteristics as described herein to provide such improvements, instead of a set of one or more conventional air movers (e.g., conventional axial fans). Power consumption by the process assembly 100 to generate and maintain a certain amount (e.g., volumetric flow rate) of air flow 180 may be reduced based on including an air mover that includes the wind turbine air mover assembly 120. The entire wind turbine air mover assembly 120 may be enclosed with a shroud structure 102 which aids in improving aerodynamic efficiency further and additional noise reduction. In a cross-wind configuration, the average wind & turbulence at the wind turbine air mover assembly 120 intake may be reduced or negligible, causing significant reduction in the turbulent fatigue damage loads increasing wind turbine rotor assembly 130 life. Any induced air turbulence produced in the air flow discharge from the wind turbine rotor assembly 130 could add potential benefits to the heat exchanger 850 performance. However, if after detailed analysis any induced turbulence or flow pulsation due to resonance is determined to be undesirable, it can be mitigated by adding “helical strakes” 700 as shown in FIG. 6 around the shroud structure 102 (e.g., diffuser).

Referring to FIG. 8A, a nuclear power plant 800 may include at least one coolant circuit (e.g., coolant circuit 830 and/or 810) configured to circulate a working fluid 834 to absorb heat from a heat source and to transfer the absorbed heat into a heat sink. Such a heat sink may include a cooling tower 840 configured to further transfer the heat to the ambient environment 190 (e.g., ambient atmosphere) which serves as a heat sink for the nuclear power plant 800. The heat source for a given coolant circuit in the nuclear power plant 800 may include the nuclear reactor 801 and/or a separate working fluid of a separate coolant circuit. For example, the nuclear reactor 801 may serve as a heat source for the working fluid 814 of the circuit 810 and the heat exchanger 826 and/or working fluid 814C may serve as a heat source for the working fluid 834 of the circuit 830. Still referring to FIG. 8A, a process assembly 100 may be configured to operate as (e.g., configured to implement) a cooling tower 840 (e.g., a dry cooling tower) to remove heat from the nuclear power plant 800 (e.g., a power cycle and/or coolant circuit of the nuclear power plant 800) to the ambient environment 190 based on directing an air flow 180 (e.g., intake air 182) to flow over at least a portion of (e.g., through and/or over one or more surfaces of), and thus in thermal communication with, one or more process devices 110 that include a heat exchanger to remove heat from a working fluid circulating through the heat exchanger, where the working fluid may be circulated in a coolant circuit of the nuclear power plant 800 to transfer heat from another part of the nuclear power plant (e.g., a nuclear reactor core, another coolant circuit, etc.) to the heat exchanger of the one or more process devices 110 for removal to the ambient environment 190 (e.g., atmosphere).

Referring to FIG. 8A, a nuclear power plant 800 having a boiling water reactor (BWR) design may include a nuclear reactor 801 comprising a nuclear reactor vessel 802 that includes a nuclear reactor core 804, and which may be enclosed within a containment structure 806, where the nuclear reactor core 804 is configured to discharge heat based on nuclear reactions occurring therein. The nuclear power plant 800 may include a coolant circuit 810 (e.g., a primary circuit) including conduits 812 (tubes, pipes, etc.) that circulate a working fluid 814 as a primary coolant through the nuclear reactor 801 and in thermal communication with the nuclear reactor core 804 to remove heat from the nuclear reactor 801. In the boiling water reactor design of the nuclear power plant 800 of FIG. 8A, the working fluid 814 is water. In the coolant circuit 810, the working fluid 814 may be directed as cold working fluid 814A (e.g., condensed “cold water”) into the reactor vessel 802 to absorb heat from the reactor core 804 to become hot working fluid 814B (e.g., evaporated cold water coolant that is high pressure steam). The hot working fluid 814B (e.g. high pressure steam) may then be directed via one or more conduits 812 from the nuclear reactor vessel 802 to a turbine assembly 820 to spin a turbine to further operate a generator 822 to generate electrical power 824. The hot working fluid 814B may be reduced in pressure and/or temperature based on passing through the turbine assembly 820 to exit the turbine assembly as warm working fluid 814C (e.g., low pressure steam or hot condensate water or any combination thereof). The warm working fluid 814C may be directed via one or more conduits 812 to a heat exchanger 826 which removes further heat from the warm working fluid 814C to cool (and, in some example embodiments, condense) the working fluid 814 to the cold working fluid 814A (e.g., condense low pressure steam to condensed cold water) which may be pumped back to the nuclear reactor vessel 802 by a pump 828 to complete the coolant circuit 810.

Still referring to FIG. 8A, the nuclear power plant 800 may include another coolant circuit 830 (e.g., a secondary circuit) including conduits 832 that circulate another working fluid 834 as a secondary coolant through the heat exchanger 826 to remove heat from the warm working fluid 814C to cool/condense the working fluid back to a “cold” working fluid 814A as described above. The working fluid 834 may be water or may be a different coolant (e.g., liquid metal, liquid salt, a different liquid, a gas, or the like). The coolant circuit 830 may circulate the working fluid 834 in a “cold” state (e.g., cold working fluid 834A, such as cold liquid water) into the heat exchanger 826 to remove/absorb heat from the warm working fluid 814C to become hot working fluid 834B (e.g., hot liquid water).

In some example embodiments, a process assembly 100 according to any of the example embodiments, including any of the example embodiments shown in FIGS. 2A to 2D, is included in the nuclear power plant 800 as a cooling tower 840, where the one or more process devices 110 of the process assembly 100 include and/or implement one or more heat exchangers 850 that are configured to circulate the hot working fluid 834B in thermal communication (e.g., heat transfer communication) with the air flow 180 generated by the wind turbine air mover assembly 120 (including the wind turbine rotor assembly 130) of the process assembly 100. Referring to FIGS. 8B and 8C, a heat exchanger 850 may be a “dry” or “closed loop” heat exchanger which receives the working fluid 834 (as hot working fluid 834B) via an inlet port 858A and circulates the working fluid 834 through one or more cooling tubes 852 (e.g., tubes, which may comprise any thermally conductive material, such as steel) that may be exposed to the interior enclosure 100V of the process assembly 100 and thus may be exposed to the air flow 180 generated by the wind turbine air mover assembly 120, such that the process assembly 100 implements a dry cooling tower. A heat exchanger 850, in a tube and fin configuration, may include one or more additional surfaces (e.g., fins 854, which may comprise any thermally conductive material, such as steel) coupled to the outer surfaces 852S of the one or more cooling tubes 852 to increase the heat exchange area of the heat exchanger 850 to the air flow 180, thereby improving heat transfer from the working fluid 834 in the cooling tubes 852 to the air flow 180. The heat exchanger 850 may include structures 856 defining an enclosure 850V in which a heat exchanger 850 is included and which is exposed to at least the enclosure 100V, and which implement the inlet side 112 opening and the outlet side 114 opening of the process device 110, but example embodiments are not limited thereto. The air flow 180, passing over the exposed surfaces of the heat exchanger 850 (e.g., outer surfaces 852S of the cooling tubes 852, exposed surfaces of the fins 854, etc.) may remove heat from the heat exchanger 850, and thus remove heat from the hot working fluid 834B circulating through the cooling tubes 852 via such exposed surfaces, and the wind turbine air mover assembly 120 may cause such air flow to be discharged from the process assembly 100 (cooling tower 840) to the ambient environment 190, thereby removing heat from the nuclear power plant 800. The working fluid may thus be cooled to a cold working fluid 834A based on circulating through the heat exchanger 850, due to heat transfer from the working fluid to the air flow 180 via the structures and/or surfaces of the cooling tubes 852, fins 854, or the like of the heat exchanger 850. The cold working fluid 834A may then be circulated out of the heat exchanger 850 and the process assembly 100 (e.g., via an outlet port 858B of the heat exchanger 850) and pumped back to the heat exchanger 826 via a pump 836 to remove additional heat from the primary coolant circuit 310.

The nuclear power plant 800 shown in FIG. 8A is a boiling water reactor (BWR) design nuclear power plant, but it will be understood that the process assembly 100 with a heat exchanger process device may be provided to operate as a cooling tower in nuclear power plants of various designs, including a Boiling Water Reactor (BWR) design nuclear power plant, a Pressurized Water Reactor (PWR) design nuclear power plant, a liquid metal cooled reactor design nuclear power plant, a High Temperature Gas Reactor (HTGR), a Sodium Fast Reactor (SFR), a Molten Salt Reactor (MSR) design nuclear power plant, an Advanced Boiling Water Reactor (ABWR) design nuclear power plant, an Economic Simplified Boiling Water Reactor (ESBWR) design nuclear power plant, a BWRX-300 reactor design nuclear power plant, or the like. In addition, while the nuclear power plant 800 shown in FIG. 8A is shown to include multiple coolant circuits, with a coolant circuit 810 (e.g., primary coolant circuit) extending through the nuclear reactor core 804 and a coolant circuit 830 (e.g., secondary coolant circuit) extending through the cooling tower 840, example embodiments are not limited thereto. For example, the nuclear power plant 800 may include another coolant circuit between coolant circuits 810 and 830. In another example, the coolant circuit 830 and heat exchanger 826 may be omitted, such that the coolant circuit 810 may circulate the warm working fluid 814C directly to the heat exchanger 850 of the cooling tower 840 to be cooled/condensed to cold working fluid 814A to be returned to the nuclear reactor 801. The working fluids 814 and 834 are described in relation to FIGS. 8A-8C may be water, but such working fluids 814 and/or 834 may include any well-known coolant fluid that may be used in cooling any part of a nuclear plant and/or nuclear reactor, including water, a liquid metal (e.g., liquid sodium), a gas (e.g., helium), a molten salt, any combination thereof, or the like. It will be understood that a “fluid” as described herein may include a gas, a liquid, or any combination thereof.

While the cooling tower 840 implemented by the process assembly 100 and process device(s) 110 as described herein is a dry cooling tower that circulates a working fluid 834 in a closed loop through the heat exchanger 850 without direct exposure of the working fluid 834 to the air flow 180, example embodiments are not limited thereto. For example, in some example embodiments the cooling tower 840 may be a wet cooling tower. In the same example or in another example, in some example embodiments the cooling tower 840 may circulate the working fluid 834 in an at least partially open loop.

Still referring to FIGS. 8A-8C, the cooling tower 840 implemented by the process assembly 100 and process device 110 as described herein is a dry cooling tower that circulates a working fluid 834 in a closed loop through the heat exchanger 850 without direct exposure of the working fluid 834 to the air flow 180. A state-of-the-art conventional dry cooling tower employs numerous fans (a typical example=vane-axial HVLP fans), for example 15 kW fans, to move air over a heat exchanger to cool a working fluid 834, typically warm water or hot water, using the temperature of the ambient air flow 180 to cool the cooling tubes 852, indirectly cooling the working fluid 834 with nearly zero evaporation due to working fluid 834 being in a closed loop. For a typical 870 MWt nuclear power plant 800 with a Rankine steam cycle, the working fluid 834 that is heated by a steam turbine condenser (e.g., heat exchanger 826) may be required to be cooled as significant amounts of heat (approximately 560 MWt) are transferred into the working fluid 834 as the steam in the primary steam generation cycle (e.g., coolant circuit 810) is condensed to water to be pumped back into the nuclear reactor 801.

Removal of this heat is typically removed via a wet cooling tower or once-through cooling from a lake or river. A wet cooling tower typically requires over 4,000 gpm of fluid (e.g., consumable water) for this size power plant (870 MWt nuclear power plant 800), of which more than 3,500 gpm of fluid (e.g., consumable water) is evaporated as it is heated by the hot condensed water (e.g., hot working fluid 834B). In locations where water is unavailable or costly to consume, it may be desirable to deploy a “dry cooling tower” which cools the hot working fluid 834B (e.g., hot condensed water) using the air (e.g., ambient air from the ambient environment 190), wherein the working fluid 834 is contained in a closed loop and does not evaporate. In this dry cooling tower configuration, the nuclear power plant 800 may operate with near zero water loss. However, to reduce the size of the heat exchanger 850 required (which would be prohibitively large if relying on natural convection to move sufficient air flow over the outer surfaces 852S of the cooling tubes 852 and/or fins 854), mechanically driven fans are used to move ambient air (e.g., air flow 180) over the outer surfaces 852S of cooling tubes 852—typically requiring for this reference nuclear power plant 800 a power expenditure (e.g., electrical power consumption 860, which may be obtained from the generated electrical power 824 from the generator 822) of approximately 55 MWe compared to a reference requirement of near zero power expenditure for once-through cooling of the working fluid 834 to 15 MWe for a wet cooling tower. 55 MWe represents an approximate 18% reduction in total power plant electrical power output 858 for this reference nuclear power plant 800 if conventional fans were to be utilized as an air mover assembly (e.g., air mover) for the cooling tower 840. A hybrid cooling tower requires a power expenditure (e.g., electrical power consumption 860) of approximately 30 MWe and still evaporates approximately 600 gpm of fluid (e.g., consumable water), which is not feasible without a significant consumable water source at the site.

In some example embodiments, based on the cooling tower 840 being implemented by a process assembly 100 that includes a wind turbine air mover assembly 120 with a wind turbine rotor assembly 130 (e.g., in a vertical axis configuration) to generate an air flow 180 that moves vertically through the wind turbine air mover assembly 120 in order to remove heat from a heat exchanger 850 included in the one or more process devices 110, the process assembly 100 may enable the nuclear power plant 800 to be located at a site that does not have access to large volumes of consumable water (e.g., based on the cooling tower 840 being a dry cooling tower) without introducing a very significant MWe penalty (e.g., power expenditure, electrical power consumption 860, etc.) for the power plant output 858 due to the vertical-axis “wind turbine” wind turbine rotor assembly 130 enabling an expected 90% reduction in electrical power consumption 860 to move the equivalent air flow 180 to facilitate the cooling of the working fluid 834. As described herein, such power consumption reduction for a given magnitude of air flow 180 may be based on the acrodynamic efficiency and/or weight loss provided by the wind turbine air mover assembly 120 with a wind turbine rotor assembly 130 in the vertical axis configuration instead of conventional axial fans as described herein to provide a same magnitude of air flow 180. Such location requirement expansion may increase the number (quantity) of locations available for power plant deployment resulting in cheaper site acquisition for power plants by millions or tens of millions of dollars per plant, based on the plant including a dry cooling tower 840 that is implemented by a process assembly 100 that includes a wind turbine air mover assembly 120 with a wind turbine rotor assembly 130 according to any of the example embodiments, including for example any of the example embodiments shown in FIGS. 2A-2D.

Furthermore, such a process assembly 100 (that includes a wind turbine air mover assembly 120 with a wind turbine rotor assembly 130) implementing a dry cooling tower 840 at the nuclear power plant 800 may reduce capital expenditures (CAPEX) associated with the cooling tower 840 and/or the nuclear power plant 800 due to the lower total volume requirement and lower cost (e.g., lower operating cost due to reduced power consumption, lower capital expenditures cost due to using a single rotor assembly instead of multiple rotor assemblies requiring multiple sets of support structures, etc.) for the single wind turbine rotor assembly 130 compared to numerous vane fans that are conventionally utilized in a dry cooling tower of comparable heat transfer (e.g., 560 MWt).

In addition, such a process assembly 100 (that includes a wind turbine air mover assembly 120 with a wind turbine rotor assembly 130) implementing a dry cooling tower 840 at a nuclear power plant 800 may enable clean power production in places where water consumption is very expensive like Arizona and Alberta Canada and even Africa and the Middle East, and may further avoid the CAPEX and O&M of using once-through ocean cooling at such nuclear power plants 800 and also avoids the environmental permitting challenges of once-through cooling at such nuclear power plants 800. Furthermore, based on such a process assembly 100 (that includes a wind turbine air mover assembly 120 with a wind turbine rotor assembly 130) having reduced noise generation as described herein compared to one or more cooling towers including numerous, smaller conventional mechanical fans, siting for a dry cooling tower of this type will be less impacted by any noise restrictions for the site.

In addition, a cooling tower 840 including a wind turbine air mover assembly 120 which includes a wind turbine rotor assembly 130 in a vertical axis configuration, as shown in at least FIGS. 8B and 8C, may enable a significantly lower overall height of the cooling tower 840 (e.g., 12-15 meters overall height from the bottom to the top of the shroud structure 102)—versus a 70-90 meters overall height needed if the cooling tower 840 were utilizing conventional horizontal axis wind turbines. The horizontal plane of the wind turbine rotor assembly 130 may enable a cooling tower 840 that is much lower to the foundation structure 104 (e.g., the ground)—providing much lower support structure, installation and maintenance costs but also lower visibility from neighbors and more siting flexibility of the cooling tower 840 (and of the nuclear power plant 800).

While the heat exchanger 850 as shown in FIGS. 8B and 8C is a finned tube heat exchanger, which includes one or more cooling tubes 852 to circulate the working fluid 834 and various fins providing additional surfaces 854 provided by fins coupled to the outer surfaces 852S of the cooling tubes 852, the heat exchanger 850 is not limited thereto. A heat exchanger 850 that may be included in a process device 110, as described herein, may include any known closed-loop or open-loop heat exchanger, including for example a finned tube heat exchanger, a closed loop cooling tube heat exchanger omitting fins, a plate fin heat exchanger, a shell and tube heat exchanger, a phase change heat exchanger, a direct contact heat exchanger, any combination thereof, or the like. A heat exchanger 850 that may be included in a process device 110, as described herein, may be located at any orientation and/or location in relation to the wind turbine air mover assembly 120. For example, the heat exchanger 850 may be located vertically or angled at the air inlet 190A (e.g., bottom opening 100B) of the process assembly 100.

The cooling tower process assembly shown in FIG. 8B corresponds to the process assembly 100 shown in FIG. 2A where the one or more process devices 110 shown in FIG. 2A include one or more heat exchangers 850 (e.g., finned tube heat exchangers including one or more closed loop cooling tubes 852 and fins 854). As shown in FIGS. 2A and 8B (and as also shown in FIG. 2D), the one or more process devices 110, and thus the one or more heat exchangers 850, may be arranged in a cylindrical arrangement (e.g., a cylindrical arrangement of closed loop cooling tubes 852) around the circumference of the process assembly 100 and thus around the circumference of the enclosure 100V, similar to the arrangement of the one or more process devices 110 in the process assembly 100 shown in FIG. 2A. Referring to at least FIGS. 2A and 8B, the end of each process device 110 (e.g., outlet side 114 of heat exchanger 850 as shown in FIG. 8B) facing into the enclosure 100V may be flush or substantially flush (e.g., coplanar or substantially coplanar) with the inner surface 102S of the cylindrical shroud structure 102, but example embodiments are not limited thereto, and any end (e.g., inlet side 112 and/or outlet side 114) of one or more process devices 110 (e.g., heat exchanger 850 as shown in FIG. 8B) may be offset from and/or flush or substantially flush with one or more surfaces of the cylindrical shroud structure 102 (e.g., the inner surface 102S and/or an outer surface of the cylindrical shroud structure 102).

The cooling tower process assembly shown in FIG. 8C corresponds to the process assembly 100 shown in FIG. 2B where the one or more process devices 110 shown in FIG. 2B include one or more heat exchangers 850 (e.g., finned tube heat exchangers including one or more closed loop cooling tubes 852 and fins 854). As shown in FIGS. 2B and 8C (and as also shown in FIG. 2C), the one or more process devices 110, and thus the one or more heat exchangers 850, may be arranged in a planar arrangement (e.g., a planar arrangement of closed loop cooling tubes 852) transversely across the internal enclosure 100V of the process assembly 100 at an elevated position above the bottom of the enclosure 100V (thereby defining a bottom air chamber 106B beneath the one or more process devices 110), similar to the arrangement of the one or more process devices 110 in the process assembly 100 shown in FIG. 2B.

A cooling tower 840 implemented by a process assembly 100 including a wind turbine air mover assembly 120 according to some example embodiments, including the example embodiments shown in FIGS. 8B and 8C, may provide a cooling tower having reduced complexity (e.g., a simpler structural design taking advantage of a singular discharge column cylinder implemented by shroud structure 102 and enclosure 100V) and improved aerodynamic efficiency of the air mover assembly, reduced air mover assembly weight, etc.

While the example embodiments of a cooling tower 840 are described with reference to FIGS. 8A-8C as being configured to remove heat from a cooling circuit (e.g., power cycle) of a nuclear power plant, it will be understood that the cooling tower 840 including the wind turbine air mover assembly 120 with the wind turbine rotor assembly 130 may be included in any facility that circulates a working fluid in a power cycle, coolant circuit, or the like such that the facility requires cooling of the working fluid and the cooling tower 840 provides such cooling based on circulating the working fluid being through a heat exchanger 850 of the cooling tower 840. Such a facility may include any power plant (e.g., any non-nuclear power plant), any industrial facility (e.g., any factory, any refinery, etc.), any combination thereof, or the like.

Referring to FIG. 8D, in some example embodiments, a plurality of cooling towers 840 (e.g., dry cooling tower) each including the wind turbine air mover assembly 120 according to some example embodiments and configured to provide cooling for a 300 MWe nuclear reactor (e.g., a small modular reactor, or SMR) may require approximately (2) ˜231′ diameter cylinder shroud structures 102 to achieve a similar cooling potential as conventional dry cooling towers as shown for example in FIG. 8E, including for example 32-count 78′×78′ area fan cells. The footprint 870 estimated for the cooling towers 840 including the process assembly 100 according to some example embodiments, including a wind turbine air mover assembly 120, is approximately 154,000 square feet, or 3.5 acres, when providing at least a spacing of 872 (e.g., 18 feet) from the outer boundaries of the footprint and a spaced 874 (e.g., 84 feet) from each other. Such a footprint 870 of about 3.5 acres is an expected reduction of approximately 70% in relation to the conventional dry cooling tower configuration footprint as shown in FIG. 8E, where conventional dry cooling towers 880 comprising conventional fan air mover assemblies (e.g., having fan rotor assemblies with a 1-10 meter rotor diameter) may be estimated to require approximately 12 acres or more of footprint for a typical 300 MWe nuclear power plant (e.g., a 3000 Mwe SMR), where spacings 884 (e.g., 67.5 feet) and 886 (e.g., 75.3 feet) are provided. As a result, process assembly 100 that implements a cooling tower 840 may be configured to enable reduced footprint (e.g., area) of the cooling tower(s) providing equivalent cooling in relation to conventional cooling towers.

FIG. 9A is a schematic view of a Direct Air Capture (DAC) facility including a process assembly configured to act as a DAC system to remove carbon dioxide from ambient air, according to some example embodiments. FIGS. 9B and 9C are cross-sectional views of a process assembly configured to act as a DAC system, according to some example embodiments. FIGS. 9D and 9E illustrate comparative footprint areas of a DAC system including the process assembly and a comparative example, according to some example embodiments. The cross-sectional view of FIG. 9B is a cross-sectional view along line IXB-IXB′ in FIG. 9D.

Referring to FIGS. 9A-9C, a process assembly 100 may include one or more DAC devices 950 configured to capture carbon dioxide from the air flow 180 generated by the wind turbine air mover assembly 120. Such a process assembly 100 may be referred to as a DAC system 940 which may be included in an industrial facility such as a DAC facility 900. As shown in at least FIGS. 9B-9D, in example embodiments where a DAC system 940 includes multiple DAC devices 950 adjacent to each other, the DAC devices 950 may have respective structures 956 or separate portions of a single structure 956 (which may include a single unitary piece of material) that partitions (e.g., isolates) respective enclosures 950V of respective DAC devices 950 from each other in a direction intersecting at least some of the adjacent DAC devices 950.

For example, as shown in FIGS. 9A-9C, a DAC facility 900 may include a DAC system 940, implemented by a process assembly 100 with a wind turbine air mover assembly 120 and a process device 110 that includes and/or implements one or more DAC devices 950, may be configured to generate an air flow 180 to flow over one or more surfaces of (and/or through) a carbon capture material 972 in the DAC device(s) 950 to facilitate capture of carbon dioxide from the air flow 180. The DAC facility 900 may be configured to release captured carbon dioxide from the DAC devices 950 to be stored in a collection system 986, for example based on applying a vacuum to the DAC devices 950, heating the carbon capture material 972 (e.g., based on applying a flow of steam from a steam supply source 984 to the carbon capture material), or the like.

In further detail, and as shown in FIGS. 9B-9C, a DAC device 950 included in a DAC system 940 of a process assembly 100 may include a structure 956 defining an enclosure 950V with louvers 962 and 964 configured to selectively seal or open respective openings 966 and 968 of the enclosure 950V at the respective inlet and outlet sides 112 and 114 of the DAC device 950. The DAC device 950 may include a contactor device 971 (also referred to herein interchangeably as a contactor) within the enclosure 950V. The contactor device 971 may include a carbon capture material 972 and may be configured to enable an air flow 180 to flow over one or more surfaces of the carbon capture material 972 (e.g., based on flowing through the contactor device 971). The carbon capture material 972 may capture (e.g., absorb, adsorb, bind, etc.) carbon dioxide from an air flow 180 directed to flow through the enclosure 950V via the respective inlet and outlet sides 112 and 114 of the DAC device 950, where the air flow 180 through the enclosure 950V of the DAC device 950 may be generated by the wind turbine air mover assembly 120 as described herein. In some example embodiments, a DAC device 950 may be interchangeably referred to as a contactor assembly, a contactor apparatus, a contactor device, a contactor, or the like.

The carbon capture material 972 may include any known carbon capture materials which may be solid materials, liquid materials, or the like. As an example, a carbon capture material 972 in the enclosure 950V may include a sodium hydroxide material which may react with carbon dioxide in the air flow 180 passing through the enclosure 950V to precipitate sodium carbonate that may be subsequently heated to generate a carbon dioxide gas stream. In another example, the carbon capture material 972 may be a sorbent material, including for example a zeolite material (e.g., zeolite Ca-A), a metal-organic framework (MOF) material (e.g., Mg-MOF-74), a chemical adsorbent including for example an amine impregnated solid material (e.g., PEI-MIL-101), or the like, which may adsorb (e.g., bind) carbon dioxide from the air flow 180 and may release the bound carbon dioxide based on application of at least one of heat or vacuum to the carbon capture material 972.

In operation, the DAC device 950 may open the louvers 962 and 964 to expose the enclosure 950V and the carbon capture material 972 therein to the enclosure 100V and the ambient environment 190 via respective openings 966 and 968, and thereby expose the enclosure 950V to the air flow 180, for a first period of time. Upon elapse of the first period of time, the louvers 962 and 964 may close to isolate the enclosure 950V and the carbon capture material 972 therein from the enclosure 100V and the ambient environment 190, and thereby isolate the enclosure 950V from the air flow 180. The DAC facility 900 may include (e.g., as part of the DAC system 940 or external to the DAC system 940) a vacuum generator 982 configured to evacuate (e.g., remove air from) the isolated enclosure 950V to generate a vacuum within the enclosure 950V (which is not limited to an absolute vacuum and may include a reduction of pressure within the enclosure 950V relative to the ambient environment 190). The DAC facility 900 may include (e.g., as part of the DAC system 940 or external to the DAC system 940) a heat source, such as a steam supply source 984 that may be configured to supply a flow of steam (e.g., low temperature steam, e.g., at 120 C) to the isolated enclosure 950V (e.g., concurrently with the enclosure 950V being in vacuum based on operation of the vacuum generator 982), such that the carbon capture material 972 in the isolated enclosure 950V may be exposed to at least one of vacuum or heat from the applied steam, which may cause the carbon capture material 972 to release carbon dioxide which may be directed through one or more conduits to a collection system 986 (e.g., a gas storage container to store the carbon dioxide, a compressor to compress the carbon dioxide gas to a higher pressure and to store the compressed carbon dioxide gas in the gas storage container at the higher pressure, or any combination thereof).

While the DAC facility 900 and DAC system 940 shown in FIGS. 9A-9C are configured to heat the carbon capture material 972 based on providing steam to enclosure 950V including the carbon capture material 972, example embodiments are not limited thereto. For example, the DAC facility 900 and DAC system 940 may omit a steam supply source 984 and may include one or more heating elements (e.g., a solid state electrical resistance heater) that may be coupled to the carbon capture material 972 in one or more DAC devices 950 and may be electrically coupled to the control system 150, where the control system 150 may controllably activate the one or more heating elements to heat the carbon capture material 972 of one or more DAC devices 950, for example concurrently with controlling the vacuum generator 982 to at least partially evacuate the enclosure 950V that includes the carbon capture material 972, opening a conduit from the enclosure 950V to the collection system 986, operating one or more louvers to seal the enclosure 950V, or the like in order to cause the carbon capture material 972 to release carbon dioxide which may be directed through one or more conduits to a collection system 986 without applying steam to heat the carbon capture material 972.

Still referring to FIGS. 9A-9C, a process assembly 100 that implements a DAC system 940 based on including one or more DAC devices 950 together with a wind turbine air mover assembly 120 that includes a wind turbine rotor assembly 130 in a vertical axis configuration may utilize the highly aerodynamically efficient rotor blades 134 of the wind turbine rotor assembly to move very large volumes of air comprising the air flow 180 to convert the wind turbine rotor assembly 130 into a highly efficient high volume low pressure (HVLP) fan, but on a massive scale. As described herein, the wind turbine rotor assembly 130 may use a wind turbine rotor assembly corresponding to a standard onshore wind turbine design configuration with approximate 750 kW-1.5 MW rated output and a 50-70 meters approximate rotor diameter.

As shown in FIGS. 9B and 9C, the process assembly 100 including the wind turbine air mover assembly 120 and one or more process devices 110 that include one or more DAC devices 950 may generate the air flow 180 and direct the air flow 180 to a discharge chamber 960 (also referred to as a discharge area, discharge enclosure, discharge ring, discharge plenum, etc.). As shown in FIG. 9B, the discharge chamber 960 may be surrounded by a plurality of DAC devices 950 also forming a circumferential ring where all of the air flow 180 may be forced to exit the process assembly 100 via flowing through the DAC devices 950 so that carbon capture material 972 in the DAC devices 950 may remove carbon dioxide from the air flow 180. Referring to at least FIGS. 2A and 9B, the end of each process device 110 (e.g., outlet side 114 of the DAC devices 950 as shown in FIG. 9B) facing into the enclosure 100V may be flush or substantially flush (e.g., coplanar or substantially coplanar) with the inner surface 102S of the cylindrical shroud structure 102, but example embodiments are not limited thereto, and any end (e.g., inlet side 112 and/or outlet side 114) of one or more process devices 110 (e.g., DAC devices 950 as shown in FIG. 9B) may be offset from and/or flush or substantially flush with one or more surfaces of the cylindrical shroud structure 102 (e.g., the inner surface 102S and/or an outer surface of the cylindrical shroud structure 102).

The air flow volume (e.g., the air flow 180) generated by the wind turbine air mover assembly 120 that includes a wind turbine rotor assembly 130 in the vertical axis configuration may be therefore directed into a contactor device 971 which may contain a carbon capture material 972 (e.g., a sorbent material) configured to preferentially capture (e.g., adsorb) carbon dioxide from the air flow 180 flowing over at least a portion of the carbon capture material 972 (e.g., one or more exposed surfaces thereof). When capturing carbon dioxide from the air flow 180 via a sorbent carbon capture material 972, a DAC device 950 may be operated in ‘adsorption mode’ where the louvers 962 and 964 are open to expose the enclosure 950V to the air flow 180 via openings 966 and 968. To extract carbon dioxide from a DAC device 950 into a collection system 986, the DAC device 950 may be operated in a ‘desorption mode’ wherein the DAC device 950 may be sealed individually at its respective inlet and outlet sides 112 and 114 based on causing the louvers 962 and 964 to close. When a DAC device 950 is sealed (e.g., isolated from the air flow 180), the enclosure 950V may be partially or entirely evacuated of air by the vacuum generator 982 such that a vacuum may be generated based on operation of the vacuum generator 982 (e.g., vacuum pump, which may be any known vacuum pump). The carbon capture material 972 may then be heated with low temperature steam (e.g., approximately 120C) provided from a steam supply source 984 (e.g., any known water boiler, steam generator, or the like). The carbon capture material 972 may release the captured carbon dioxide based on being exposed to the vacuum and being heated by the steam, and the released carbon dioxide gas may be directed to a collection system 986 via one or more conduits extending into the enclosure independently of the openings 966 and 968 at the inlet and outlet sides 112 and 114 that may be sealed by the louvers 962 and 964. After the carbon dioxide is released, the openings at the inlet and outlet sides 112 and 114 may be unsealed based on causing the louvers 962 and 964 to open, and the adsorption process may repeat.

The DAC facility 900 may cause the air flow 180 to not enter DAC devices 950 which are operating in desorption mode (e.g., based on controlling the louvers 962 and 964 of those DAC devices 950 operating in desorption mode to be closed) but rather may passively redirect the air flow 180 into DAC devices 950 which are operating in adsorption mode (e.g., based on controlling the louvers 962 and 964 of those DAC devices 950 operating in adsorption mode to be open). The DAC facility 900 may thus operate the DAC system 940 to simultaneously operate some DAC devices 950 in absorption mode and other DAC devices 950 in desorption mode and may continuously switch some DAC devices 950 between absorption mode and desorption mode (e.g., in a staggered sequence) to maintain a continuous absorption flow area through which the air flow 180 may be directed and to maintain a continuous capture of carbon dioxide from the air flow 180 in the DAC devices 950 that are in absorption mode and a continuous release of carbon dioxide to the collection system 986 from the DAC devices 950 that are in desorption mode.

Still referring to FIGS. 9A-9C, application of a wind turbine rotor assembly 130 of the wind turbine air mover assembly 120 as an air mover (e.g., a fan) to move large amounts of air with a low pressure impact may take advantage of a wind turbine rotor assembly's potential to move these large volumes/masses of air at relatively low speed and low pressure which ideally matches the needs for DAC modules for low-speed, low-pressure air flow 180 passing through the enclosures 950V of the DAC devices 950 to facilitate efficient and high-effectiveness capture of carbon dioxide from the air flow 180. Using a wind turbine rotor assembly 130 that corresponds to a standard onshore wind turbine rotor and hub design in the wind turbine air mover assembly 120 for a DAC system 940 may significantly reduce the initial cost of the DAC system 940, power consumption of the DAC system 940, number of units (e.g., quantity of DAC systems 940, quantity of air mover assemblies) requirements as well as the broadband noise generated by the DAC system 940 while achieving improved or maximum aerodynamic efficiency of the wind turbine air mover assembly 120 of the DAC system 940 based on the aerodynamic efficiency, reduced weight, reduced noise, and the like associated with the DAC system 940 including a wind turbine air mover assembly 120 that includes a wind turbine rotor assembly 130 as described herein, having the distinctive structural and/or operational characteristics as described herein to provide such improvements, instead of a set of one or more conventional air movers (e.g., conventional axial fans). Power consumption by the process assembly 100 to generate and maintain a certain amount (e.g., volumetric flow rate) of air flow 180 may be reduced based on including an air mover that includes the wind turbine air mover assembly 120. The entire wind turbine air mover assembly 120 may be enclosed with a shroud structure 102 which aids in improving aerodynamic efficiency further and additional noise reduction. In a cross-wind configuration, the average wind & turbulence at the wind turbine air mover assembly 120 intake may be reduced or negligible, causing significant reduction in the turbulent fatigue damage loads increasing wind turbine rotor assembly 130 life. Any induced air turbulence produced in the air flow discharge from the wind turbine rotor assembly 130 could add potential benefits to the DAC device 950 performance. However, if after detailed analysis any induced turbulence or flow pulsation due to resonance is determined to be undesirable, it can be mitigated by adding “helical strakes” 700 as shown in FIG. 7 around the shroud structure 102 (e.g., diffuser).

Still referring to FIGS. 9A-9C, conventional vane-axial fans may be the state-of-the-art fans used in DAC systems 940. For a ˜1M mt/year carbon dioxide capture DAC facility 900, approximately 2,500-3,000 of these ˜15 kW fans may be used to induce sufficient air flow 180 to facilitate 1M mt/year of carbon dioxide capture from the air flow 180. Each conventional vane-axial fan may either serve a group of DAC devices 950 or individual DAC devices 950, each integrated into the control system for each module and served by its own motor and typical belt drive system. Significant capital costs may be required to purchase fans and install such fans along with electrical wiring and control systems and their associated cabling. Furthermore, this large quantity of fans may be extremely noisy and require large amounts of power to drive air flow to the DAC unit stacks. Due to their noise levels, large DAC systems 940 and/or the DAC facility 900 may need to be located approximately 1-2 miles or more away from neighbors. Additionally, the large quantity of conventional vane-axial fans may pose additional maintenance cost to the DAC system 940. Additionally each fan system requires individual periodic maintenance and expected repairs/replacement of each of the subcomponents. This maintenance stands in high contrast to the wind turbine air mover assembly which is expected to require minimal maintenance (both in contrast to a state-of-the-art horizontal axis wind turbine or the plurality of vane-axial fans).

In some example embodiments, a DAC system 940 implemented by a process assembly 100 that includes a wind turbine air mover assembly 120 with a wind turbine rotor assembly 130 (e.g., a single, large rotor diameter rotor assembly) may be configured to be at least 20 dB quieter than the state-of-the-art fans for a same flow rate of air flow 180 through a DAC system 940 including one or more DAC devices 950 configured to capture a same amount of carbon dioxide, based at least in part upon the DAC system 940 using a wind turbine air mover assembly 120 providing noise reduction and aerodynamic efficiency benefits as described herein, thereby enabling significant reduction in setback of the DAC system 940 from neighbors to the facility for a same amount of noise generated by the DAC system 940 at said neighbors.

In some example embodiments, a footprint of the DAC facility 900 may be reduced based on the DAC facility 900 including a DAC system 940 implemented by a process assembly 100 that includes a wind turbine air mover assembly 120 with a wind turbine rotor assembly 130. The single group of DAC devices 950 supplied with an air flow 180 generated by a single wind turbine air mover assembly that includes a single wind turbine rotor assembly 130 may be more compact and may avoid being spread out to avoid recycling air from discharge to inlet of separate DAC devices 950.

In some example embodiments, a DAC system 940 implemented by a process assembly 100 that includes a wind turbine air mover assembly 120 with a wind turbine rotor assembly 130 may be configured to provide a very significant total power consumption reduction for the generation of the air flow 180 in relation to a DAC system configured to generate a similar magnitude of air flow 180 with conventional fans (conventional air mover assemblies), where such total power consumption reduction may be more than 90 percent, resulting in significant operation cost reduction of the DAC system 940 and thus of the DAC facility 900, thereby improving operational efficiency of the DAC system 940 and of the DAC facility 900. In some example embodiments, a DAC system 940 implemented by a process assembly 100 that includes a wind turbine air mover assembly 120 with a wind turbine rotor assembly 130 may be configured to generate significantly less noise, especially broadband noise which is particularly undesirable, than in relation to a DAC system configured to generate a similar magnitude of air flow 180 with conventional fans (e.g., conventional fan air mover assemblies). In some example embodiments, a DAC system 940 implemented by a process assembly 100 that includes a wind turbine air mover assembly 120 with a wind turbine rotor assembly 130 may be configured to significantly reduce the CAPEX (e.g., greater than 50% to 75% CAPEX reduction), reduce the O&M costs, and reduce the operating power costs for a DAC system than in relation to a DAC system configured to generate a similar magnitude of air flow 180 with conventional fans, enabling a more competitive DAC cost of carbon dioxide captured. The captured carbon dioxide and its value are very much commoditized when carbon dioxide pressure and purity are equal; therefore, any reduction in cost equals a direct potential increase in profit for a DAC system 940.

In addition, a DAC system 940 including a wind turbine air mover assembly 120 which includes a wind turbine rotor assembly 130 in a vertical axis configuration, as shown in at least FIGS. 9B and 9C, may enable a significantly lower overall height of the DAC system 940 (e.g., 12-15 meters overall height from the bottom to the top of the shroud structure 102)—versus a 70-90 meters overall height needed if the DAC system 940 were utilizing conventional horizontal axis wind turbines. The horizontal plane of the wind turbine rotor assembly 130 may enable a DAC system 940 that is much lower to the foundation structure 104 (e.g., the ground)—providing much lower support structure, installation and maintenance costs but also lower visibility from neighbors and more siting flexibility of the DAC system 940 (and of the DAC facility 900).

The DAC system process assembly shown in FIG. 9B corresponds to the process assembly 100 shown in FIG. 2A where the one or more process devices 110 shown in FIG. 2A include one or more DAC devices 950 (e.g., at least two DAC devices vertically stacked as shown in FIG. 9B). As shown in FIGS. 2A and 9B (and as also shown in FIG. 2D), the one or more process devices 110, and thus the one or more sets of DAC devices 950 (which as shown in FIG. 9B may include two or more vertically stacked DAC devices 950), may be arranged in a cylindrical arrangement (e.g., a cylindrical arrangement of DAC devices 950) around the circumference of the process assembly 100 and thus around the circumference of the enclosure 100V, similar to the arrangement of the one or more process devices 110 in the process assembly 100 shown in FIG. 2A.

Accordingly, as shown in FIG. 9B and as further shown in FIG. 9D (where FIG. 9B may be a cross-sectional view along view line IXB-IXB′ of the DAC system 940 shown in FIG. 9D), the DAC system 940 may include a circumferential plurality of DAC devices 950 (also referred to interchangeably as DAC modules, contactor modules, contactors, etc.) that each include a contactor device 971 having a carbon capture material 972 within an enclosure 950V and further including one or more openings 966 and/or 968 configured to be selectively opened or closed (e.g., by respective louvers 962 and/or 964) to selectively seal or open the enclosure 950V, wherein the circumferential plurality (also referred to herein interchangeably as a circumferential ring, circumferential arrangement, circumferential pattern, etc.) of DAC devices 950 as shown in FIGS. 9B and 9D at least partially define a circumference of a central enclosure space (e.g., discharge chamber 960 of the enclosure 100V in a plane (e.g., the horizontal plane in FIG. 9B, the plane of the image in FIG. 9D), at least one opening (e.g., opening 968 in FIGS. 9B, 9D) of each DAC device 950 facing into the central enclosure space (960, 100V), and where the wind turbine rotor assembly 130 of the wind turbine air mover assembly 120 at least partially overlaps the central enclosure space (960, 100V) in a direction extending perpendicular to the plane (e.g., vertically in FIG. 9B, out of the plane of the image in FIG. 9D), where such direction may be the same as or different from the direction of gravity G. While FIG. 9D illustrates the circumferential plurality of DAC devices 950 defining the entire circumference of at least a portion of the central enclosure (e.g., a lower level of the discharge chamber 960 as shown in FIG. 9B), example embodiments are not limited thereto. For example, at least some DAC devices 950 in a given circumferential plurality of DAC devices 950 (e.g., at a given level extending through a horizontal plane as shown in FIG. 9B) may be azimuthally spaced apart from each other around the circumference of the enclosure space, such that the circumferential plurality of DAC devices 950 may define a limited portion of the circumference. The DAC system 940 may include one or more structures (e.g., shroud structures) extending azimuthally between such spaced-apart DAC devices 950 to complete the circumference of the central enclosure space (960, 100V) and thus to partially or entirely prevent air flow from entering or exiting the central enclosure space in a radial direction without passing through one or more DAC devices (e.g., without passing between at least two azimuthally spaced-apart DAC devices 950.

As shown in at least FIG. 9B, two or more DAC devices 950 may be stacked on each other in the direction extending perpendicular to the plane of a given circumferential plurality of DAC devices 950 (where such direction may be the same as or different from the direction of gravity). Restated, the DAC system 940 may include multiple stacked circumferential pluralities of DAC devices 950, multiple “levels” of a circumferential plurality of DAC devices 950, or the like. Further restated, the DAC system 940 may include, in addition to a “first” circumferential plurality of DAC devices 950 (e.g., a first level of DAC devices) as described above, at least one additional “second” circumferential plurality of DAC devices 950 (e.g., a second level of DAC devices) extending circumferentially around at least a portion of the circumference of the central enclosure space (960, 100V) wherein at least one DAC device 950 of the second circumferential plurality of DAC devices may be stacked on at least one DAC device 950 of the first circumferential plurality of DAC devices in the direction extending perpendicular to the plane (e.g., the vertical direction in FIG. 9B, the direction extending out of the image of FIG. 9D, etc.).

The DAC system process assembly shown in FIG. 9C corresponds to the process assembly 100 shown in FIG. 2B where the one or more process devices 110 shown in FIG. 2B include one or more DAC devices 950. As shown in FIGS. 2B and 9C (and as also shown in FIG. 2C), the one or more process devices 110, and thus the one or more DAC devices 950, may be arranged in a planar arrangement (e.g., a planar arrangement of DAC devices 950) transversely across the internal enclosure 100V of the process assembly 100 at an elevated position above the bottom of the enclosure 100V (thereby defining a bottom air chamber 106B beneath the one or more process devices 110), similar to the arrangement of the one or more process devices 110 in the process assembly 100 shown in FIG. 2B.

Referring to FIG. 9D, in some example embodiments, a plurality of DAC systems 940 each including the wind turbine air mover assembly 120 according to some example embodiments and further including 520 DAC devices 950 (contactors), arranged in 5 levels and with two DAC modules per contactor, may require approximately (2) ˜265′ diameter cylinder shroud structures 102 to achieve a similar carbon capture potential as conventional DAC systems as shown for example in FIG. 9E, including for example 9 sets of 30 DAC devices 950. The footprint 970 estimated for the DAC systems 940 including the process assembly 100 according to some example embodiments, including a wind turbine air mover assembly 120, is approximately 442,000 square feet, or 10 acres, when providing at least a spacing of 972 (e.g., 98 feet) from the outer boundaries of the footprint and a space 974 (e.g., 234 feet) from each other. Such a footprint 970 of about 10 acres is an expected reduction of approximately 65% in relation to the conventional DAC system configuration footprint as shown in FIG. 9E, where conventional DAC systems 980 may be estimated to require approximately 22 acres or more of footprint 992. As a result, process assembly 100 that implements a DAC system 940 may be configured to enable reduced footprint (e.g., area) of the DAC system(s) providing equivalent carbon capture in relation to conventional DAC systems.

In some example embodiments, a process assembly 100, including the example embodiments shown in FIGS. 1-7, 8A-8D, and 9A-9D, include a wind turbine air mover assembly 120 with a wind turbine rotor assembly 130 in a vertical axis configuration, such that the central axis 130A extends parallel to the direction of gravity G and the wind turbine air mover assembly is configured to cause the air flow 180 in a vertical direction parallel to the direction of gravity through the wind turbine air mover assembly 120. However, example embodiments are not limited thereto. For example, the wind turbine air mover assembly 120 may be provided in various axis configurations which may be different from a vertical axis configuration, such that the central axis 130A of wind turbine rotor assembly 130 may extend at an angle to the direction of gravity that is greater than 0 degrees, and such that the wind turbine air mover assembly 120 may be configured to cause the air flow 180 to move in a direction through the wind turbine air mover assembly that is at an angle to the direction of gravity that is greater than 0 degrees (and which may be the same or different direction as the direction of the central axis 130A). In some example embodiments, a process assembly 100 may include a wind turbine air mover assembly 120 with a wind turbine rotor assembly 130 in a horizontal axis configuration, such that the central axis 130A extends perpendicular to the direction of gravity G and the wind turbine air mover assembly is configured to cause the air flow 180 in a horizontal direction perpendicular to the direction of gravity G through the wind turbine air mover assembly 120. The process assembly 100 may include various support structures 140, 142, or the like to position the one or more process devices 110, shroud structures 102, or the like according to the axis configuration (e.g., the central axis 130A) of the wind turbine air mover assembly 120 to enable the wind turbine air mover assembly 120 to cause the air flow 180 to flow over at least a portion of the process device(s) 110 based on causing the air flow 180 to move in the particular direction through the wind turbine air mover assembly 120, so that the process device(s) may perform a process (e.g., heat transfer to the air flow, carbon capture from the air flow, etc.) based on the air flow over at least the portion of the process device(s). Additionally, the “vertical direction” as described herein may, in some example embodiments, be a “particular direction” that is a direction in which the wind turbine air mover assembly 120 is configured to direct air flow 180 through the wind turbine air mover assembly 120, wherein the “particular direction” may be a direction that is parallel to the central axis 130A of the wind turbine rotor assembly 130. Accordingly, the “vertical direction” as described herein with regard to some example embodiments may, in some example embodiments, be a particular direction extending parallel to the central axis 130A and which may be different from a direction extending parallel to the direction of gravity G.

While example embodiments are described herein with regard to “wind turbine” air mover assemblies 120 that each include a “wind turbine” rotor assembly 130 including a plurality of wind turbine rotor blades 134, example embodiments are not limited thereto. For example, in some example embodiments, a process assembly 100 may include an air mover assembly that is configured to cause an air flow to flow over at least a portion of a process device (e.g., a heat exchanger, a DAC device, or any combination thereof) based on causing the air flow to move in a particular direction through the air mover assembly, where the air mover assembly includes a rotor assembly mechanically coupled to a drive motor and configured to rotate around a central axis based on operation of the drive motor, the rotor assembly including a plurality of rotor blades extending radially from a rotor hub, where the rotor assembly and rotor blades thereof may be different from a wind turbine rotor assembly 130 and/or wind turbine rotor blades 134, such that the rotor assembly 130 may be referred to as a “non-wind turbine” rotor assembly and thus the rotor blades 134 may be referred to as “non-wind turbine” rotor blades, and the air mover assembly 120 may be referred to as a “non-wind turbine” air mover assembly. For example, the rotor assembly may be a fan rotor assembly having fan rotor blades that are different from “wind turbine” rotor blades. Such a fan rotor assembly may include, for example, a vane-axial rotor assembly, an HVLS rotor assembly, any combination thereof, or the like. Such a fan rotor assembly may include fan rotor blades that omit one or more of: any root section, any variation of profile thickness to profile chord along the span of the rotor blades, any variation in twist angle along the span of the rotor blades, or any composite materials. For example, a fan rotor assembly of an air mover assembly (thus referred to as a fan air mover assembly) may include fan rotor blades (e.g., vane-axial fan blades, HVLS fan blades, etc.) which may be rotor blades including a metal (e.g., aluminum) casting structure and/or solid interior, a non-twist blade body shape, a non-root rotor blade lacking a cylindrical or substantially cylindrical root section, any combination thereof, or the like. A fan air mover assembly may include an “upscaled” fan rotor assembly that corresponds to a reference fan rotor assembly (e.g., a reference vane-axial and/or HVLS fan rotor assembly) having a rotor diameter that is upscaled according to one or more fan affinity laws as described herein.

Accordingly, it will be understood that any of the descriptions of any of the process assemblies 100 according to any of the example embodiments, including any of the process assemblies 100 shown in any of FIGS. 1-7, 8A-8E, and/or 9A-9E, including at least one process device 110 and a “wind turbine” air mover assembly 120 including a “wind turbine” rotor assembly 130 having a plurality of “wind turbine” rotor blades 134, may apply equally to example embodiments of one or more process assemblies 100 including at least one process device and an air mover assembly including a rotor assembly that may be different from a wind turbine rotor assembly (e.g., a non-wind turbine rotor assembly), including for example a fan rotor assembly (e.g., vane axial rotor assembly, HVLS rotor assembly, etc.). For example, the wind turbine air mover assembly 120 as shown in any of FIGS. 1-7, 8A-8E, and/or 9A-9E and described according to any of the example embodiments may be replaced, in a process assembly 100 according to any of the example embodiments, with an air mover assembly (e.g., a non-wind turbine air mover assembly, for example a fan air mover assembly) including a rotor assembly (e.g., a non-wind turbine rotor assembly, for example a fan rotor assembly) including a plurality of rotor blades (e.g., a plurality of non-wind turbine rotor blades, for example fan rotor blades) that may omit one or more of: any root section, any variation of profile thickness to profile chord along the span of the rotor blades, any variation in twist angle along the span of the rotor blades, or any composite materials.

For example, referring to FIGS. 9B and 9D, in some example embodiments, a DAC system 940 may include a circumferential plurality of DAC devices 950, where each DAC device 950 of the circumferential plurality of DAC devices 950 includes a contactor device 971 having a carbon capture material 972 within an enclosure 950V and further including one or more openings 966 and/or 968 configured to be selectively opened or closed (e.g., by louvers 962 and/or 964) to selectively seal or open the enclosure 950V, where the circumferential plurality of DAC devices 950 at least partially define a circumference of a central enclosure space (e.g., 960, 100V) in a plane, at least one opening (e.g., 968) of each DAC device 950 facing into the central enclosure space (e.g., 960, 100V), and wherein the DAC system 940 further includes an air mover assembly 120 configured to cause an air flow 180 to flow over at least a portion of a contactor device 971 of one or more of the DAC devices 950 based on causing the air flow 180 to move in a particular direction through the air mover assembly, the air mover assembly including a rotor assembly 130 at least partially overlapping the central enclosure space (e.g., 960, 100V) in an axial direction extending perpendicular to the plane. In such example embodiments, the air mover assembly 120 may be a fan air mover assembly having a fan rotor assembly that includes a plurality of fan rotor blades. Such a fan air mover assembly may be referred to as a “fan,” an industrial fan, or the like. Such a fan air mover assembly may include a vane-axial fan, an HVLS fan, or the like, and thus the fan air mover assembly may include a vane-axial fan rotor assembly, an HVLS fan rotor assembly, or the like, respectively.

In some example embodiments, even with a fan air mover assembly, a process assembly, such as a DAC system 940 as shown in FIGS. 9B and 9D, may provide improvements over conventional corresponding process assemblies (e.g., conventional DAC systems and facilities including same). For example, as shown in FIG. 9D, a DAC system 940 including an air mover assembly 120 including a rotor assembly 130 at least partially overlapping the central enclosure space (e.g., 960, 100V) that is at least partially circumferentially surrounded by DAC devices 950 such that a single air mover assembly 120 generates air flow that moves radially between the central enclosure space and one or more of the DAC devices 950 and further moves in a direction perpendicular to the plane in which a circumferential pattern of the DAC deices 950 is located may provide a DAC system having a reduced footprint (e.g., area) of the DAC system(s) providing equivalent carbon capture in relation to conventional DAC systems and may further provide power consumption reduction per unit (e.g., cubic foot, kg, etc.) of carbon dioxide captured from the ambient air by the DAC system in relation to conventional DAC system, even if the air mover assembly of the DAC system is a fan air mover assembly (e.g., an upscaled HVLS, vane-axial, or other type of fan) instead of a wind turbine air mover assembly and thus includes a fan rotor assembly (e.g., an upscaled HVLS, vane-axial, or other type of fan, for example having a rotor diameter of 20-50 meters) instead of a wind turbine rotor assembly. Such an air mover assembly and/or rotor assembly may include one or more mid-span or tip supports of the rotor blades thereof, which may be applied to the rotor blades from an exterior of the rotor blades and separately from the connections between the rotor blades and the rotor hub of the fan rotor assembly, to mitigate sag and/or bending of the rotor blades of the air mover assembly. Such a DAC system 940 may provide a large amount of generated air flow to facilitate carbon capture without requiring constructing additional air mover assemblies, or at least based on requiring fewer air mover assemblies than would be required for upscaled industrial fan air mover assembly designs (e.g., vane-axial, HVLS, etc.) to generate the same amount of air flow, thereby enabling reduced capital expenditures (e.g., due to reduced quantity of air mover assemblies and reduced corresponding support structure, shroud structure, reduced land purchase/leasing requirements, etc.) without compromising generated air flow. Such a DAC system 940, may incorporate a very large single rotor assembly (e.g., a very large fan) serving multiple modules thereby unexpectedly achieving significantly higher efficiency in both electrical consumption and capital expenditure (CAPEX) due to the tighter, more compact design that is enabled by the single-fan (e.g., single rotor) configuration. A practical and/or manufacturable single rotor assembly (e.g., a single fan) was not previously feasible to DAC or dry cooling tower designers. For example, a cylindrical multi-module dry cooling tower with a plurality of fans on top of a chimney is not known to be widely adopted in favor or multiple separated modules with individual fans for likely reasons of maintainability of the fans, cost of the structure, etc. However, a process assembly having a single rotor assembly unexpectedly solves these challenges and enables a cost efficient solution for both power consumption and CAPEX.

Such a DAC system 940 may include a cylindrical shroud structure 102 according to any of the example embodiments, including a shroud structure that at least partially circumferentially surrounds the central enclosure space (e.g., 960, 100V) as shown in FIGS. 9B and 9D, wherein the cylindrical shroud structure is to the air mover assembly (e.g., as shown in at least FIGS. 2A and 9B with regard to cylindrical shroud 102, air mover assembly 120, and structural supports 140), such that the cylindrical shroud structure 102 is configured to at least partially structurally support a weight of the rotor assembly (e.g., fan rotor assembly) of the air mover assembly (e.g., fan air mover assembly) at least partially overlapping the central enclosure space (e.g., 960, 100V) in the axial direction that may be perpendicular to the plane in which a circumferential pattern of DAC devices 950 of the DAC system 940 are located. Accordingly, as shown in at least FIGS. 2A and 9B, the cylindrical shroud structure 102 may provide a novel self-support for the air mover assembly of the DAC system 940 as the cylindrical shroud structure 102 may be the support structure for the structure supporting the entire weight (e.g., structural load) of the air mover assembly, even if the air mover assembly of the DAC system 940 and which is structurally supported by the cylindrical shroud structure 102 is a fan air mover assembly (e.g., an upscaled HVLS, vane-axial, or other type of fan) instead of a wind turbine air mover assembly and thus includes a fan rotor assembly (e.g., an upscaled HVLS, vane-axial, or other type of fan, for example having a rotor diameter of 20-50 meters) instead of a wind turbine rotor assembly. Accordingly, in some example embodiments, the cylindrical shroud structure 102 may be understood to be a load-bearing structure with regard to at least the rotor assembly 130.

It will be understood that the term “air mover assembly” may refer to an air mover assembly according to any of the example embodiments, including a wind turbine air mover assembly or a non-wind turbine air mover assembly (which may include a fan air mover assembly). It will be understood that the term “rotor assembly” may refer to a rotor assembly according to any of the example embodiments, including a wind turbine rotor assembly or a non-wind turbine rotor assembly (which may include a fan rotor assembly). It will be understood that the term “rotor blade” may include a rotor blade according to any of the example embodiments, including a wind turbine rotor blade or a non-wind turbine rotor blade, (which may include a fan rotor blade).

FIG. 10 is a flowchart illustrating a method for operating a process assembly, according to some example embodiments. The process assembly operated in FIG. 10 may be the process assembly 100 according to any of the example embodiments. The method shown in FIG. 10 may be performed based on operate a control system of the process assembly according to any of the example embodiments (e.g., control system 150), for example, based on a processor of the control system executing a program of instructions stored at a memory of the control system.

At S902, a wind turbine rotor assembly of a wind turbine air mover assembly of the process assembly is caused to rotate, based on operating a drive motor of the wind turbine air mover assembly (e.g., based on controlling a supply of electrical power to the drive motor) to cause the wind turbine rotor assembly of the wind turbine air mover assembly to rotate around the central axis thereof (which may be parallel to the direction of gravity), to cause an air flow to move vertically through the wind turbine rotor assembly, parallel to the central axis and to further move over one or more surfaces of one or more process devices of the process assembly (and/or through the one or more process devices). The one or more process devices may each be any process device according to any of the example embodiments, including for example a heat exchanger configured to discharge (e.g., transfer) heat to the air flow, a DAC module configured to capture carbon dioxide from the air flow, or any combination thereof.

At S910, one or more process devices of the process assembly are operated to perform a process based on the air flow over one or more surfaces of one or more process devices of the process assembly (and/or through the one or more process devices). At S920, where the one or more process devices includes a heat exchanger, the operating at S910 may include operating the heat exchanger to reject (e.g., transfer) heat to the air flow. In some example embodiments, where the heat exchanger is configured to circulate a working fluid therethrough, the operating at S920 may include, at S922, circulating the working fluid through the heat exchanger (e.g., through one or more tubes) to cause the heat exchanger to transfer heat from the working fluid to the air flow flowing over one or more surfaces of the tube(s) and/or one or more structures (e.g., fins) coupled to the tube(s).

At S930, where the one or more process devices includes a DAC device, the operation at S910 may include switching the DAC device between operating in an absorption mode to capture (e.g., adsorb) carbon dioxide from the air flow and a desorption mode to release the captured carbon dioxide to a collection system. In particular, at S932 the DAC device may be operated in an absorption mode where a carbon capture material of the DAC module is exposed to the air flow generated by the wind turbine air mover assembly (e.g., based on controlling one or more louvers of the DAC device to open an enclosure containing the carbon capture material to a chamber through which the wind turbine air mover assembly causes the air flow to pass) so that the carbon capture material is exposed to the air flow and is thus may capture (e.g., adsorb) carbon dioxide from the air flow based on the air flow passing over one or more surfaces of the carbon capture material. The DAC device may be maintained in the adsorption mode at S932 for a particular first time period (e.g. 60 minutes). At S934, the DAC device may be operated in a desorption mode where the carbon capture material is isolated from the air flow (e.g., based on controlling the one or more louvers to close to isolate the enclosure of the DAC device from the air flow) and where the carbon capture material may be further exposed to a vacuum (e.g., based on operating a vacuum generator to evacuate the enclosure of the DAC device containing the carbon capture material) and/or to heat (e.g., based on operating a steam supply source to apply a low-temperature steam, such as steam at a temperature of 120C, to flow through the isolated enclosure containing the carbon capture material) to cause the carbon capture material to release the captured carbon dioxide as a gas. The DAC device may be isolated from the air flow and subsequently exposed to heat and/or vacuum to cause the carbon capture material to release the carbon dioxide gas. At S936, the released carbon dioxide gas may be directed to a collection system to be stored (e.g., in a storage container). The operations at S934 and S936 may be performed at least partially concurrently for a particular second period of time which may be the same or different as the first period of time (e.g., 60 minutes). As further shown, the operation at S930 may revert from S936 to S932 wherein the DAC module returns to the absorption mode to be exposed to the air flow (e.g., based on causing the louvers to open again) to capture additional carbon dioxide from the air flow (e.g., in response to the elapsed of the particular second period of time).

While some example embodiments of the process assembly may include a process device that includes either one or more heat exchangers or one or more DAC modules, it will be understood that example embodiments are not limited thereto. For example, a process assembly may include both one or more heat exchangers configured to discharge heat from a working fluid to at least a portion of the air flow generated by the air mover assembly and one or more DAC modules configured to capture carbon dioxide to at least a portion of the air flow generated by the air mover assembly. As a result, in some example embodiments, the operation at S910 may include both operations S920 and S930.

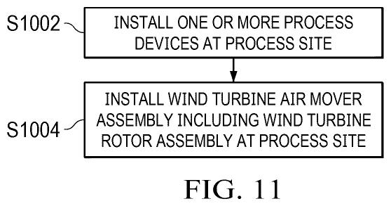

FIG. 11 is a flowchart illustrating a method for constructing a facility that includes a process assembly, according to some example embodiments. The facility may include any facility that may include a process assembly according to any of the example embodiments, including for example the nuclear power plant 800 shown in FIG. 8A, the DAC facility 900 shown in FIG. 9A, or any combination thereof.

At S1002, one or more process devices (e.g., one or more process devices 110) is installed at a process site. The process device may be a device configured to perform a process (e.g., an industrial process) based on an air flow being directed to flow over one or more surfaces of the process device and/or through at least a portion of the process device. The process device may include at least one of a heat exchanger configured to reject heat from a working fluid into an air flow as described herein, a direct air capture (DAC) device configured to capture carbon dioxide from an air flow, or any combination thereof. A heat exchanger that may be included in a process device, as described herein, may include any known closed-loop or open-loop heat exchanger, including for example a finned tube heat exchanger, a plate fin heat exchanger, a shell and tube heat exchanger, a phase change heat exchanger, a direct contact heat exchanger, any combination thereof, or the like. A DAC device that may be included in a process device, as described herein, may include any known DAC module, DAC device, DAC system, or the like, including DAC devices that utilize a solvent to absorb carbon dioxide from an air flow or utilize a sorbent to bind carbon dioxide from and air flow. The installation at S1002 may include forming a foundation support (e.g., foundation structure 104), installing a shroud structure (e.g., shroud structure 102) on the foundation, installing one or more process devices on the foundation support, mounting one or more process devices 110 on one or more support structures (e.g., one or more support structures 142) in an enclosure 100V at least partially defined by the shroud structure, coupling one or more helical strakes to an inner surface of the shroud structure, or any combination thereof.

At S1004, a wind turbine air mover assembly (e.g., wind turbine air mover assembly 120 according to any of the example embodiments) is installed at the process site to configure the wind turbine air mover assembly to generate an air flow to flow over one or more surfaces of the one or more process devices (and/or through the one or more process devices) based on causing at least a portion of the air flow to move vertically through the wind turbine air mover assembly. The wind turbine air mover assembly may include a wind turbine rotor assembly (e.g., wind turbine rotor assembly 130) according to any of the example embodiments. The wind turbine rotor assembly may be mechanically coupled to a drive motor (e.g., directly or via a gearbox) and configured to rotate around a central axis based on operation of the drive motor. The wind turbine rotor assembly may include a plurality of rotor blades extending radially from a central rotor hub. The central axis may extend parallel to a direction of gravity such that the plurality of rotor blades are in a horizontal plane extending perpendicular to the direction of gravity and further such that the wind turbine rotor assembly is configured to cause the air flow to move vertically through the wind turbine rotor assembly, parallel to the central axis, based on operation of the drive motor. The installing at S1004 may include coupling the wind turbine air mover assembly to the shroud structure of the process assembly via coupling the wind turbine air mover assembly to one or more support structures (e.g., one or more support structures 140), such that the structural load (e.g., weight) of the wind turbine air mover assembly is supported entirely by the one or more support structures which transfer the entire weight of the wind turbine air mover assembly to a foundation (e.g., directly or via an intermediate one or more support structures, including the shroud structure, one or more process devices, or the like.

The installing at S1004 may include communicatively coupling the air mover assembly to a control system (e.g., control system 150). In some example embodiments, the installing of the process devices at S1004 may include coupling the process device to another part of a facility. For example, in example embodiments where the process device includes a heat exchanger configured to circulate a working fluid therein to reject heat from the working fluid to an air flow, the installing at S1004 may include coupling respective inlet and outlet conduits of the heat exchanger to hot and cold working fluid conduits, respectively, of a coolant circuit of the facility (e.g., as described with reference to FIGS. 8A-8C). In another example, in example embodiments where the process device includes a DAC device, the installing at S1004 may include coupling the DAC device to a steam supply source, a vacuum generator, and a collection system as described with reference to FIGS. 9A-9C.

While a number of example embodiments have been disclosed herein, it should be understood that other variations may be possible. Such variations are not to be regarded as a departure from the spirit and scope of the present disclosure, and all such modifications as would be obvious to one skilled in the art are intended to be included within the scope of the following claims. In addition, while processes have been disclosed herein, it should be understood that the described elements of the processes may be implemented in different orders, using different selections of elements, some combination thereof, etc. For example, some example embodiments of the disclosed processes may be implemented using fewer elements than that of the illustrated and described processes, and some example embodiments of the disclosed processes may be implemented using more elements than that of the illustrated and described processes.

1. A process assembly, comprising:
a process device configured to perform a process based on an air flow over at least a portion of the process device, the process device including at least one of
a heat exchanger configured to transfer heat from a working fluid into the air flow, or
a direct air capture (DAC) device configured to capture carbon dioxide from the air flow; and
a wind turbine air mover assembly configured to cause the air flow to flow over the portion of the process device based on causing the air flow to move in a particular direction through the wind turbine air mover assembly, the wind turbine air mover assembly including a wind turbine rotor assembly, the wind turbine rotor assembly mechanically coupled to a drive motor and configured to rotate around a central axis based on operation of the drive motor, the wind turbine rotor assembly including a plurality of wind turbine rotor blades extending radially from a rotor hub,
wherein each wind turbine rotor blade of the plurality of wind turbine rotor blades includes a body structure defining
a root section that extends along a first span portion of the wind turbine rotor blade, the root section having a cylindrical shape,
an airfoil section that extends along a second span portion of the wind turbine rotor blade to a tip of the wind turbine rotor blade, each cross-sectional profile of the airfoil section having an airfoil profile chord and a profile thickness perpendicular to the airfoil profile chord, a ratio between the airfoil profile chord and the profile thickness varying along at least a first portion of the second span portion, and
a twist angle between the airfoil profile chord and a root profile chord of the root section, the twist angle varying along at least a second portion of the second span portion.

2. The process assembly of claim 1, wherein the root section has a circular cylindrical shape.

3. The process assembly of claim 1, wherein the wind turbine rotor assembly has a rotor diameter that is equal to or greater than 50 meters.

4. The process assembly of claim 1, wherein
the particular direction is a vertical direction extending parallel to a direction of gravity, and
the central axis of the wind turbine rotor assembly extends parallel to the direction of gravity.

5. The process assembly of claim 1, wherein the body structure of each wind turbine rotor blade defines an enclosure within an interior of the wind turbine rotor blade.

6. The process assembly of claim 1, wherein the wind turbine rotor assembly is between the process device and an air outlet of the process assembly, such that the wind turbine rotor assembly is configured to induce the air flow through the process device based on drawing the air flow through the process device and further forcing the drawn air flow through the air outlet.

7. The process assembly of claim 6, wherein the wind turbine rotor assembly is at least partially above the process device in the particular direction, such that the wind turbine rotor assembly is configured to draw the air flow upwards through the wind turbine rotor assembly and at least partially opposite the direction of gravity.

8. The process assembly of claim 6, wherein the wind turbine rotor assembly is at least partially beneath the process device in the particular direction, such that the wind turbine rotor assembly is configured to draw the air flow downwards through the wind turbine rotor assembly and at least partially in the direction of gravity.

9. The process assembly of claim 1, wherein the wind turbine rotor assembly is between the process device and an air inlet of the process assembly, such that the wind turbine rotor assembly is configured to force the air flow toward the process device based on drawing the air flow through the air inlet and further forcing the drawn air flow toward the process device.

10. The process assembly of claim 9, wherein the wind turbine rotor assembly is at least partially above the process device in the particular direction, such that the wind turbine rotor assembly is configured to force the air flow downwards through the wind turbine rotor assembly and at least partially in the direction of gravity.

11. The process assembly of claim 9, wherein the wind turbine rotor assembly is at least partially beneath the process device in the particular direction, such that the wind turbine rotor assembly is configured to force the air flow upwards through the wind turbine rotor assembly and at least partially opposite the direction of gravity.

12. The process assembly of claim 1, wherein the process assembly is a DAC system, comprising:
a circumferential plurality of DAC devices including the process device, the process device being the DAC device, each DAC device of the circumferential plurality of DAC devices including a contactor having a carbon capture material within an enclosure and further including one or more openings configured to be selectively opened or closed to selectively seal or open the enclosure,
wherein the circumferential plurality of DAC devices at least partially define a circumference of a central enclosure space in a plane, at least one opening of each DAC device facing into the central enclosure space, the wind turbine rotor assembly of the wind turbine air mover assembly at least partially overlapping the central enclosure space in a direction extending perpendicular to the plane.

13. The process assembly of claim 12, wherein the DAC system includes at least one additional circumferential plurality of DAC devices extending circumferentially around at least a portion of the circumference of the central enclosure, at least one DAC device of the additional circumferential plurality of DAC devices stacked on at least one DAC device of the circumferential plurality of DAC devices in the direction extending perpendicular to the plane.

14. A direct air capture (DAC) facility, comprising:
the DAC system of claim 12;
a vacuum generator configured to at least partially evacuate one or more enclosures of the circumferential plurality of DAC devices; and
a heat source configured to heat the carbon capture material in one or more DAC devices of the circumferential plurality of DAC devices.

15. The process assembly of claim 1, wherein the process device includes at least one heat exchanger, such that the process assembly is a cooling tower.

16. A nuclear power plant, comprising:
a nuclear reactor;
at least one coolant circuit configured to circulate a working fluid to absorb heat from a heat source and to transfer the absorbed heat into a heat sink, the heat source including the nuclear reactor or a separate working fluid of a separate coolant circuit; and
the process assembly of claim 1, wherein the process device includes at least one heat exchanger and is configured to circulate the working fluid to transfer at least a portion of the heat from the working fluid to atmosphere via the air flow.

17. A method of operating the process assembly of claim 1, the method comprising:
operating the drive motor to cause the wind turbine rotor assembly of the wind turbine air mover assembly to rotate around the central axis, to cause the air flow to move in the particular direction through the wind turbine rotor assembly, parallel to the central axis and to further flow over at least the portion of the process device; and
operating the process device to perform a process based on the air flow flowing over at least the portion of the process device, the process including at least one of
circulating a working fluid through a heat exchanger such that the heat exchanger transfers heat from the working fluid to the air flow and the wind turbine air mover assembly causes the air flow to remove the transferred heat from the process assembly via an air outlet of the process assembly, or
directing the air flow to flow over one or more surfaces of a carbon capture material such that the carbon capture material captures carbon dioxide from the air flow and subsequently isolating the carbon capture material from the air flow and further subsequently releasing the captured carbon dioxide from the carbon capture material.

18. A direct air capture (DAC) system, comprising:
a circumferential plurality of DAC devices, each DAC device of the circumferential plurality of DAC devices including a contactor having a carbon capture material within an enclosure and further including one or more openings configured to be selectively opened or closed to selectively seal or open the enclosure, the circumferential plurality of DAC devices at least partially defining a circumference of a central enclosure space in a plane, at least one opening of each DAC device facing into the central enclosure space; and
an air mover assembly configured to cause an air flow to flow over at least a portion of a contactor of one or more of the DAC devices based on causing the air flow to move in a particular direction through the air mover assembly, the air mover assembly including a rotor assembly at least partially overlapping the central enclosure space in an axial direction extending perpendicular to the plane.

19. The DAC system of claim 18, wherein the air mover assembly is a wind turbine air mover assembly, such that the rotor assembly is a wind turbine rotor assembly.

20. The DAC system of claim 18, further comprising:
a cylindrical shroud structure at least partially circumferentially surrounding the central enclosure space, the cylindrical shroud structure coupled to the air mover assembly such that the cylindrical shroud structure is configured to at least partially structurally support a weight of the rotor assembly at least partially overlapping the central enclosure space in the axial direction.
